SEQUENCE LISTING (28 sequences)

SEQ ID NO: 1 - DNA, 107 bp, Homo sapiens
ctaaggtaggagattgagactgcagtgacttgtgattgcgtcactgcgctccagcctgggtgacagagttgagactccgtctcaaaaaaaaaaaaaaaaaaaaaaat

SEQ ID NO: 2 - DNA, 76 bp, Homo sapiens
tgtgattgcgtcactgcgctccagcctgggtgacagagttgagactccgtctcaaaaaaaaaaaaaaaaaaaacaa

SEQ ID NO: 3 - DNA, 76 bp, Homo sapiens
acttgtgattgcgtcactgcgctccagcctgggtgacagagttgagactccggctcaaaaaaaaaaaaaaaaaaaa

SEQ ID NO: 4 - DNA, 76 bp, Homo sapiens
gacttgtgattgcgtcactgcgctccagcctgggtgacagagttgagactccgtctcaaaaaaaaaaaaaaaaaaa

SEQ ID NO: 5 - DNA, 76 bp, Homo sapiens; identical to SEQ ID NO: 4

SEQ ID NO: 6 - DNA, 76 bp, Homo sapiens
tgagactgcagtgacttgtgattgcgtcactgcgctccagcctgggtgacagagttgagactccgtctcaaaaaaa

SEQ ID NO: 7 - DNA, 76 bp, Homo sapiens
gattgagactgcagtgacttgtgattgcgtcactgcgctccagcctgggtgacagagttgagactccgtctcaaaa

SEQ ID NO: 8 - DNA, 76 bp, Homo sapiens
gagattgagactgcagtgacttgtgattgcgtcactgcgctccagcctgggtgacagagttgagactccgtctcaa

SEQ ID NO: 9 - DNA, 76 bp, Homo sapiens
ggagattgagactgcagtgacttgtgattgcgtcactgcgctccagcctgggtgacagagttgagactccgtctca

SEQ ID NO: 10 - DNA, 76 bp, Homo sapiens
gtaggagattgagactgcagtgacttgtgattgcgtcactgcgctccagcctgggtgacagagttgagactccgtc

SEQ ID NO: 11 - DNA, 76 bp, Homo sapiens
aaggtaggagattgagactgcagtgacttgtgattgcgtcactgcgctccagcctgggtgacagagttgagactcc

SEQ ID NO: 12 - DNA, 94 bp, Homo sapiens
ttctttaaaaacttgagcttcttggccgggtgcggtggctcacgcctgtaatcccagcactttgggaggctaaggagggcggatcacgaggtca

SEQ ID NO: 13 - DNA, 76 bp, Homo sapiens
ttcttggccgggtgcggtggctcacgcctgtaatcccagcactttgggaggctaaggagggcggatcacgaggtca

SEQ ID NO: 14 - DNA, 76 bp, Homo sapiens; identical to SEQ ID NO: 13

SEQ ID NO: 15 - DNA, 76 bp, Homo sapiens
ttaaaaacttgagcttcttggccgggtgcggtggctcacgcctgtaatcccagcactttgggaggctaaggagggc

SEQ ID NO: 16 - DNA, 76 bp, Homo sapiens
ctttaaaaacttgagcttcttggccgggtgcggtggctcacgcctgtaatcccagcactttgggaggctaaggagg

SEQ ID NO: 17 - DNA, 76 bp, Homo sapiens
ttctttaaaaacttgagcttcttggccgggtgcggtggctcacgcctgtaatcccagcactttgggaggctaagga

SEQ ID NO: 18 - DNA, 90 bp, Homo sapiens
gcatatgagattgtaagggtcaattttgagagataaagttcagttttagtgaagggaatgggaaaccattgtaggtttttaagcgaggga

SEQ ID NO: 19 - DNA, 76 bp, Homo sapiens
gcatatgagattgtaagggtcaattttgagagataaagttcagttttagtgaagggaatgggaaaccattgtaggt

SEQ ID NO: 20 - DNA, 76 bp, Homo sapiens
catatgagattgtaagggtcaattttgagagataaagttcagttttagtgaagggaatgggaaaccattgtaggtt

SEQ ID NO: 21 - DNA, 76 bp, Homo sapiens
atatgagattgtaagggtcaattttgagagataaagttcagttttagtgaagggaatgggaaaccattgtaggttt

SEQ ID NO: 22 - DNA, 76 bp, Homo sapiens; identical to SEQ ID NO: 21

SEQ ID NO: 23 - DNA, 76 bp, Homo sapiens
atgagattgtaagggtcaattttgagagataaagttcagttttagtgaagggaatgggaaaccattgtaggttttt

SEQ ID NO: 24 - DNA, 76 bp, Homo sapiens
ttgtaagggtcaattttgagagataaagttcagttttagtgaagggaatgggaaaccattgtaggtttttaagcga

SEQ ID NO: 25 - DNA, 76 bp, Homo sapiens
tgtaagggtcaattttgagagataaagttcagttttagtgaagggaatgggaaaccattgtaggtttttaagcgag

SEQ ID NO: 26 - DNA, 76 bp, Homo sapiens
aagggtcaattttgagagataaagttcagttttagtgaagggaatgggaaaccattgtaggtttttaagcgaggga

SEQ ID NO: 27 - DNA, 20 bp, Artificial Sequence
  synthetic construct; primer
catgtgatcccagaacttgg

SEQ ID NO: 28 - DNA, 24 bp, Artificial Sequence
  synthetic construct; primer
accatctcgactatttgtgagtgc

(19) United States
(12) Patent Application Publication
(10) Pub. No.: US 2017/0286594 A1
(43) Pub. Date: Oct. 5, 2017

(54) Genetic Variant-Phenotype Analysis System And Methods Of Use

(71) Applicant: REGENERON PHARMACEUTICALS, INC., Tarrytown, NY (US)

(72) Inventors: Jeffrey Reid, Stamford, CT (US); Omri Gottesman, New York, NY (US); Lukas Habegger, Stamford, CT (US); Brian Cajes, Stamford, CT (US); Jeffrey Staples, Briarcliff Manor, NY (US); Evan Maxwell, Danbury, CT (US)

(21) Appl. No.: 15/473,302

(22) Filed: Mar. 29, 2017

Related U.S. Application Data
(60) Provisional application No. 62/314,684, filed on Mar. 29, 2016.
(60) Provisional application No. 62/362,660, filed on Jul. 15, 2016.
(60) Provisional application No. 62/467,547, filed on Mar. 6, 2017.

(51) Int. Cl. G06F 19/18; G06F 19/26

(52) U.S. Cl. CPC G06F 19/18; G06F 19/26

(57) ABSTRACT

Methods and systems for generating and analyzing genetic variant-phenotype association results are disclosed.

### CROSS REFERENCE TO RELATED PATENT APPLICATIONS

This application claims priority to U.S. Provisional Application No. 62/314,684 filed Mar. 29, 2016, U.S. Provisional Application No. 62/362,660 filed Jul. 15, 2016, and U.S. Provisional Application No. 62/467,547 filed Mar. 6, 2017; herein incorporated by reference in their entireties.

### REFERENCE TO SEQUENCE LISTING

The Sequence Listing submitted Mar. 29, 2017 as a text file named “37595_0009U5_Sequence_Listing.txt,” created on Mar. 29, 2017, and having a size of 6,470 bytes is hereby incorporated by reference pursuant to 37 C.F.R. §1.52(e)(5).

### BACKGROUND

The application of high-throughput DNA sequencing to human cohorts has enabled genetic discovery, from the development of comprehensive catalogs of rare and common genetic variations (Genomes Project, C., et al., Nature 2010; 467: 1061; Tennessen J A, et al., Science 2012; 337: 64) to the elucidation of novel causal genes in Mendelian diseases (Chong J X, et al., Am J Hum Genet 2015; 97: 199; Yang Y, et al., JAMA, 2014; 312:1870), and rare variants have been implicated in common complex diseases (Do R, et al., Nature 2015; 518: 102; Holm H, et al., Nat Genet 2011; 43: 316; Steinberg S, et al., Nat Genet, 2015; 47: 445).

Recent discoveries have been aided by discovery of rare “human knockouts (MacArthur D G, et al., Science 2012; 335:823; Sulem P, et al., Nat Genet 2015; 47: 448; Lim E T, et al., PLoS Genet 2014; 10: e1004494). In some cases, sequence databases are linked to epidemiological data (Li A H, et al., Nat Genet 2015; 47: 640) or clinical phenotypes captured in structured clinical records (Sulem P, et al., Nat Genet 2015; 47: 448; Lim E T, et al., PLoS Genet 2014; 10: e1004494) to facilitate discovery of an association between a variant and a phenotype. (Gudbjartsson D F, et al., Nat Genet 2015; 47: p. 435-44; Consortium U K, et al., Nature 2015; 526: 82).

Such efforts have facilitated the discovery of a few therapeutic targets. For example, loss of function (LoF) mutations have been identified in the PCSK9 gene (Kathiresan, S. and C. Myocard Infarction, N Engl J Med 2008; 358: 2299) and in the APOC3 gene (Pollin T I, et al., Science 2008; 322: 1702) that are associated with favorable lipid profiles and reduced risk for coronary heart disease, and those discoveries have facilitated the development of therapeutics that target the products of those genes.

However, further elucidation of genetic factors that affect health and disease and the development of targeted therapeutics based on this information are needed to drive the implementation of precision medicine, and to identify more biological targets for pharmacological intervention. One approach for identifying putative biological targets is to statistically associate a variant of interest with a phenotype (or vice versa) in a large population of subjects for whom genetic variant and phenotype information is available (for example, Wellcome Trust Case Control Consortium, Nature 2007; 447: 661; Cohorts for Heart and Aging Research in Genomic Epidemiology Consortium, Circulation: Cardiovascular Genetics 2009; 2: 73). However, such efforts generally do not utilize a sufficient number of subjects or sufficiently deep characterization of genetic variation to find rare, high-impact, loss of function variants, which is due at least in part to insufficient statistical power, and insufficient genetic variant-phenotype association data from which clinically relevant putative targets can be nominated.

Furthermore, despite increased investment in research and development by biopharmaceutical industry, over 90% of molecules that enter Phase I clinical trials fail to demonstrate sufficient safety and efficacy to obtain regulatory approval. Most failures occur in Phase II clinical trials, with about half of the failures due to lack of efficacy, and about a quarter of the failures due to toxicity. Reasons for failure include that pre-clinical models may be poor predictors of clinical benefit.

Thus, there is a need in the art for an integrated electronic system that supports (1) the scalable storage of genetic variant and phenotype data for hundreds of thousands of subjects, (2) the scalable, automated analysis of genetic variant-phenotype associations, and (3) the automated computational analysis of genetic variant-phenotype association results.

### SUMMARY

It is to be understood that both the following general description and the following detailed description are exemplary and explanatory only and are not restrictive. Methods and systems for generating and analyzing genetic variant-phenotype association results are disclosed.

The present methods and systems provide an integrated electronic system comprising a genetic data component, a phenotypic data component, an automated genetic variant-phenotype association result data component, an automated result data analysis component and interfaces that facilitate the review of genetic variant data, phenotype data, association results data and pedigree. Disclosed herein are methods and systems for storage, processing, analysis, output, and/or visualization of biological data.

The present methods and systems facilitate the nomination identification of biological drug targets, which can be subsequently investigated in a functional model, for example, an animal model. It is believed that biological drug targets for which identification is supported by human genetic evidence are substantially more likely to succeed in clinical trials than are targets for which identification is supported by human genetic evidence.

The present methods and systems serve as a primary engine for novel genetic variant-phenotype association discovery, facilitates the aggregation of rare deleterious and protective alleles, including those in a homozygous state, facilitates investigation in large case-control studies and extreme/precise phenotypes, facilitates human knockout discovery, facilitates the validation of findings via genotype first queries and follow-up with subjects of interest and deep phenotyping in those subjects of interest, and facilitates pharmacogenetic studies in human clinical trials.

A system is disclosed comprising: a genetic data component configured for functionally annotating one or more genetic variants obtained from sequence data; a phenotypic data component configured for determining one or more phenotypes for one or more patients for whom the sequence data was obtained and analyzed by the genetic data component; a genetic variant-phenotype association data component configured for determining one or more associations between the one or more genetic variants and the one or more phenotypes; and a data analysis component configured for generating, storing and indexing the one or more associations from the genetic variant-phenotype association data component.

A system is disclosed comprising: a phenotype data interface coupled to the phenotypic data component; a genetic variant data interface coupled to the genetic data component; a pedigree interface coupled to the genetic data component; and a results interface coupled to the phenotypic data component and the data analysis component.

A method of viewing genetic variant data in via the disclosed systems is disclosed (e.g., via a graphical user interface).

A method of viewing phenotypic data via the disclosed systems is disclosed (e.g., via a graphical user interface).

A method of viewing genetic variant-phenotype association results via the disclosed systems is disclosed (e.g., via a graphical user interface).

A method of generating pedigrees from genetic data via the disclosed systems is disclosed.

A method of generating genetic variant-phenotype association results is disclosed, comprising: accessing data from the genetic data component and the phenotypic data component of the system of the invention, and statistically associating one or more genes or genetic variants with one or more phenotypes, thereby obtaining one or more genetic variant-phenotype association results.

A method is disclosed comprising: receiving a selection of one or more criteria; determining one or more de-identified medical records associated with the one or more criteria; grouping the one or more de-identified medical records into a first result; and displaying a first distribution of the one or more criteria as applied to the first result.

A method is disclosed comprising: receiving a plurality of variants from exome sequencing data; assessing a functional impact of the plurality of variants; generating an effect prediction element for each of the plurality of variants; and assembling the effect prediction element into a searchable database comprising the plurality of variants.

A method is disclosed comprising: querying a genetic data component for a variant associated with a gene of interest, passing the variant to a phenotypic data component as a query for a cohort possessing the variant; passing the variant and the cohort to a genetic variant-phenotype association data component to determine an association result between the variant and a phenotype of the cohort; passing the association result to a data analysis component to store and index the association result by at least one of the variant and the phenotype; and querying the data analysis component by a target variant or a target phenotype, wherein the association result is provided in response.

Additional advantages will be set forth in part in the description which follows or may be learned by practice. The advantages will be realized and attained by means of the elements and combinations particularly pointed out in the appended claims.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 is an exemplary operating environment;

FIG. 2 illustrates a plurality of system components configured for performing the disclosed methods;

FIG. 3 illustrates exemplary system interfaces configured for data analysis, visualization, and/or exchange;

FIG. 4A is an example graphical user interface;

FIG. 4B is an example phenotypic data graphical user interface;

FIG. 4C is an example phenotypic data graphical user interface;

FIG. 4D is an example query result from a phenotypic data graphical user interface;

FIG. 4E is an example phenotypic data graphical user interface;

FIG. 5 is an example phenotypic data method;

FIG. 6A is an example genetic data graphical user interface:

FIG. 6B is an example genetic data graphical user interface;

FIG. 7A is an example genetic data graphical user interface;

FIG. 7B is an example query result from a genetic data graphical user interface;

FIG. 7C is an example genetic data graphical user interface;

FIG. 7D is an example genetic data graphical user interface:

FIG. 7E is an example genetic data graphical user interface;

FIG. 8A is an example genetic data method;

FIG. 8B is an example VCF file generated by the disclosed methods;

FIG. 9 is an example pedigree user interface;

FIG. 10 is an example pedigree user interface;

FIG. 11 is an example pedigree user interface;

FIG. 12A is an example results user interface;

FIG. 12B is an example results user interface;

FIG. 13A is an example genetic data and phenotypic data graphical user interface;

FIG. 13B is an example query result from a genetic data and phenotypic data graphical user interface;

FIG. 14 is an example method;

FIG. 15 is an exemplary operating environment;

FIG. 16A, FIG. 16B, FIG. 16C, FIG. 16D, FIG. 16E, and FIG. 16F, depict the frequency and distribution of functional variants in 50,726 exome sequences: FIG. 16A depicts the relationship between alternate allele count and site number by functional class; FIG. 16B depicts site frequency spectra by functional class, demonstrating enrichment for rare alleles among more functionally deleterious variants; FIG. 16C is a line graph that depicts the accrual of rare (alternate allele frequency <1%) variants by functional class; FIG. 16D is a line graph that depicts the percentage of autosomal genes with multiple predicted loss of function carriers (pLoF) as a function of sample size, estimated by randomly sampling the 50,726 sequenced individuals in increments of 5,000, creating 10 samples for each increment; FIG. 16E is a histogram that depicts the distribution of observed/predicted ratio of premature stop variants in 50,726 exome sequences; and FIG. 16F is a box graph that depicts the distribution of observed/predicted ratio of premature stop variants in 50,726 exome sequences by gene class: essential, mouse essential genes (Georgi B, el al., PLoS Genet 2013; 9: e1003484); cancer, cancer predisposition genes (Rahman N, Nature 2014; 505: 302); dominant, autosomal dominant disease genes curated from OMIM (Blekhman R, et al., Curr Biol 2008; 18: 883; Berg J S, et al., Genet Med 2013; 15: 36); drug targets, genes encoding targets of drugs approved by the US Food and Drug Administration (Wishart D S, et al., Nucleic Acids Res 2006; 34: D668); recessive, autosomal recessive disease genes curated from OMIM; olfactory, olfactory receptor genes;

FIG. 17 is a histogram that depicts the distribution of single nucleotide variants leading to premature stop codons and frameshift indels as a function of position along the coding sequence. Abbreviations: pLoF=predicted loss of function;

FIG. 18A, FIG. 18B, and FIG. 18C, depict genetically inferred familial relationships in 50,726 DiscovEHR participants; FIG. 18A depicts pairwise identity-by-descent inferred from exome sequence data using PRIMUS (Staples J, et al., Am J Hum Genet 2014; 95: 553) for all relationships of 3^{rd} degree or greater. The red line represents empirically observed fraction of individuals with at least one 1^{st} or 2^{nd} degree family relationship, and blue shaded range indicates expectation n based on demographic data for the study cohort; FIG. 18B is a histogram that depicts the observed fraction of individuals in the participants sequenced to date with one or more 1^{st} or 2^{nd} degree relatives who are also sequenced; and FIG. 18C is a graphical representation of the largest family network reconstructed from exome sequence data, representing 3,144 individuals linked by 1^{st} or 2^{nd} degree relationships;

FIG. 19 is a bar graph that depicts runs of homozygosity in 34,246 DiscovEHR participants. F (ROH) is the proportions in runs of 5 Mb or greater in length. Abbreviations: ASW, African-American in Southwest US; CEU, Utah Residents (CEPH) with Northern and Western European Ancestry; CHB, Han Chinese in Beijing, China; CHS, Southern Han Chinese; CLM, Colombians from Medellin, Colombia; FIN, Finnish in Finland; GBR, British in England and Scotland; GHS, Geisinger Health System (DiscovEHR); IBS, Iberian Population in Spain; JPT, Japanese in Tokyo, Japan; LWK, Luhya in Webuye, Kenya; MXL, Mexican Ancestry from Los Angeles USA; PUR, Puerto Ricans from Puerto Rico; TSI, Toscani in Italia; YRI, Yoruba in Ibadan, Nigeria;

FIG. 20A, FIG. 20B, FIG. 20C, and FIG. 20D, depict quantile-quantile (Q-Q) plots of single marker association results for lipid traits for the DiscovEHR study. The plots describe observed vs. predicted P values for single nucleotide and indel variants with minor allele frequency greater than 0.1%. P values are for mixed linear model association analysis of lipid trait residuals adjusted for age, age², sex, principal components of ancestry, with genotypes coded under an additive model. Triglycerides and HDL-C were log₁₀ transformed prior to regression analysis. Abbreviations: λ_{GC}=genomic control lambda;

FIG. 21A, FIG. 21B, FIG. 21C, FIG. 21D, FIG. 21E, FIG. 21F, and FIG. 21G is a table that depicts exome-wide significant findings from multivariate analysis of HDL-C, LDL-C, and triglycerides;

FIG. 22A, FIG. 22B, FIG. 22C, and FIG. 22D is a table that depicts exome-wide significant single marker associations with total cholesterol levels;

FIG. 23A, FIG. 23B, FIG. 23C, FIG. 23D, and FIG. 23E is a table that depicts exome-wide significant single marker associations with HDL-C levels;

FIG. 24A, FIG. 24B, FIG. 24C, and FIG. 24D is a table that depicts exome-wide significant single marker associations with LDL-C levels;

FIG. 25A, FIG. 25B, FIG. 25C, FIG. 25D, and FIG. 25E is a table that depicts exome-wide significant single marker associations with triglyceride levels;

FIG. 26 is a table that depicts gene-based burden test findings for lipid levels in 50,726 DiscovEHR Participants;

FIG. 27 is a scatter plot graph that depicts the relationship between allele frequency and effect size for single variant and gene burden tests of association with lipid levels. Effect size is given as the absolute value of beta, in standard deviation units. Only single variant and gene-based burden associations meeting exome-wide significance criteria (1×10⁻⁷ and 1×10⁻⁶ for single variant and gene-based burden tests of association) are displayed;

FIG. 28 depicts the associations between predicted loss of function variants in lipid drug target genes and lipid levels. Each box corresponds to the effect size, given as the absolute value of beta, in standard deviation units, and whiskers denote 95% confidence intervals for beta. The size of the box is proportional to the logarithm (base 10) of predicted loss of function carriers. Bracketed numbers denote the 95% confidence interval;

FIG. 29 is a table that depicts associations between predicted loss of function mutations in genes encoding lipid lowering drug targets and median lifetime lipid levels;

FIG. 30A, FIG. 30B, FIG. 30C, FIG. 30D, FIG. 30E, FIG. 30F, FIG. 30G, and FIG. 30H is a table that depicts expected and known pathogenic mutations in 76 clinically actionable disease genes in 50,726 sequenced DiscovEHR participants;

FIG. 31 depicts an LDLR tandem duplication whole-genome sequence validation; SEQ ID NOs: 1-11 are shown from top to bottom, respectively;

FIG. 32 is a line graph that depicts the results of a comparison of CNV calls made by CLAMMS (whole-exome sequence) and PennCNV (SNP array) on 1,174 parent-child duos (2.132 unique samples) where both parent and child were not outliers by CLAMMS (<=28 CNVs) or PennCNV (<=50 CNVs);

FIG. 33 is a table that depicts the observed frequencies of a set of known disease-associated CNVs in the GHS population;

FIG. 34 is a pedigree diagram;

FIG. 35A shows the mean length (95% confidence bands) for deletion and duplication loci at varying allele frequency ranges;

FIG. 35B is a histogram that shows the sample-wise distribution of CNV count;

FIG. 35C shows the cumulative distribution of CNV loci by allele frequency;

FIG. 36 is a scatter plot that depicts CNV length relative to allele frequency;

FIG. 37 is a line graph that depicts the comparison of gene tolerance to CNVs versus LoF SNVs;

FIG. 38A depicts gene sets enriched or depleted for loss-of-function intolerant genes (high ExAC pLI ranking);

FIG. 38B depicts the expected probability (mean, 95% confidence interval) of observing a duplication or deletion for genes in each gene set from (a), compared relative to the superset of “All Genes”;

FIG. 39 is a schematic of an HMAGCR-containing tandem duplication with a nested deletion; SEQ ID NOs: 12-26 are shown from top to bottom, respectively; and

FIG. 40 depicts the LDLR DUP₁₃₋₁₇ carrier pedigree and LDL levels.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

It is understood that the disclosed method and compositions are not limited to the particular methodology, protocols, and reagents described as these may vary. It is also to be understood that the terminology used herein is for the purpose of describing particular embodiments only, and is not intended to limit the scope of the present methods and system which will be limited only by the appended claims.

Unless defined otherwise, all technical and scientific terms used herein have the same meanings as commonly understood by one of skill in the art to which the disclosed method and compositions belong. Although any methods and materials similar or equivalent to those described herein can be used in the practice or testing of the present method and compositions, the particularly useful methods, devices, and materials are as described. Publications cited herein and the material for which they are cited are hereby specifically incorporated by reference. Nothing herein is to be construed as an admission that the present methods and systems are not entitled to antedate such disclosure by virtue of prior invention. No admission is made that any reference constitutes prior art. The discussion of references states what their authors assert, and applicants reserve the right to challenge the accuracy and pertinency of the cited documents. It will be clearly understood that, although a number of publications are referred to herein, such reference does not constitute an admission that any of these documents forms part of the common general knowledge in the art.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

The methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Next-generation DNA sequencing technology enables genetic research on a large scale. The methods and systems disclosed can leverage de-identified, clinical information and biological data for medically relevant associations. The methods and systems disclosed can comprise a high-throughput platform for discovering and validating genetic factors that cause or influence a range of diseases, including diseases where there are major unmet medical needs.

As used herein, “biological data” can refer to any data derived from measuring biological conditions of human, animals or other biological organisms including microorganisms, viruses, plants and other living organisms. The measurements may be made by any tests, assays or observations that are known to physicians, scientists, diagnosticians, or the like. Biological data can include, but is not limited to, clinical tests and observations, physical and chemical measurements, genomic determinations, genomic sequencing data, exomic sequencing data, proteomic determinations, drug levels, hormonal and immunological tests, neurochemical or neurophysical measurements, mineral and vitamin level determinations, genetic and familial histories, and other determinations that may give insight into the state of the individual or individuals that are undergoing testing. The term “data” can be used interchangeably with “biological data.” As used herein, “phenotypic data” refer to data about phenotypes. Phenotypes are discussed further below.

As used herein, the term “subject” means an individual. In one aspect, a subject is a mammal such as a human. In one aspect a subject can be a non-human primate. Non-human primates include marmosets, monkeys, chimpanzees, gorillas, orangutans, and gibbons, to name a few. The term “subject” also includes domesticated animals, such as cats, dogs, etc., livestock (for example, cattle (cows), horses, pigs, sheep, goats, etc.), laboratory animals (for example, ferret, chinchilla, mouse, rabbit, rat, gerbil, guinea pig, etc.) and avian species (for example, chickens, turkeys, ducks, pheasants, pigeons, doves, parrots, cockatoos, geese, etc.). Subjects can also include, but are not limited to fish (for example, zebrafish, goldfish, tilapia, salmon, and trout), amphibians and reptiles. As used herein, a “subject” is the same as a “patient,” and the terms can be used interchangeably.

As used herein, the term “haplotype” refers to a set of two or more alleles (specific nucleic acid sequences) that are in linkage disequilibrium. In one aspect, a haplotype refers to a set of single nucleotide polymorphisms (SNPs) found to be statistically associated with each other on a single chromosome. A haplotype can also refer to a combination of polymorphisms (e.g., SNPs) and other genetic markers (e.g., an insertion or a deletion) found to be statistically associated with each other on a single chromosome.

The term “polymorphism” refers to the occurrence of one or more genetically determined alternative sequences or alleles in a population. A “polymorphic site” is the locus at which sequence divergence occurs. Polymorphic sites have at least one allele. A diallelic polymorphism has two alleles. A triallelic polymorphism has three alleles. Diploid organisms may be homozygous or heterozygous for allelic forms. A polymorphic site can be as small as one base pair. Examples of polymorphic sites include: restriction fragment length polymorphisms (RFLPs), variable number of tandem repeats (VNTRs), hypervariable regions, minisatellites, dinucleotide repeats, trinucleotide repeats, tetranucleotide repeats, and simple sequence repeats. As used herein, reference to a “polymorphism” can encompass a set of polymorphisms (i.e., a haplotype). A “single nucleotide polymorphism (SNP)” can occur at a polymorphic site occupied by a single nucleotide, which is the site of variation between allelic sequences. The site can be preceded by and followed by highly conserved sequences of the allele. A SNP can arise due to substitution of one nucleotide for another at the polymorphic site. Replacement of one purine by another purine or one pyrimidine by another pyrimidine is called a transition. Replacement of a purine by a pyrimidine or vice versa is called a transversion. A synonymous SNP refers to a substitution of one nucleotide for another in the coding region that does not change the amino acid sequence of the encoded polypeptide. A non-synonymous SNP refers to a substitution of one nucleotide for another in the coding region that changes the amino acid sequence of the encoded polypeptide. A SNP may also arise from a deletion or an insertion of a nucleotide or nucleotides relative to a reference allele.

A “set” of polymorphisms means one or more polymorphism, e.g., at least 1, at least 2, at least 3, at least 4, at least 5, at least 6, or more than 6 polymorphisms.

As used herein, a “nucleic acid,” “polynucleotide,” or “oligonucleotide” can be a polymeric form of nucleotides of any length, can be DNA or RNA, and can be single- or double-stranded. Nucleic acids can include promoters or other regulatory sequences. Oligonucleotides can be prepared by synthetic means. Nucleic acids include segments of DNA, or their complements spanning or flanking any one of the polymorphic sites. The segments can be between 5 and 100 contiguous bases and can range from a lower limit of 5, 10, 15, 20, or 25 nucleotides to an upper limit of 10, 15, 20, 25, 30, 50, or 100 nucleotides (where the upper limit is greater than the lower limit). Nucleic acids between 5-10, 5-20, 10-20, 12-30, 15-30, 10-50, 20-50, or 20-100 bases are common. The polymorphic site can occur within any position of the segment. A reference to the sequence of one strand of a double-stranded nucleic acid defines the complementary sequence and except where otherwise clear from context, a reference to one strand of a nucleic acid also refers to its complement.

“Nucleotide” as described herein refers to molecules that, when joined, make up the individual structural units of the nucleic acids RNA and DNA. A nucleotide is composed of a nucleobase (nitrogenous base), a five-carbon sugar (either ribose or 2-deoxyribose), and one phosphate group. “Nucleic acids” are polymeric macromolecules made from nucleotide monomers. In DNA, the purine bases are adenine (A) and guanine (G), while the pyrimidines are thymine (T) and cytosine (C). RNA uses uracil (U) in place of thymine (T).

As used herein, the term “genetic variant” or “variant” refers to a nucleotide sequence in which the sequence differs from the sequence most prevalent in a population, for example by one nucleotide, in the case of the SNPs described herein. For example, some variations or substitutions in a nucleotide sequence alter a codon so that a different amino acid is encoded resulting in a genetic variant polypeptide. The term “genetic variant,” can also refer to a polypeptide in which the sequence differs from the sequence most prevalent in a population at a position that does not change the amino acid sequence of the encoded polypeptide (i.e., a conserved change). Genetic variant polypeptides can be encoded by a risk haplotype, encoded by a protective haplotype, or can be encoded by a neutral haplotype. Genetic variant polypeptides can be associated with risk, associated with protection, or can be neutral.

Non-limiting examples of genetic variants include frameshift, stop gained, start lost, splice acceptor, splice donor, stop lost, inframe indel, missense, splice region, synonymous and copy number variants. Non-limiting types of copy number variants include deletions and duplications.

As used herein, “genetic variant data” refer to data obtained by identifying allelic variants in a subject's nucleic acid, relative to a reference nucleic acid sequence. The term “genetic variant data” also encompasses data that represent the predicted effect of a variant on the biochemical structure/function of the polypeptide encoded by the variant gene.

Methods and systems disclosed support large-scale, automated statistical analysis of genetic variant-phenotype associations, on a rolling basis, as genetic variant and phenotype data for new subjects are added over time. For example, in an aspect, the statistical association analysis that is performed is a genome-wide association study (GWAS) statistical analysis (van der Sluis S, et al., PLOS Genetics 2013; 9: e1003235; Visscher P M, et al., Am J Hum Genet 2012; 90: 7). In a GWAS analysis, one determines what genes or genetic variants are associated with a phenotype of interest. In one aspect, the genetic variant data are obtained from genomic sequencing of the subjects for whom genetic variant and phenotype data are contained in the system. In another aspect, the genetic variant data are obtained from exome (for example, whole exome) sequencing of the subjects for whom genetic variant and phenotype data are contained in the system.

In another aspect, the statistical association analysis that is performed is a phenome-wide association study (PheWAS) statistical analysis (Denny J C, et al., Nature Biotechnol 2013; 31: 1102). In a PheWAS study, one determines phenotypes that are associated with one or more genes or genetic variants of interest. In PheWAS, associations between one or more specific genetic variants and one or more physiological and/or clinical outcomes and phenotypes can be identified and analyzed. In an aspect, algorithms can be utilized to analyze electronic medical record (EMR) and electronic health record (EHR) data. In another aspect, data collected in observational cohort studies can be analyzed.

As used herein, the terms “electronic medical record” and “electronic health record” are synonymous.

As used herein, a genetic variant is “pleiotropic” if it has an effect on more than one phenotype (Gottesman O, et al., Plos One 2012; 7: e46419). In one embodiment, a genetic variant is associated with an increase in the magnitude of two or more phenotypes, measured, for example, as an increased odds ratio. In another embodiment, a genetic variant is associated with a decrease in the magnitude of two or more phenotypes, measured, for example as a decreased odds ratio. In another embodiment, a genetic variant is associated with an increase in the magnitude of one or more phenotypes and is also associated with a decrease in the magnitude of one or more phenotypes.

In another embodiment, a variant of interest that has been identified in a family affected with a Mendelian disease or in a founder population can be investigated in a larger population for which genetic variant and phenotype information is contained in the present methods and systems. Using that approach, a statistical analysis can be performed to identify what, if any, phenotypes are associated with the variant in a population that is larger than the family affected with a Mendelian disease or the founder population in which the genetic variant was identified. This approach is referred to herein as “family-to-population” analysis.

In another embodiment, a variant of interest that has previously been associated with a phenotype in clinical trial participants can be investigated in a larger population for which genetic variant and phenotype information is contained in the present methods and systems. Using that approach, a statistical analysis can be performed to identify what, if any, phenotypes are associated with the variant in a population that is larger than the group of clinical trial participants.

The present methods and systems also provide a method of gene-based phenotyping. In that method, if a genetic variant-phenotype association has been identified, and if a subject in the population has the variant of interest in the association, but does not exhibit the phenotype of interest associated with the genetic variant, then the subject can be monitored for the development of the phenotype in the future. Alternatively, the subject can be evaluated for the presence of the (previously undiagnosed) phenotype.

Regardless of what type of statistical analysis is employed using the system disclosed, one can filter genetic variant-phenotype association results by any category of interest. Non-limiting categories of interest by which one can filter results are age, sex, race, ethnicity, weight, medicine, diagnosis, laboratory test, laboratory test result, laboratory test result range, or any other phenotype category or type for which the phenotypic data component is configured.

In one embodiment, the genetic variant and phenotype data are obtained from a population of at least 50,000, 60,000, 70,000, 80,000, 90,000, 100,000, 110,000, 120,000, 130,000, 140,000, 150,000, 160,000, 170,000, 180,000, 190,000, 200,000, 250,000, 300,000, 350,000, 400,000, 450,000, 500,000, 600,000, 700,000, 800,000, 900,000 or 1,000,000 subjects. The genetic data and the phenotype data can be used in a statistical analysis of the association of one or more genes and/or one or more genetic variants with one or more phenotypes.

As the sample size (number of sequenced subjects) increases, the number variants found to be significantly associated with one or more phenotypes can increase. To minimize false positive genetic variant-phenotype statistical associations, one must have adequate power and a stringent significance threshold (Sham P C and Purcell S M, Nature Rev 2014; 15: 335). The sample size required for detecting a variant is influenced by both the frequency of the variant, for example the minor allele frequency (MAF), and the effect size of the variant.

In one embodiment, the MAF of a genetic variant is at least 1%, 2%, 3%, 4%, 5%, 6%, 7%, 8%, 9% or 10%. In another embodiment, the MAF of a genetic variant is less than 10%, 9%, 8%, 7%, 6%, 5%, 4%, 3%, 2%, 1%, 0.9%, 0.8%, 0.7%, 0.6%, 0.5%, 0.4%, 0.3%, 0.2%, 0.1%, 0.09%, 0.08%, 0.07%, 0.06%, 0.05%, 0.04%, 0.03%, 0.02% or 0.01%.

Statistical power depends on allele frequency and effect size. Analysis of rare variants (MAF<1%) can be challenging, due to data sparsity. Even with a large effect size, statistically significant associations for rare variants may only be detected in very large samples. Power may be increased by combining (aggregating) information across variants in a genetic region into a summary dose variable (gene burden testing). Non-limiting examples of gene burden tests are the sequence kernal association test (SKAT), the cohort allelic sum test (CAST), the weighted sum test (WST), the combined multivariate and collapsing method (CMD), the Wald test, and the CMC-Wald test (Wu M C, et al., Am. J. Hum. Genet. 2011; 89: 82; Lee S, et al., Am. J. Hum. Genet. 2014; 95: 5).

In one embodiment, a phenotype is observed in at least 1%, 2%, 3%, 4%, 5%, 6%, 7%, 8%, 9%, 10%, 11%, 12%, 13%, 14%, 15%, 16%, 17%, 18%, 19%, 20%, 25%, 30%, 35%, 40%, 45%, 50%, 60%, 70%, 80% or 90% of the subjects from which phenotype information was obtained in the association analysis. In another embodiment, a phenotype is observed in less than 50%, 45%, 40%, 35%, 30%, 25%, 20%, 15%, 10%0, 9%, 8%, 7%, 6%, 5%, 4%, 3%, 2%, 1%, 0.9%, 0.8%, 0.7%, 0.6%, 0.5%, 0.4%, 0.3%, 0.2%, 0.1%, 0.09%, 0.08%, 0.07%, 0.06%, 0.05%, 0.04%, 0.03%, 0.02%, 0.01%, 0.009%, 0.008%, 0.007%, 0.006%, 0.005%, 0.004%, 0.003%, 0.002% or 0.001% of the subjects from which phenotype information was obtained in the association analysis.

In order to determine the penetrance of a variant of interest on one or more phenotypes of interest in a statistical association study, a case-control study can be performed (Sham P C and Purcell S M, Nature Reviews 2014; 15: 335). In such a case-control study, subjects who have the phenotype(s) of interest are designated as “cases,” and subjects who do not have the phenotype(s) of interest are designated as “controls.” The incidence of a variant of interest is then determined in the respective “case” and “control” groups of subjects.

In one embodiment, the present methods and systems contain de-identified subject information, which means that neither the genetic data component 304 (which contains a subject's genetic variant data), nor the phenotypic data component 302 (which contains a subject's phenotype data), contain information (such as name, birth date, address, Social Security number, etc.), by which the subject could be identified.

The present methods and systems are not a clinical decision support system. As used herein, the term “clinical decision support system” is an electronic system that clinicians (for example, physicians, nurses, pharmacists, physician assistants, physical therapists, laboratory technicians, etc.) utilize to record patient-identified clinical information, such as patient vital signs, laboratory results, clinical narrative notes, and which provides clinicians with alerts that relate, for example, to medication contraindications, allergies, etc.

As used herein, a “phenotype” is a clinical designation or category, for example, a clinical diagnosis, a clinical parameter name, a clinical parameter value, a medicine name, dosage or route of administration, a laboratory test name or a laboratory test value. As used herein, a “binary phenotype” is a phenotype that is fixed, i.e., that is either yes or no, for example, a clinical diagnosis, a clinical parameter name, a medicine name or route of administration, or a laboratory test name. As used herein, a “quantitative phenotype” is a phenotype that has a value within a range, for example, a clinical parameter value (for example, a blood pressure value or a serum glucose value), a medicine dosage, or a laboratory test value.

The phenotypic data component can comprise at least 100, 200, 300, 400, 500, 600, 700, 800, 900, 1000, 1100, 1200, 1300, 1400, 1500, 1600, 1700, 1800, 1900 or 2000 categories of phenotypes, among which are at least 100, 200, 300, 400, 500, 600, 700, 800, 900, 1000, 1100, 1200, 1300, 1400, 1500, 1600, 1700, 1800 categories of binary phenotypes and at least 100, 110, 120, 130, 140, 150, 160, 170, 180, 190, 200, 210, 220, 230, 240, 250, 260, 270, 280, 290, 300, 350, 400, 450 or 500 categories of quantitative phenotypes.

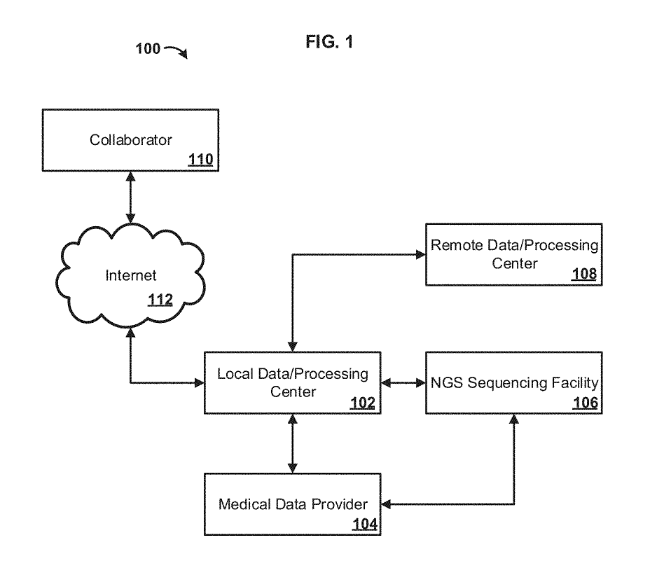

FIG. 1 illustrates various aspects of an exemplary environment 100 in which the present methods and systems can operate. The present methods may be used in various types of networks and systems that employ both digital and analog equipment. Provided herein is a functional description and that the respective functions can be performed by software, hardware, or a combination of software and hardware.

The environment 100 can comprise a Local Data/Processing Center 102. The Local Data/Processing Center 102 can comprise one or more networks, such as local area networks, to facilitate communication between one or more computing devices. The one or more computing devices can be used to store, process, analyze, output, and/or visualize biological data. The environment 100 can, optionally, comprise a Medical Data Provider 104. The Medical Data Provider 104 can comprise one or more sources of biological data. For example, the Medical Data Provider 104 can comprise one or more health systems with access to medical information for one or more patients. The medical information can comprise, for example, medical history, medical professional observations and remarks, laboratory reports, diagnoses, doctors' orders, prescriptions, vital signs, fluid balance, respiratory function, blood parameters, electrocardiograms, x-rays, CT scans, MRI data, laboratory test results, diagnoses, prognoses, evaluations, admission and discharge notes, and patient registration information. The Medical Data Provider 104 can comprise one or more networks, such as local area networks, to facilitate communication between one or more computing devices. The one or more computing devices can be used to store, process, analyze, output, and/or visualize medical information. The Medical Data Provider 104 can de-identify the medical information and provide the de-identified medical information to the Local Data/Processing Center 102. The de-identified medical information can comprise a unique identifier for each patient so as to distinguish medical information of one patient from another patient, while maintaining the medical information in a de-identified state. The de-identified medical information prevents a patient's identity from being connected with his or her particular medical information. The Local Data/Processing Center 102 can analyze the de-identified medical information to assign one or more phenotypes to each patient (for example, by assigning International Classification of Diseases “ICD” and/or Current Procedural Terminology “CPT” codes).

The environment 100 can comprise a NGS Sequencing Facility 106. The NGS Sequencing Facility 106 can comprise one or more sequencers (e.g., Illumina HiSeq 2500, Pacific Biosciences PacBio RS II, and the like). The one or more sequencers can be configured for exome sequencing, whole exome sequencing, RNA-seq, whole-genome sequencing, targeted sequencing, and the like. In an aspect, the Medical Data Provider 104 can provide biological samples from the patients associated with the de-identified medical information. The unique identifier can be used to maintain an association between a biological sample and the de-identified medical information that corresponds to the biological sample. The NGS Sequencing Facility 106 can sequence each patient's exome based on the biological sample. To store biological samples prior to sequencing, the NGS Sequencing Facility 106 can comprise a biobank (for example, from Liconic Instruments). Biological samples can be received in tubes (each tube associated with a patient), each tube can comprise a barcode (or other identifier) that can be scanned to automatically log the samples into the Local Data/Processing Center 102. The NGS Sequencing Facility 106 can comprise one or more robots for use in one or more phases of sequencing to ensure uniform data and effectively non-stop operation. The NGS Sequencing Facility 106 can thus sequence tens of thousands of exomes per year. In one aspect, the NGS Sequencing Facility 106 has the functional capacity to sequence at least 1000, 2000, 3000, 4000, 5000, 6000, 7000, 8000, 9000, 10,000, 11,000 or 12,000 whole exomes per month.

The biological data (e.g., raw sequencing data) generated by the NGS Sequencing Facility 106 can be transferred to the Local Data/Processing Center 102 which can then transfer the biological data to a Remote Data/Processing Center 108. The Remote Data/Processing Center 108 can comprise a cloud-based data storage and processing center comprising one or more computing devices. The Local Data/Processing Center 102 and the NGS Sequencing Facility 106 can communicate data to and from the Remote Data/Processing Center 108 directly via one or more high capacity fiber lines, although other data communication systems are contemplated (e.g., the Internet). In an aspect, the Remote Data/Processing Center 108 can comprise a third party system, for example Amazon Web Services (DNAnexus). The Remote Data/Processing Center 108 can facilitate the automation of analysis steps, and allows sharing data with one or more Collaborators 110 in a secure manner. Upon receiving biological data from the Local Data/Processing Center 102, the Remote Data/Processing Center 108 can perform an automated series of pipeline steps for primary and secondary data analysis using bioinformatic tools, resulting in annotated variant files for each sample. Results from such data analysis (e.g., genotype) can be communicated back to the Local Data/Processing Center 102 and, for example, integrated into a Laboratory Information Management System (LIMS) can be configured to maintain the status of each biological sample.

The Local Data/Processing Center 102 can then utilize the biological data (e.g., genotype) obtained via the NGS Sequencing Facility 106 and the Remote Data/Processing Center 108 in combination with the de-identified medical information (including identified phenotypes) to identify associations between genotypes and phenotypes. For example, the Local Data/Processing Center 102 can apply a phenotype-first approach, where a phenotype is defined that may have therapeutic potential in a certain disease area, for example extremes of blood lipids for cardiovascular disease. Another example is the study of obese patients to identify individuals who appear to be protected from the typical range of comorbidities. Another approach is to start with a genotype and a hypothesis, for example that gene X is involved in causing, or protecting from, disease Y.

In an aspect, the one or more Collaborators 110 can access some or all of the biological data and/or the de-identified medical information via a network such as the Internet 112.

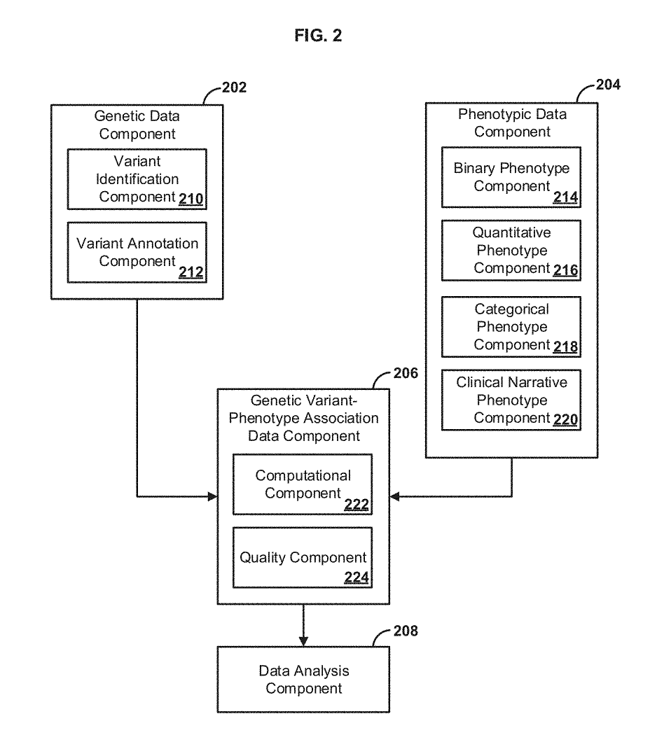

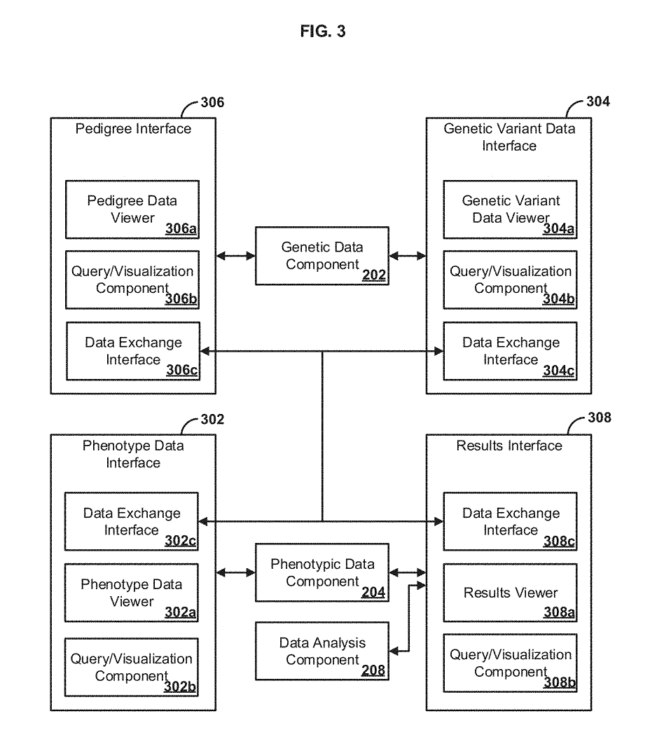

In an aspect, illustrated in FIG. 2, one or more of the Local Data/Processing Center 102 and/or the Remote Data/Processing Center 108 can comprise one or more computing devices that comprise one or more of a genetic data component 202, a phenotypic data component 204, a genetic variant-phenotype association data component 206, and/or a data analysis component 208. The genetic data component 202, the phenotypic data component 204, and/or the genetic variant-phenotype association data component 206 can be configured for one or more of, a quality assessment of sequence data, read alignment to a reference genome, variant identification, annotation of variants, phenotype identification, variant-phenotype association identification, data visualization, combinations thereof, and the like.

In an aspect, one or more of the components may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

In an aspect, the genetic data component 202 can be configured for functionally annotating one or more genetic variants. The genetic data component 202 can also be configured for storing, analyzing, receiving, and the like, one or more genetic variants. The one or more genetic variants can be annotated from sequence data (e.g., raw sequence data) obtained from one or more patients (subjects). For example, the one or more genetic variants can be annotated from each of at least 100,000, 200,000, 300,000, 400,000 or 500,000 subjects. A result of functionally annotating one or more genetic variants is generation of genetic variant data. By way of example, the genetic variant data can comprise one or more Variant Call Format (VCF) files. A VCF file is a text file format for representing SNP, indel, and/or structural variation calls. Variants are assessed for their functional impact on transcripts/genes and potential loss-of-function (pLoF) candidates are identified. Variants are annotated with snpEff using the Ensembl75 gene definitions and the functional annotations are then further processed into a single REGN Effect Prediction (REP) for each variant (and gene).

The genetic data component 202 can be inclusive—so while can comprise mostly high-quality variants, it can comprise some variant calls of lower quality (mostly due to alignment errors in Indels). For various calculations, the genetic data component 202 can distinguish between three levels of quality and can impose different restrictions on the variant calls and pLoF definition based on empirically determined cutoffs:

| | | QD | Flanking | |
|---|---|---|---|---|
| Level | Description | Filter | Regions | pLoF Definition |
| L1 | “Loose” | None | +/−100 nt | REP using Ensembl75 |
| | | | | (protein-coding transcripts |
| | | | | with an annotated start |
| | | | | and stop) |
| L2 | “Moderate” | QD >=3 | +/−100 nt | Same as above (L1), but |
| | | | | exclude sites if the alternate |
| | | | | allele matches the ancestral |
| | | | | allele |
| L3 | “Strict” | QD >=5 | +/−20 nt | Same as above (L2), but |
| | | | | exclude pLoFs if they occur in |
| | | | | the last 5% of all affected |
| | | | | transcripts (applies to |
| | | | | stop_gained and |
| | | | | frameshift variants only) |

The genetic data component 202 can comprise one or more components to perform the functional annotation of the one or more genetic variants. For example, the genetic data component 202 can comprise a variant identification component 210 comprised of a trimming component, an alignment component, a variant calling component, combinations thereof, and the like. The genetic data component 202 can comprise a variant annotation component 212 comprised of a functional predictor component, and the like.

The variant identification component 210 can evaluate quality of raw sequence data (e.g., reads) and to remove, trim, or correct reads that do not meet a defined quality standard. Raw sequence data generated by the NGS Sequencing Facility 106 can be compromised by sequence artifacts such as base calling errors, INDELs, poor quality reads, and/or adaptor contamination. The trimming component can be configured for trimming off low-quality ends from reads in sequence data. The trimming component can determine base quality scores and nucleotide distributions. The trimming component can trim reads and perform read filtering based on the base quality scores and sequence properties such as primer contaminations, N content, and/or GC bias.

After the sequence data (e.g., reads) have been processed to meet the defined quality standard, the variant identification component 210 can utilize an alignment component to align the sequence data (e.g., reads) to an existing reference genome. Any alignment algorithm/program can be used, for example, Burrow-Wheeler (BWA), BWA MEM, Bowtie/Bowtie2, MAQ, mrFAST, Novoalign, SOAP, SSAHA2, Stampy, and/or YOABS. The alignment component can generate a Sequence Alignment/Map (SAM) and/or a Binary Alignment/Map (BAM). The SAM is an alignment format for storing read alignments against reference sequences, whereas the BAM is a compressed binary version of the SAM. A BAM file is a compact and indexable representation of nucleotide sequence alignments.

After the sequence data (e.g., reads) have been aligned, the variant identification component 210 can identify (e.g., call) one or more variants. Tools for genome-wide variant identification can be grouped into four categories: (i) germline callers, (ii) somatic callers, (iii) CNV identification and (iv) SV identification. The tools for the identification of large structural modifications can be divided into those which find CNVs and those which find other SVs such as inversions, translocations or large INDELs. CNVs can be detected in both whole-genome and whole-exome sequencing studies. Non-limiting examples of such tools include, but are not limited to, CASAVA, GATK, SAMtools, SomaticSniper, SNVer, VarScan 2, CNVnator, CONTRA, ExomeCNV, RDXplorer, BreakDancer, Breakpointer, CLEVER, GASVPro, and SVMerge.

A non-limiting example of a method (referred to herein as “CLAMMS”) for calling a copy number variant is disclosed in U.S. application Ser. No. 14/714,949, filed May 18, 2015 (“Methods and Systems for Copy Number Variant Detection”), which is hereby incorporated by reference in its entirety.

The variant identification component 210 can identify (e.g., call) one or more variants, including CNV identification. As used herein, “CNV” refers to “copy number variant” which can be a genetic variant in which the number of copies of a particular region of the genome differs from its most commonly observed copy number in the population. For example, most individuals carry two copies of a gene on their diploid chromosomes (autosomes as well as chromosome X in females), but an individual harboring a copy number variant may have 0, 1, 3, 4, or more copies of the gene. The sequence itself may or may not contain SNP or indel variants, and the number of copies most common in the population may not necessarily be two. There is no limitation on the size of the copy number variant region, however CNVs are generally considered to be larger than indels (>100 bp for example) and smaller than a chromosome arm.

One or more CNVs can be detected in all whole-exome sequencing samples using CLAMMS. Every CNV can be defined by start and end coordinates, expected copy number state, and/or confidence level. Start and end coordinates can correspond to the first and last exon window within the predicted CNV region. Copy number state is the most likely state (# of copies) as predicted by the probabilistic CLAMMS mixture models and hidden markov model (HMM). A confidence level (“QC Level”) can be assigned between 0 and 3, where QCO are the lowest confidence CNV calls, and QC3 are the highest. The confidence levels can be assigned using the CLAMMS quality control pipeline as described in “Primary Sequence Analysis, CNV Calling, and Quality Control,” infra. High-confidence CNVs can be defined as QC levels 2-3, with low-confidence being QC levels 0-1.

Following assignment of CNV confidence levels, CNVs can be merged into CNV “super-loci” or “loci”. Because CNV coordinates can be somewhat inaccurate depending on how confidently the model identifies the first and last exon window, it can be necessary to perform a merging step to group CLAMMS CNV calls expected to represent the same underlying copy number variant allele based on their predicted coordinates. To perform this grouping step, high-confidence (QC levels 2-3) CNVs that have >=50% reciprocal overlap (i.e. CNV1 overlaps at least 50% of CNV2 and CNV2 overlaps at least 50% of CNV1) can recursively merged into a “super-locus”. When two CNVs are merged, the new super-locus coordinates represent the most extreme endpoints of the merged CNVs, such that no CNV extends beyond the coordinates of its super-locus. Because the merging process is recursive, super-loci can be merged together in a subsequent merging step, which entails defining a new super-locus and grouping all underlying CNVs from each super-locus into the new super-locus. Recursive merging continues until no loci can be merged further, or until a maximum number of merge iterations have occurred (for example, no more than 10 iterations). Lastly, because CNV super-locus merging is performed only on high-confidence CNVs, a final step attempts to assign low-confidence CNVs to CNV super-loci based on a minimum overlap criterion (for example, at least 90% of the low-confidence CNV overlaps the super-locus). If an assignment is not made, the CNV has no associated super-locus. CNV locus definitions enable estimates of allele frequency, zygosity distributions, and testing of CNV associations with phenotypes.

A non-limiting example of a method for determining aneuploidy in a subject's genetic sequence is disclosed in U.S. Application No. 62/294,669, filed Feb. 12, 2016 (“Methods and Systems for Detection of Abnormal Karyotypes”), which is hereby incorporated by reference in its entirety.

The variant annotation component 212 can be configured to determine and assign functional information to the identified variants. The variant annotation component 212 can be configured to categorize each variant based on the variant's relationship to coding sequences in the genome and how the variant may change the coding sequence and affect the gene product. The variant annotation component 212 can be configured to annotate multi-nucleotide polymorphisms (MNPs). The variant annotation component 212 can be configured to measure sequence conservation. The variant annotation component 212 can be configured to predict the effect of a variant on protein structure and function. The variant annotation component 212 can also be configured provide database links to various public variant databases such as dbSNP. A result of the variant annotation component 212 can be a classification into accepted and deleterious mutations and/or a score reflecting the likelihood of a deleterious effect. The variant annotation component 212 can utilize a functional predictor component such as SnpEff. Combined Annotation Dependent Depletion (CADD), ANNOVAR, AnnTools, NGS-SNP, sequence variant analyzer (SVA), The ‘SeattleSeq’ Annotation server, VARIANT, Variant effect predictor (VEP), combinations thereof, and the like.

As a result of the variant identification component 210 and the variant annotation component 212, the genetic data component 202 can comprise identification and functional annotation of variants derived from sequence data generated by the NGS Sequencing Facility 106. Millions of variants can be identified and annotated (e.g., SNPs, indels, frameshift, truncations, synonymous, nonsynonymous, and the like) for hundreds of thousands of patients (subjects).

The genetic data component 202 can comprise identification and functional annotation of variants derived from sequencing subjects (a) in a general population, for example, a population of subjects who seek care at a medical system at which detailed longitudinal electronic health records are maintained on the subjects, (b) in a family affected by a Mendelian disease, and (c) in a founder population.

The genetic data component 202 can comprise identification and functional annotation of at least 1 million, 2 million, 3 million, 4 million, 5 million, 6 million, 7 million, 8 million, 9 million, 10 million, 11 million, 12 million, 13 million, 14 million, 15 million, 16 million 17 million, 18 million, 19 million or 20 million variants.

The genetic data component 202 can comprise identification and functional annotation of at least 150 thousand, 160 thousand, 170 thousand, 180 thousand, 190 thousand, 200 thousand, 210 thousand, 220 thousand, 230 thousand, 240 thousand, 250 thousand, 260 thousand, 270 thousand, 280 thousand, 290 thousand or 300 thousand, predicted loss of function variants.

Data in the genetic data component 202 can be used in a statistical analysis.

The phenotypic data component 204 can be configured for determining, storing, analyzing, receiving, and the like, one or more phenotypes for a patient (subject). The phenotypic data component 204 can be configured to determine one or more phenotypes for each of at least 100,000 patients (subjects). The patients (subjects) can be patients for whom sequencing data has been obtained and analyzed by the genetic data component 202. A result of determining one or more phenotypes is generation of phenotypic data. The phenotypic data can be determined from a plurality of categories of phenotypes (e.g., 1,500 or more categories).

The phenotypic data component 204 can comprise one or more components to determine the one or more phenotypes for a patient. A phenotype can be an observable physical or biochemical expression of a specific trait in an organism, such as a disease, stature, or blood type, based on genetic information and environmental influences. The phenotype of an organism can include factors such as physical appearance, biochemical processes, and behavior. Phenotype can include measurable biological (physiological, biochemical, and anatomical features), behavioral (psychometric pattern), or cognitive markers that are found more often in individuals with a disease or condition than in the general population. The phenotypic data component 204 can comprise a binary phenotype component 214, a quantitative phenotype component 216, a categorical phenotype component 218, a clinical narrative phenotype component 220, combinations thereof, and the like.

In an aspect, the binary phenotype component 214 can be configured for analyzing de-identified medical information to identify one or more codes assigned to a patient in the de-identified medical information. The one or more codes can be, for example, International Classification of Diseases codes (ICD-9, ICD-9-CM, ICD-10), Systematized Nomenclature of Medicine-Clinical Terms (SNOMED CT) codes, Unified Medical Language System (UMLS) codes, RxNorm codes, Current Procedural Terminology (CPT) codes, Logical Observation Identifier Names and Codes (LOINC) codes, MedDRA codes, drug names, billing codes, and the like. The one or more codes are based on controlled terminology and assigned to specific diagnoses and medical procedures. The binary phenotype component 214 can identify the existence (or non-existence) of the one or more codes, determine a phenotype(s) associated with the one or more codes, and assign the phenotype(s) to the patient associated with the de-identified medical information via a unique identifier.

In an aspect, the quantitative phenotype component 216 can be configured for analyzing de-identified medical information to identify continuous variables and assign a phenotype based on the identified continuous variable. A continuous variable can comprise a physiological measurement that can comprise one or more values over a range of values. For example, blood glucose, heart rate, any laboratory value, and the like. The quantitative phenotype component 214 can identify such continuous variables, apply the identified continuous variables to a pre-determined classification scale for the identified continuous variables, and assign a phenotype(s) to the patient associated with the de-identified medical information via a unique identifier.

In an aspect, the categorical phenotype component 218 can be configured for analyzing de-identified medical information to identify ranges of a given quantitative phenotype.

In an aspect, the clinical narrative phenotype component 220 can be a natural language processing (NLP) phenotype component configured for analyzing de-identified medical information to identify terms that can be used to assign a phenotype to a patient. The NLP phenotype component 220 can analyze, for example, narrative (unstructured) data contained in the de-identified medical information. The NLP phenotype component 220 can process text to extract information using linguistic rules. The NLP phenotype component 220 can break down sentences and phrases into words, and assign each word a part of speech—for example, a noun or adjective. The NLP phenotype component 220 can then apply linguistic rules to interpret the possible meaning of the sentence. In so doing, the NLP phenotype component 220 can identify concepts contained in the sentences. The NLP phenotype component 220 can link several terms to a concept by accessing one or more databases that standardize health terminologies, define the terms, and relate terms to each other and to a concept (e.g., an ontology). Such databases include the SNOMED CT, which organizes health terminologies into categories (such as body structure or clinical finding), RxNorm, which links drug names to other drug names in major pharmacy and drug interaction databases, and the Phenotype KnowledgeBase website (PheKB).

The genetic variant-phenotype association data component 206 can be configured for determining, storing, analyzing, receiving, and the like, one or more associations between the one or more genetic variants in the genetic variant data and the one or more phenotypes in the phenotypic data. In an aspect, the genetic variant-phenotype association data component 206 can generate a million or more (e.g., a billion or more) genetic variant-phenotype association results. The genetic variant-phenotype association data component 206 can comprise one or more components to determine the one or more associations. The genetic variant-phenotype association data component 206 can comprise a computational component 222, a quality component 224, combinations thereof, and the like. In an aspect, the genetic variant-phenotype association data component 206 can comprise a statistical package such as R.

In an aspect, the computational component 222 can be configured for performing one or more statistical tests. For example, the computational component 222 can be configured for performing Hardy-Weinberg equilibrium (HWE) analysis, Fisher's exact test, a BOLT-LMM analysis, a logistic regression, a linear mixed model, and the like for binary phenotypes. The computational component 222 can be configured for performing a linear regression, a linear mixed model, ANOVA, and the like for quantitative phenotypes. The computational component 222 can perform a series of single-locus statistic tests, examining each variant independently for association to a specific phenotype. The statistical test conducted depends on a variety of factors, such as quantitative phenotypes versus case/control phenotypes. In one embodiment, the computational component 222 can also calculate an odds ratio for each genetic variant-phenotype association.

Quantitative phenotypes can be analyzed using generalized linear model (GLM) approaches, for example the Analysis of Variance (ANOVA), which is similar to linear regression with a categorical predictor variable, in this case genotype classes. The null hypothesis of an ANOVA using a single variant is that there is no difference between the trait means of any genotype group. The assumptions of GLM and ANOVA are 1) the trait is normally distributed; 2) the trait variance within each group is the same (the groups are homoskedastic); 3) the groups are independent.

Dichotomous (binary) case/control phenotypes can be analyzed using contingency table methods, logistic regression, and the like. Contingency table tests examine and measure the deviation from independence that is expected under the null hypothesis that there is no association between the phenotype and genotype classes. Examples of this include the chi-square test and the Fisher's exact test.

Logistic regression is an extension of linear regression where the outcome of a linear model is transformed using a logistic function that predicts the probability of having case status given a genotype class. Logistic regression is often the preferred approach because it allows for adjustment for clinical covariates (and other factors), and can provide adjusted odds ratios as a measure of effect size. Logistic regression has been extensively developed, and numerous diagnostic procedures are available to aid interpretation of the model.

An odds ratio is a measure of effect size. In the present context, the odds ratio is the ratio of the odds of subjects in the “case” group having the variant of interest to the odds of subjects in the “control” group having the variant of interest. For example, the effect size of a statistical association can be measured as the ratio of the odds of the presence of the phenotype(s) of interest in subjects who have 1 or 2 copies of the variant allele of interest, to the ratio of the odds of the presence of the phenotype(s) of interest in subjects who do not have 1 or 2 copies of the variant allele of interest. For a potential loss of function variant, an odds ratio less than 1 suggests that the variant is a protective variant, and an odds ratio greater than 1 suggests that the variant is a risk or causative variant.

In one embodiment, the odds ratio is greater than 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, 9.0, 9.1, 9.2, 9.3, 9.4, 9.5, 9.6, 9.7, 9.8, 9.9 or 10.0. In another embodiment, the odds ratio is less than 0.90, 0.85, 0.80, 0.75, 0.70, 0.65, 0.60, 0.55, 0.50, 0.45, 0.40, 0.35, 0.30, 0.25, 0.20, 0.15, 0.10 or 0.05.

For both quantitative and dichotomous (binary) phenotypes analysis (regardless of the analysis method), there are a variety of ways that genotype data can be encoded or shaped for association tests. The choice of data encoding can have implications for the statistical power of a test, as the degrees of freedom for the test may change depending on the number of genotype-based groups that are formed. Allelic association tests examine the association between one allele of the variant and the phenotype. Genotypic association tests examine the association between genotypes (or genotype classes) and the phenotype. The genotypes for a variant can also be grouped into genotype classes or models, such as dominant, recessive, multiplicative, or additive models.

In a statistical analysis, a p-value, which is the probability of seeing a test statistic equal to or greater than the observed test statistic if the null hypothesis is true, is generated for each statistical test. In one embodiment, the p-value of a genetic variant-phenotype association or gene-phenotype is less than or equal to 1 times 10⁻⁵, 10⁻⁶, 10⁻⁷, 10⁻⁸, 10⁻⁹, 10⁻¹⁰, 10⁻¹¹, 10⁻¹², 10⁻¹³, 10⁻¹⁴, 10⁻¹⁵, 10⁻¹⁶, 10⁻¹⁷, 10⁻¹⁸, 10⁻¹⁹, 10⁻²⁰, 10⁻²¹, 10⁻²², 10⁻²³, 10⁻²⁴, 10⁻²⁵, 10⁻²⁶, 10⁻²⁷, 10⁻²⁸, 10⁻²⁹, 10⁻³⁰, 10⁻³¹, 10⁻³², 10⁻³³, 10⁻³⁴, 10⁻³⁵, 10⁻³⁶, 10⁻³⁷, 10⁻³⁸, 10⁻³⁹, 10⁻⁴⁰, 10⁻⁴⁵, 10⁻⁵⁰, 10⁻⁵⁵, 10⁻⁶⁰, 10⁻⁶⁵, 10⁻⁷⁰, 10⁻⁷⁵, 10⁻⁸⁰, 10⁻⁸⁵, 10⁻⁹⁰, 10⁻⁹⁵, 10⁻¹⁰⁰, 10⁻¹²⁵, 10⁻¹⁵⁰, 10⁻¹⁷⁵, 10⁻²⁰⁰, 10⁻²²⁵, 10⁻²⁵⁰, 10⁻²⁷⁵ or 10⁻³⁰⁰.

In a statistical analysis, a statistical test is generally called significant and the null hypothesis is rejected if the p-value falls below a predefined alpha value, for example 0.05. This is relative to a single statistical test; in the case of a genome wide association study (GWAS), hundreds of thousands to millions of tests are conducted, each one with its own false positive probability. The cumulative likelihood of finding one or more false positives over the entire GWAS analysis is therefore much higher.

In an aspect, the quality component 224 can be configured to identify evidence of systematic bias (from unrecognized population structure, analytical approach, genotyping artifacts, etc.). For example, the quality component 224 can determine a quantile-quantile (Q-Q) plot, and the like. The Q-Q plot can be used to characterize the extent to which the observed distribution of the test statistic follows the expected (null) distribution.

The genetic variant-phenotype association data component 206 can be configured to generate genetic variant-phenotype association results and/or gene-phenotype association results with new results automatically calculated at each genetic data freeze (number of subjects sequenced). Factors involved in the number of genetic variant-phenotype association and/or gene-phenotype association results that can be generated include the number of genes and/or genetic variants, the number of phenotypes and the number of statistical tests or models that are performed. Thus, the genetic variant-phenotype association data component 206 is thus infinitely scalable. In one embodiment, a genetic variant-phenotype association result and/or gene-phenotype association result analysis for a desired number of genes and/or genetic variants, a desired number of phenotypes and the number of applied statistical tests or models.

In one embodiment, the genetic variant-phenotype association data component is configured to generate and store at least 10 million, 20 million, 30 million, 40 million, 50 million, 60 million, 70 million, 80 million, 90 million, 100 million, 200 million, 300 million, 400 million, 500 million, 600 million, 700 million, 800 million, 900 million, 1 billion, 1.2 billion, 1.3, billion, 1.4 billion, 1.5 billion, 1.6 billion, 1.7 billion, 1.8 billion, 1.9 billion, 2 billion, 2.1 billion, 2.2 billion, 2.3 billion, 2.4 billion, 2.5 billion, 2.6 billion, 2.7 billion, 2.8 billion, 2.9 billion, 3 billion, 4 billion, 5 billion, 6 billion, 7 billion 8 billion, 9 billion, 11 billion, 12 billion, 13 billion, 14 billion, 15 billion, 16 billion, 17 billion, 18 billion, 19 billion, 20 billion, 21 billion, 22 billion, 23 billion, 24 billion, 25 billion, 26 billion, 27 billion, 28 billion, 29 billion or 30 billion genetic variant-phenotype association and/or gene-phenotype results. At larger scale, analytical approaches that are useful in founder population analysis become useful in populations that are larger than a founder population.

Results from the genetic variant-phenotype association data component 206 can be aggregated and stored at one or more of the Local Data/Processing Center 102 and/or the Remote Data/Processing Center 108. Instances of the genetic variant-phenotype association data component 206 can be optimized to facilitate an all-by-all results generation (all variants/all phenotypes) and can facilitate bespoke results generation (e.g., calculate results for phenotype(s) of interest). In the case of an all-by-all and a bespoke analysis, all results can be stored for subsequent review.

The data analysis component 208 can be configured for generating, storing and indexing results from the genetic variant-phenotype association data component 206. For example, results can be indexed by variant(s), results can be indexed by phenotype(s), combinations thereof, and the like. The data analysis component 208 can be configured to perform data mining, artificial intelligence techniques (e.g., machine learning), and/or predictive analytics. The data analysis component 208 can generate and store a visualization, for example, a Manhattan plot, that shows variants along the x-axis and significance along the y-axis.

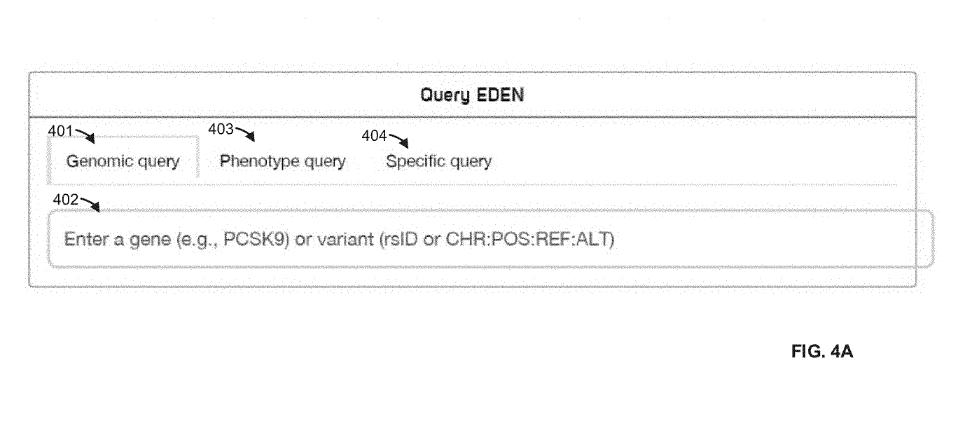

In an aspect, illustrated in FIG. 3, one or more of the Local Data/Processing Center 102 and/or the Remote Data/Processing Center 108 can comprise one or more computing devices that comprise one or more of, a phenotype data interface 302, a genetic variant data interface 304, a pedigree interface 306, and/or a results interface 308.

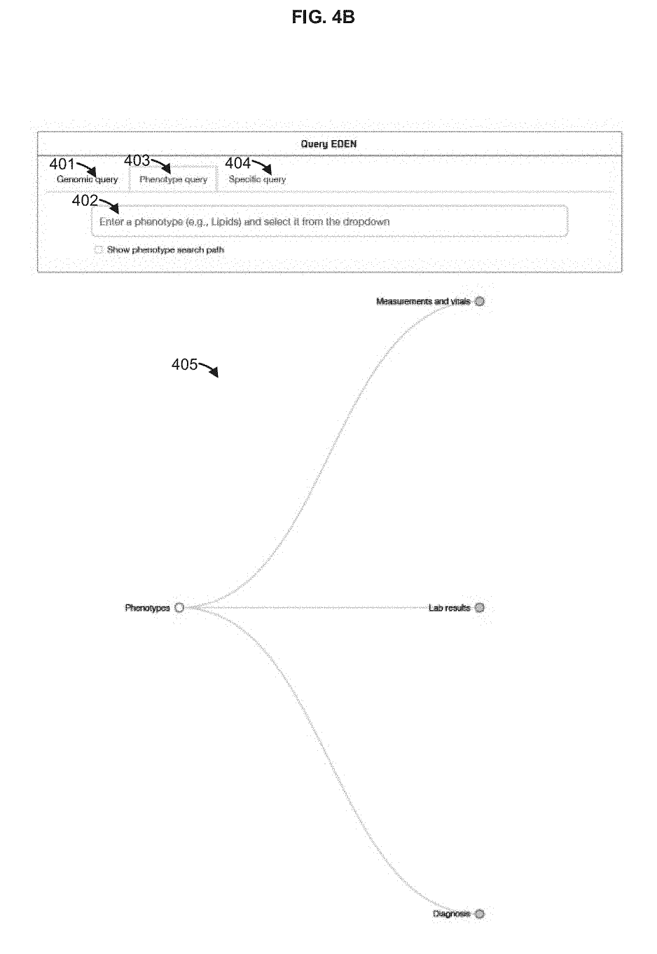

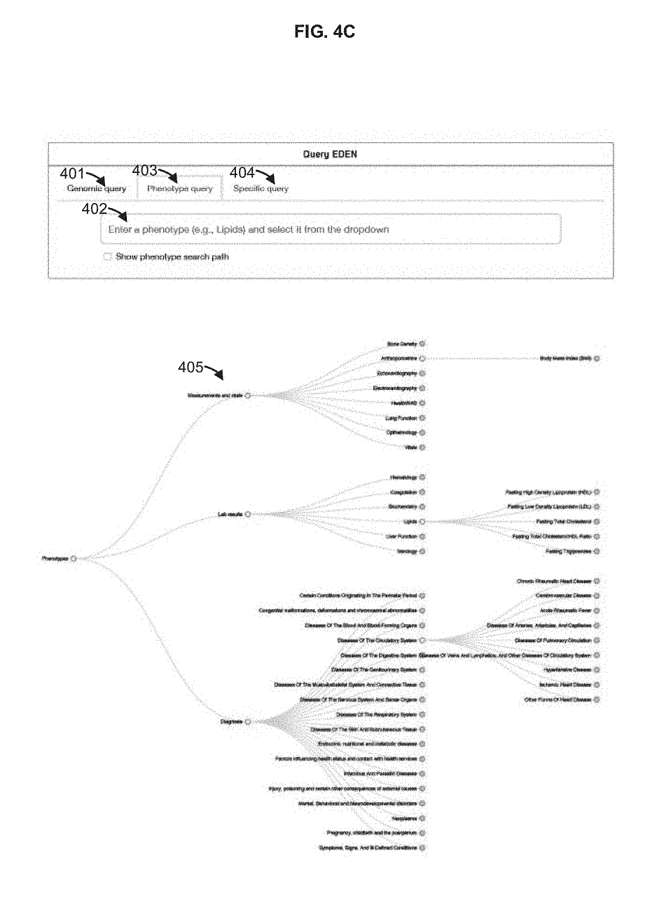

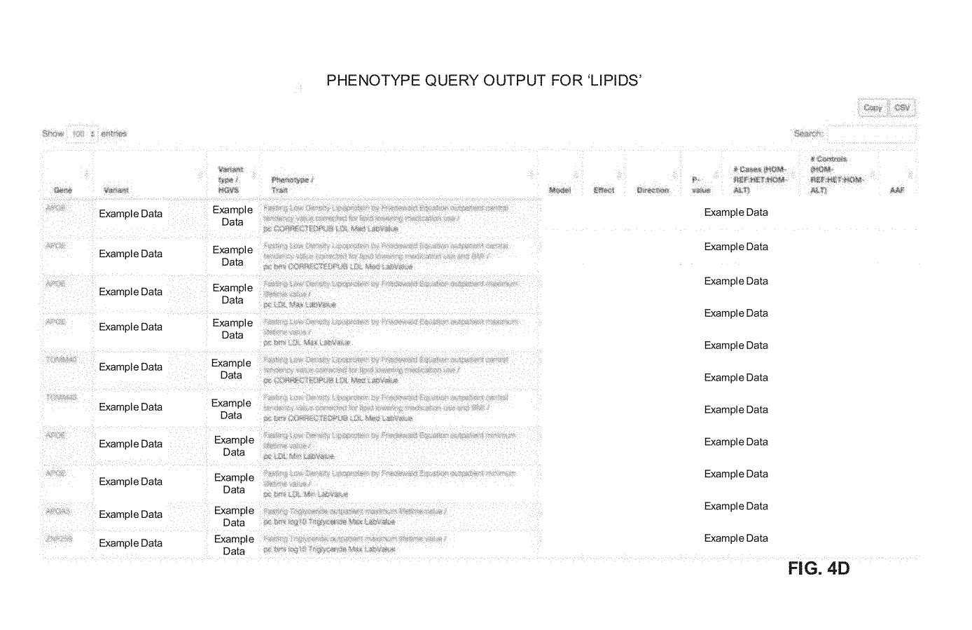

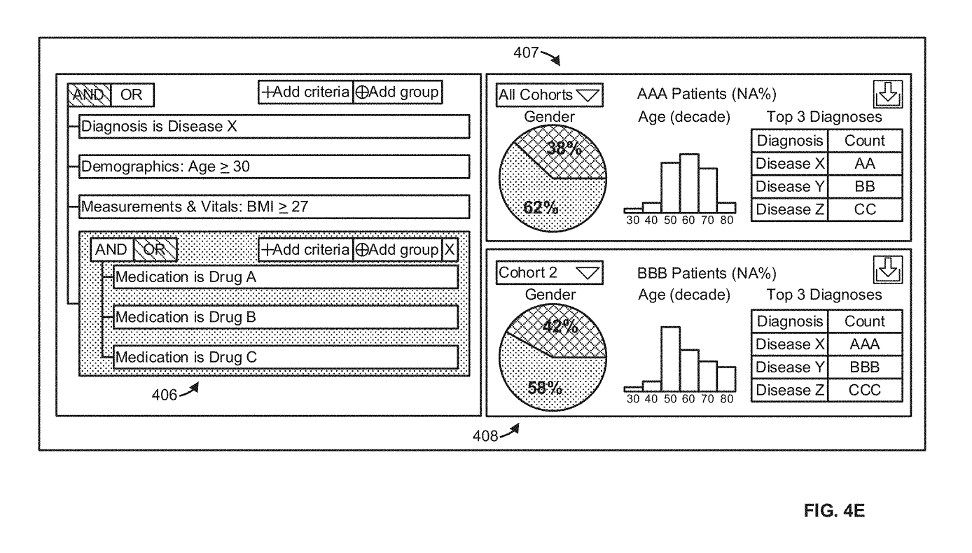

The phenotype data interface 302 can access data stored in the phenotypic data component 204. The phenotype data interface 302 can comprise one or more of a phenotype data viewer 302a, a query/visualization component 302b, and/or a data exchange interface 302c. The phenotype data viewer 302a can comprise a graphical user interface configured to permit a user to input one or more queries into the query/visualization component 302b. FIG. 4A illustrates an example graphical user interface for querying and/or displaying results from one or more of the phenotype data interface 302 and/or the genetic variant data interface 304. User interface element 401 can be engaged to enable query entry element 402 to receive and transmit a query to the phenotype data interface 302. User interface element 403 can be engaged to enable query entry element 402 to receive and transmit a query to the genetic variant data interface 304. User interface element 404 can be engaged to enable query entry element 402 to receive and transmit a query to both the phenotype data interface 302 and the genetic variant data interface 304. FIG. 4B illustrates an example graphical user interface for querying and/or displaying results from the phenotype data interface 302 by selection of the user interface element 403. A specific phenotype can be entered as a query into the query entry element 402. The query entry element 402 can further comprise a drop down list of phenotypes. The drop down list of phenotypes can comprise all the phenotypes contained with a graphical depiction of phenotypes 405. In a further aspect, the graphical depiction of phenotypes 405 can be generated and browsed to query for a specific phenotype. The graphical depiction of phenotypes 405 can comprise a hierarchy (or other relationship structure) of phenotypes based, for example, on ICD-9 codes. Engaging one or more elements on the graphical depiction of phenotypes 405 can result in further expansion of the graphical depiction of phenotypes 405 as shown in FIG. 4C. A query can be generated based on engaging one or more elements on the graphical depiction of phenotypes 405. An example query result is illustrated in FIG. 4D for a phenotype query of “Lipids”. The query result indicates all genes associated with lipids and includes various data associated with the genes (e.g., gene, chromosome number, genomic position, a reference, alternative alleles, variant, variant name, predicted type of variant, amino acid change, specific phenotype, and the like).

The graphical user interface can also be configured to display one or more data visualizations. The one or more data visualizations can be static or can be interactive. FIG. 4E illustrates an example phenotype data viewer 302a.

The query/visualization component 302b can comprise data querying functionality, data visualization functionality, and the like. For example, the query/visualization component 302b can be configured to query phenotype data (including medical information) stored in an acyclic graph. In an aspect, the query/visualization component 302b can query by gene, gene set, and/or variant. The acyclic graph can be built utilizing relationships from Unified Medical Language System (UMLS) hierarchies. For example, nodes of the acyclic graph can comprise phenotypes and edges between nodes can comprise relationships such as “has diagnoses,” “has medication,” and the like. An example of a type of query can be “How many patients have this disease or take this medication?” Additionally, a query can specify specific lab results (e.g., ldl>200). The acyclic graph can comprise metadata regarding the phenotype data, for example, which dataset the data was derived from, and the like. The query/visualization component 302b can generate and display one or more visualizations of query results. The one or more visualizations enable users to view graphical representations of query results. Data visualization formats include by way of example, bar charts, tree charts, pie charts, line graphs, bubble graphs, geographic maps, and any other format in which data can be graphically represented.

The phenotype data viewer 302a in FIG. 4E illustrates results of a single query applied to all cohorts and applied to a Cohort 2. The phenotype data viewer 302a enables a user to intuitively build a query by adding or deleting any number of criteria to the query with support for Boolean logic at input area 406. The illustrated query is for all patients diagnosed with Disease X who are at least 30 years old with a body mass index (BMI) of at least 27 that have been prescribed either Drug A, Drug B, or Drug C. The query can be sent to the query/visualization component 302b for processing.

The query/visualization component 302b can be configured to apply the query against some or all phenotype data (including medical information). The phenotype data (including medical information) can be divided into one or more cohorts. A query can be applied to one or more cohorts separately and the results displayed for comparison between cohorts. In an aspect, variants in common between two groups can be determined.

The phenotype data viewer 302a in FIG. 4E illustrates results of the query as applied to all cohorts (display area 407) and applied to Cohort 2 (display area 408). The phenotype data viewer 302a enables download of query results in any data format (e.g., text file, spread sheet, etc. . . . ). The phenotype data viewer 302a can display trending searches to assist users by identifying other users that are conducting the same or similar query (e.g., phenotype/variant).

The data exchange interface 302c permits output of other interfaces to be used as input into the phenotype data interface 302 and permits output of the phenotype data interface 302 to be used as input into other interfaces. In an aspect, one or more other interfaces can be launched from the phenotype data interface 302 and one or more query results of the phenotype data interface 302 can be passed to the one or more other interfaces as input. For example, the phenotype data interface 302 can receive a predefined cohort based on a common variant from a genetic variant data interface 304. The phenotype data interface 302 can apply a query to the predefined cohort and additional cohorts. The data exchange interface 302c can also provide query results as input to a pedigree interface 306 to determine which patients contained in the query results are in a pedigree.

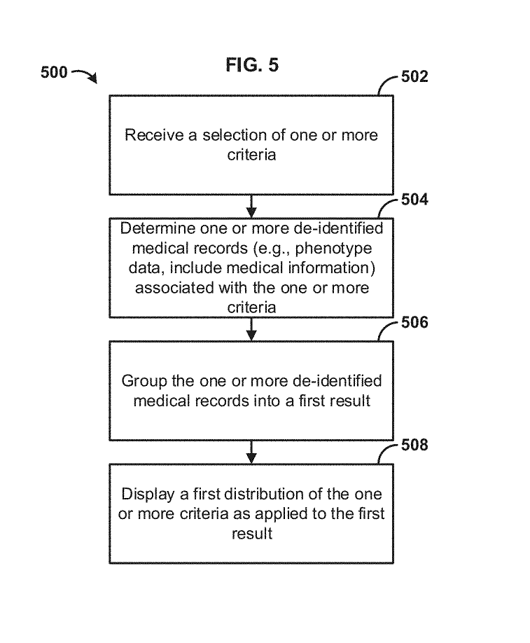

In an aspect, illustrated in FIG. 5, provided is a method 500 comprising receiving a selection of one or more criteria at 502. The one or more criteria can comprise one or more of a diagnosis, a demographic, a measurement, a vital, a medication, and the like. The method 500 can further comprise receiving a toggle interaction via an interface element, wherein the toggle interaction causes one or more operators to change a state as applied to the one or more criteria. The state can comprise one of AND, OR, or XOR.

The method 500 can comprise determining one or more de-identified medical records (e.g., phenotype data, including medical information) associated with the one or more criteria at 504. The one or more de-identified medical records can be associated with the first cohort. The method 500 can comprise grouping the one or more de-identified medical records into a first result at 506.

The method 500 can comprise displaying a first distribution of the one or more criteria as applied to the first result at 508. The method 500 can further comprise receiving a first selection of a first cohort of a plurality of cohorts. The method 500 can further comprise receiving a second selection of a second cohort of the plurality of cohorts. The method 500 can further comprise determining one or more de-identified medical records associated with the one or more criteria, wherein the one or more de-identified medical records are associated with the second cohort, grouping the one or more de-identified medical records into a second result, and displaying a second distribution of the one or more criteria as applied to the second result

The method 500 can further comprise receiving a request for a genetic profile of the one or more de-identified medical records, transmitting the request, wherein the request comprises an identifier for each of the one or more de-identified medical records, and receiving, the genetic profile from a remote computing device. The genetic profile can comprise one or more DNA sequences. The one or more DNA sequences can comprise one or more DNA sequence variants.

The method 500 can further comprise compiling the genetic profile and the one or more de-identified medical records into a dataset. The method 500 can further comprise processing the dataset to identify an association between a genetic profile and a medical condition. By way of example, the method 500 can be performed via the phenotype data interface 302.

Returning to FIG. 3, the genetic variant data interface 304 can access data stored in the genetic data component 202. The genetic variant data interface 304 enables tracking of all variants, including copy number variants (“CNVs”) that have been identified as part of exome sequencing efforts, and provides context about variant frequency and putative function. Any SNPs or Indels observed in at least one patient are recorded in the genetic data component 202 and accessible by the genetic variant data interface 304. In some aspects, variants with two distinct alternate alleles are recorded.

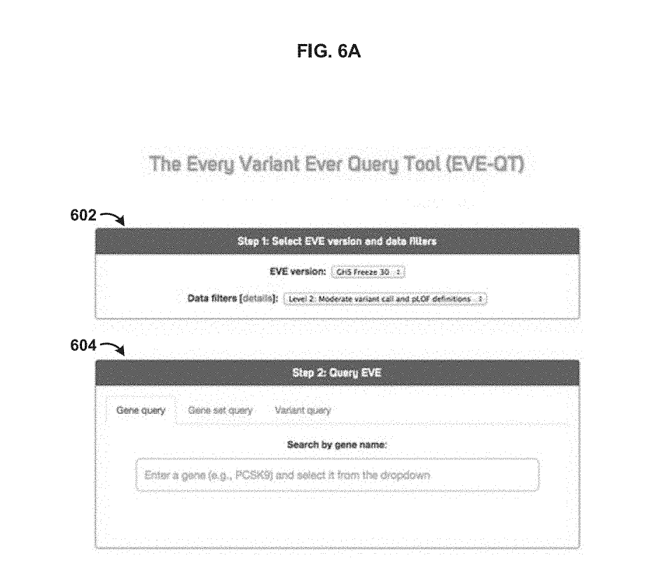

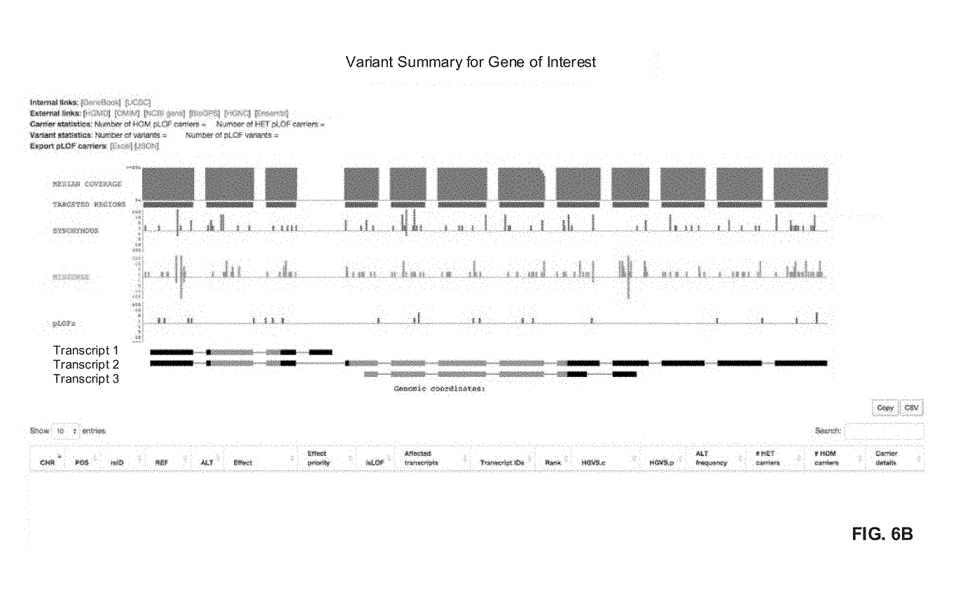

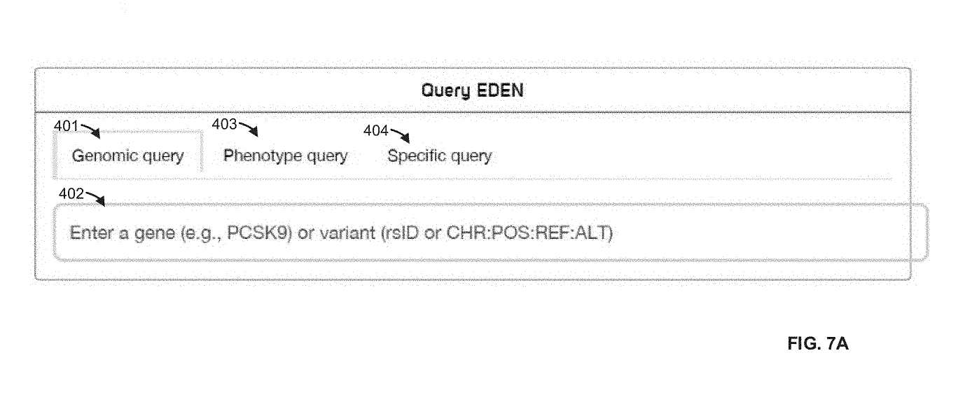

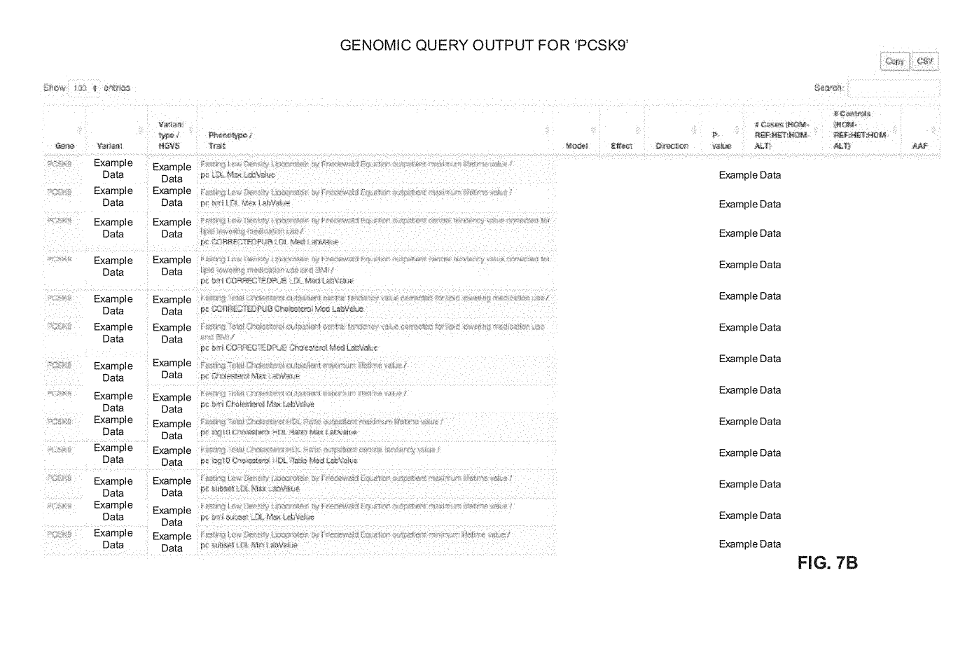

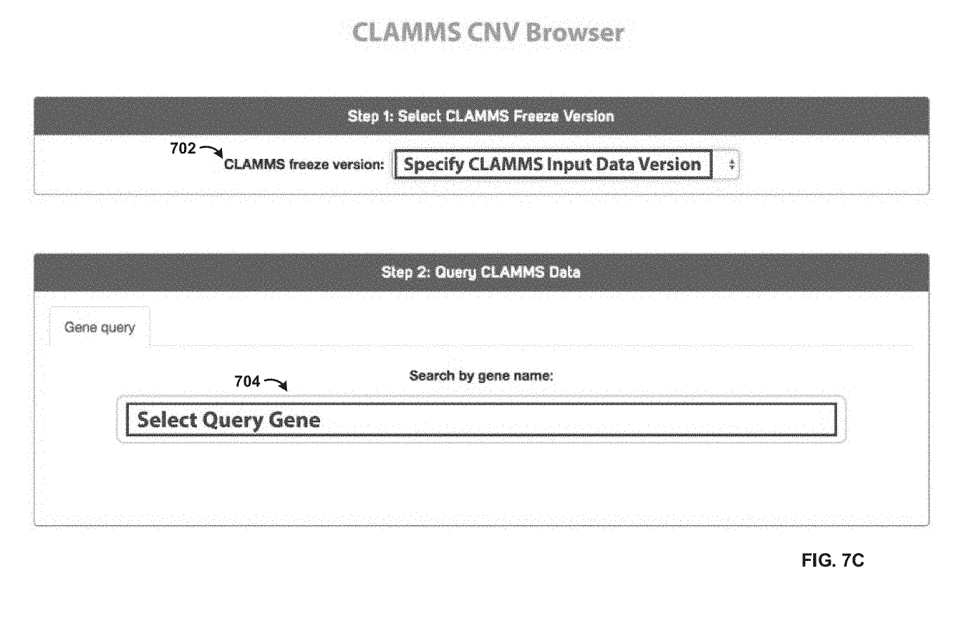

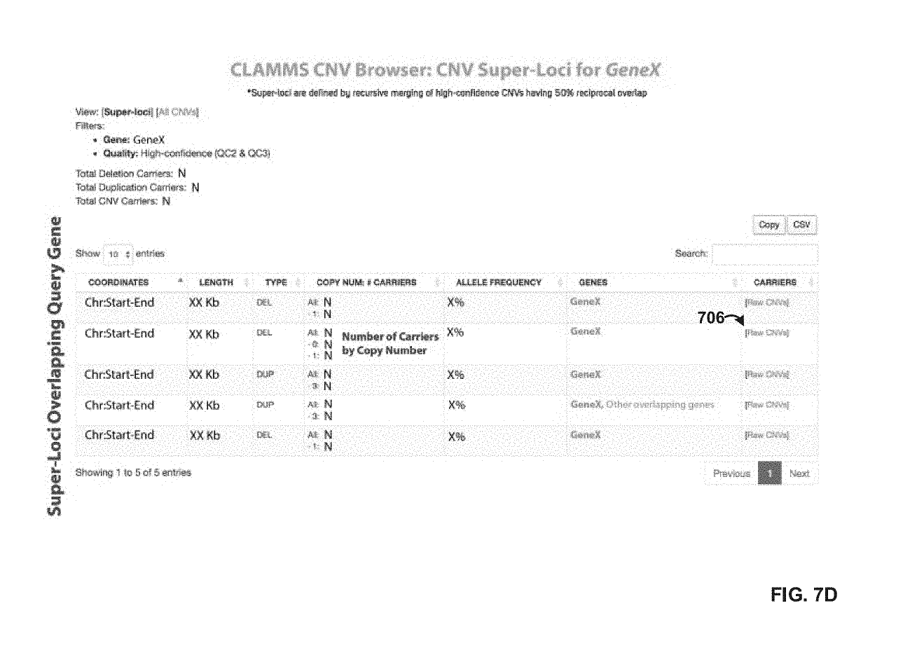

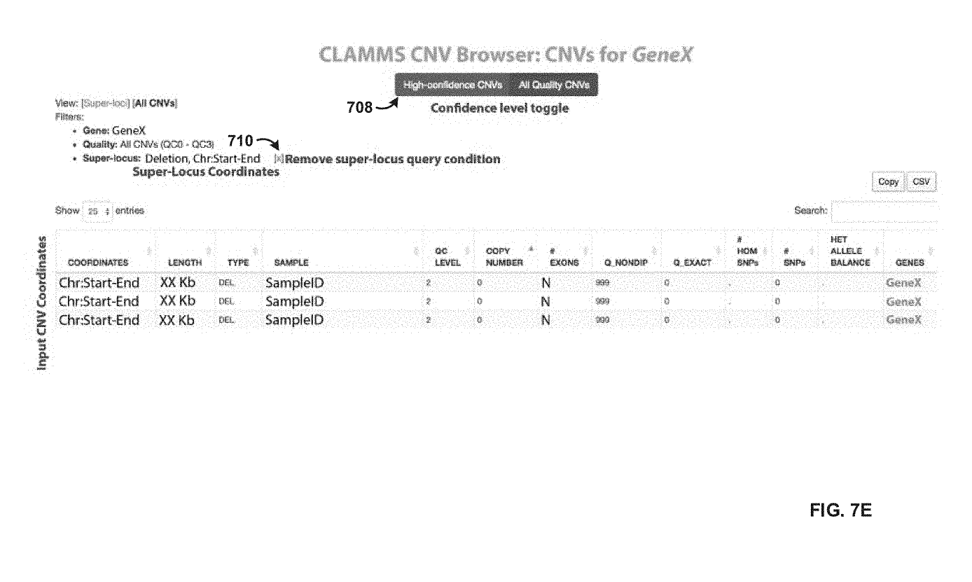

In an aspect, the genetic variant data interface 304 can comprise one or more of a genetic variant data viewer 304a, a query/visualization component 304b, and/or a data exchange interface 304c. The genetic variant data viewer 304a can comprise a graphical user interface configured to permit a user to input one or more queries into the query/visualization component 304b. The graphical user interface can also be configured to display one or more data visualizations. The one or more data visualizations can be static or can be interactive. The genetic variant data viewer 304a can enable the viewing of annotated genetic variant data. FIG. 6A and FIG. 6B illustrate an example genetic variant data viewer 304a. FIG. 7A illustrates an example graphical user interface for querying and/or displaying results from the genetic data interface 304 by selection of the user interface element 401. A specific gene or a specific variant can be entered as a query into the query entry element 402. The query entry element 402 can further comprise a drop down list of genes and/or variants. An example query result is illustrated in FIG. 7B for a gene query of “PCSK9”. The query result indicates all variants associated with PCSK9 and includes various data associated with the variants (e.g., gene, chromosome number, genomic position, a reference, alternative alleles, variant, variant name, predicted type of variant, amino acid change, specific phenotype, and the like).

The query/visualization component 304b can comprise data querying functionality, data visualization functionality, and the like. For example, the query/visualization component 304b can be configured to query genetic variant data stored in one or more VCF files in the genetic data component 202. For example, the query/visualization component 304b can query by gene, by gene sets, and/or by variant. FIG. 6 illustrates an example genetic variant data viewer 304a configured for receiving a query as input from a user. The user can specify a data set to query and data filters to apply, if any, in input area 602. The user can then enter a gene, a gene set, and/or a variant at input area 604.

In the case of a gene query, the query/visualization component 304b can retrieve variants that overlap with a gene of interest. Results of an example search by gene of interest are shown in FIG. 6B. The results visualization can include one or more of a variogram of targeted regions and observe read coverage (median), carrier information (log-scaled) for different functional classes, and gene models with functional domains. Also shown in the figure is a table with information about genomic coordinates (chromosome position of the variant, reference allele, alternate allele, rsID, if available), functional effect prediction, effect priority, an indication of whether or not the functional effect is likely to result in putative loss-of-function (Is_pLoF), the affected transcripts, a ranking of the exon number relative to the transcript start site, HGVS notation describing the functional impact at the cDNA level, HGVS notation describing the functional impact at the protein level, the frequency of the alternate allele, the number of heterozygous carriers, the number of homozygous carriers, and links to separate pages providing carrier information and additional annotations.

In another case of a gene query, the query/visualization component 304b can retrieve CNV-related data based on a query gene of interest. As described with regard to FIG. 2, the variant identification component 210 can identify (e.g., call) one or more variants, including CNV identification. The genetic variant data viewer 304a can thus comprise a CNV browser. As described supra, CLAMMS can be used to generate CNV locus definitions that enable estimates of allele frequency, zygosity distributions, and testing of CNV associations with phenotypes. The CNV browser can be based on the locus definitions, which can be defined for a specific set of input CNVs that were used for the locus merging process. FIG. 7C illustrates an example graphical user interface for querying and/or displaying CNV related results from the genetic data interface 304 by selection of user interface element 702. A user can select via the user interface element 702 a CLAMMS CNV version (defining the input set of CNV calls) where the user can search for all CNV loci that overlap with a query gene entered into user interface element 704.

Results of an example search of CNV-related data by gene of interest are shown in FIG. 7D. The user can be provided a total number of carriers having duplications, deletions, or any CNVs overlapping the query gene, followed by a table listing all super-loci that overlap the query gene. Each locus can have information including the coordinates, number of carriers (total as well as a breakdown by copy-number), allele frequency, a list of genes overlapping the locus (including the query gene), and a link to view the “Raw CNVs”, which are the carrier-specific input CNVs used to build the super-locus.

The user can engage user interface element 706 “Raw CNVs” (e.g., in the form of a hyperlink). Engaging the user interface element 706 for a locus brings the user to a detailed super-locus view page illustrated in FIG. 7E. The user can be provided with a toggle switch (user interface element 708) between high-confidence CNVs and all quality CNVs, allowing for additional CNVs not passing high-confidence QC criteria to be viewed. The super-locus definition query condition can also be removed by clicking the “[X]” (user interface element 710), allowing all raw CNVs for the original query gene to be viewed (including low-confidence CNVs). Rows in the subsequent table correspond to CNV calls made in an individual sample, along with the raw coordinates (which will be equal to or within the super-locus boundary), QC level, predicted copy number (homozygous deletions are displayed as copy number 0), number of exons, call level QC metrics, and overlapping gene names.

In the case of a gene set query, the query/visualization component 304b can obtain variant/pLoF summaries for gene sets. The results visualization can include one or more of a gene-level pLoF summary created for defined gene sets, gene ID (e.g., Ensembl gene ID), gene name, the number of individuals that carry at least one homozygous pLoF variant in a gene, the number of individuals that carry at least one heterozygous pLoF variant in a gene, the number of individuals that carry at least one homozygous SNP causing a non-synonymous change in a gene, the number of individuals that carry at least one heterozygous SNP causing a non-synonymous change in a gene, the number of frameshift sites in a gene, the number of stop gained sites in a gene, the number of start lost sites in a gene, the number of sites affecting a splice acceptor site in a gene, the number of sites causing a stop loss in a gene, the number of inframe Indels in a gene, the number of non-synonymous sites in a gene and the number of synonymous sites in a gene.

In the case of a variant query, the query/visualization component 304b can obtain the carriers that are associated with a particular variant. The results visualization can include a table containing one or more of a sample name, an indication of zygosity, an indication of a quality metric (e.g., pass/fail for each of L1, L2, L3), and links to other pages, e.g., a raw VCF lookup or a read stack view. The query/visualization component 304b can be configured to generate and display one or more visualizations of query results. The one or more visualizations enable users to view graphical representations of query results. Data visualization formats include by way of example, bar charts, tree charts, pie charts, line graphs, bubble graphs, geographic maps, and any other format in which data can be graphically represented.

The query/visualization component 304b can be configured to explore coverage/callability of regions in the genome based on achieved median coverage, visualize variant position in the context of gene/variant transcripts, explore relative location and density of variants by functional class (e.g., synonymous, missense or pLoF), identify the numbers of carriers in population of variants (by class and by variant), find relevant transcripts for a variant, determine amino acid impact of a variant, determine the frequency of a variant (in genetic data component 202 or in another database to which data exchange interface 304c is linked), connect variants in genetic data component 202 to RSIDs, explore detailed variant annotations, export variant data (e.g., to a spreadsheet (such as an Excel spreadsheet) or in PDF format), export variant data to phenotype data interface 302, extract and display read-stack information for visual validation, and provide variant quality information in terms of filter level.

In an aspect, the query/visualization component 304b can be configured to generate allele frequency spectra for different cohorts and analyze differences therein. For example, a user can use the query/visualization component 304b to identify variants that are enriched 10×, 100×, etc. between cohorts. The query/visualization component 304b can then be used to compare cohorts and see which cohorts have the highest concentration of a variant of interest or highest concentration of variants in a gene of interest. The query/visualization component 304b can also be used to display the number of subjects in a heterozygous state or in a homozygous state for a given variant.

The data exchange interface 304c permits output of other interfaces to be used as input into the genetic variant data interface 304 and permits output of the genetic variant data interface 304 to be used as input into other interfaces. In an aspect, one or more other interfaces can be launched from the genetic variant data interface 304 and one or more query results of the genetic variant data interface 304 passed to the one or more other interfaces as input. For example, the genetic variant data interface 304 can receive a gene of interest from a phenotype data interface 302. The genetic variant data interface 304 can apply a query based on the received gene of interest. The data exchange interface 304c can also provide query results as input to a pedigree interface 306 to determine which patients contained in the query results are in a pedigree.

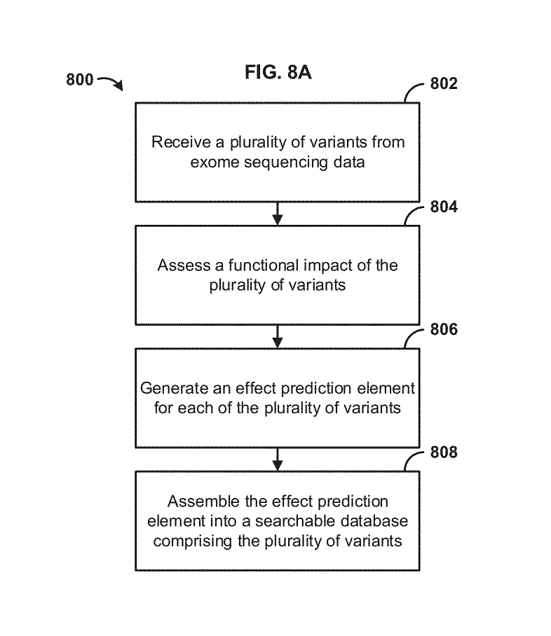

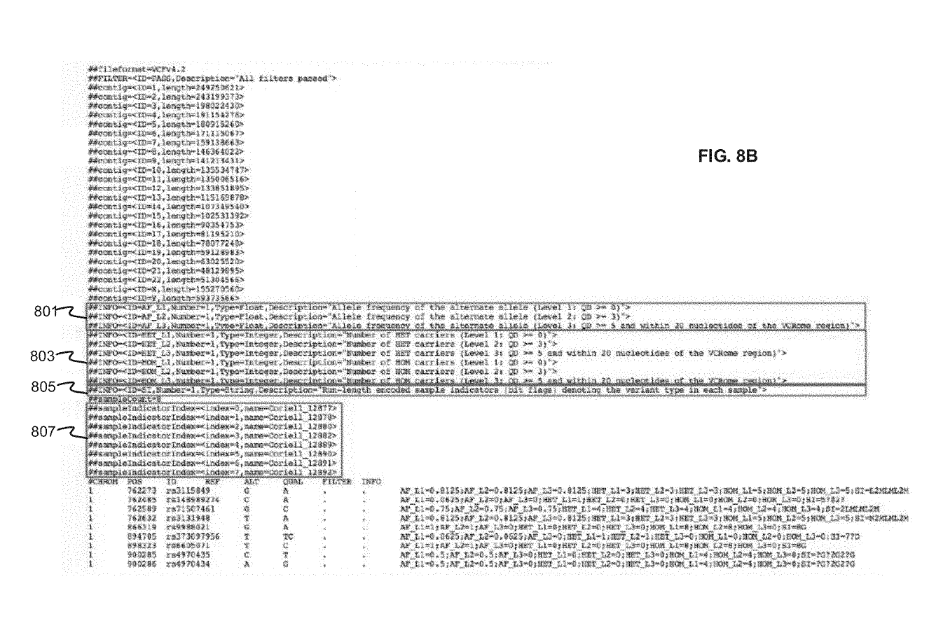

In an aspect, illustrated in FIG. 8A, provided is a method 800 comprising receiving a plurality of variants from exome sequencing data at 802. The method 800 can comprise assessing a functional impact of the plurality of variants at 804. The method 800 can comprise generating an effect prediction element for each of the plurality of variants at 806. Generating an effect prediction element for each of the plurality of variants can comprise identifying each of the plurality of variants as a potential loss-of-function (pLoF) candidate. Identifying each of the plurality of variants as a potential loss-of-function (pLoF) candidate can comprise identifying a level of quality associated with each variant call for each of the plurality of variants and applying a pLoF definition based on the level of quality. Identifying each of the plurality of variants as a potential loss-of-function (pLoF) candidate can comprise applying a genetic variant annotation and effect prediction method to each of the plurality of variants (see Table 1). As used herein, the term “effect prediction” refers to the prediction of the effect of a variant on the biochemical structure and function of the expression product of the variant gene, and not to a prediction of the effect of a variant on a phenotype.

TABLE 1
Hierarchy of functional annotation assignment for
DiscovEHR exome sequence variants

| | | Effect | pLoF |
|---|---|---|---|
| Effect | Description | Priority | Variant |
| “frameshift | Variant causes a frame shift (e.g., | 1 | Yes |
| variant” | insertion or deletion (Indel) size that is | | |
| | not a multiple of three) | | |
| “stop gained” | Variant causes a STOP codon (e.g., Cag/Tag, | 2 | Yes |
| | Q/*) | | |
| “start lost” | Variant causes start codon to be mutated | 3 | Yes |
| | into a non-start codon (e.g., aTg/aGg, M/R) | | |
| “splice acceptor | Variant hits a splice acceptor site (defined | 4 | Yes |
| variant” | as two bases before exon start, except for | | |
| | the first exon) | | |
| “splice donor | Variant hits a splice donor site (defined as | 5 | Yes |
| variant” | two bases after coding exon end, except | | |
| | for the last exon) | | |
| “stop lost” | Variant causes stop codon to be mutated | 6 | Yes |
| | into a non-stop codon (e.g., Tga/Cga, */R) | | |
| “inframe indel” | Variant inserts or deletes one or many | 7 | No |
| | codons (i.e., a multiple of three) | | |
| “missense | Variant causes a codon that produces a | 8 | No |
| variant” | different amino acid (e.g., Tgg/Cgg, W/R) | | |
| “splice region | Variant occurs within the region of the | 9 | No |
| variant” | splice site, either within 1-3 bases of the | | |
| | exon or 3-8 bases of the intron | | |
| “synonymous | Variant causes a codon that produces the | 10 | No |
| variant” | same amino acid (e.g., Ttg/Ctg, L/L) | | |

The method 800 can comprise assembling the effect prediction element into a searchable database comprising the plurality of variants at 808. The searchable database can be configured for searching by one or more of a gene, a gene set, and a variant. The method 800 can further comprise assigning one or more of the plurality of variants to an individual.

In an aspect, the method 800 can further comprise generating or querying a custom Variant Call Format (VCF) file encoding variants of genotypes. In an aspect, the custom VCF file can be generated from a plurality of standard VCF files each indicating the genomic coordinates of one or more variants. Generating the custom VCF file can include determining, for each distinct variant, determining which of the VCF files include the respective variant. A single table can then be generated comprising a row for each variant, and a column corresponding to each of the VCF files. An entry in the table for a given row (variant) and column (VCF file) would indicate whether the variant for the given row is present in the given file. In an aspect, the table can include a column for Run-Length Encodings (RLE), with each entry indicating the RLE for the corresponding row's variant. Thus, variants indicated across a plurality of VCF files can instead be expressed as a single table. RLE is a form of lossless data compression in which runs of data (that is, sequences in which the same data value occurs in many consecutive data elements) are stored as a single data value and count, rather than as the original run. The use of RLE as described herein is highly efficient given that the majority of variants are “rare” (e.g., approximately 85% of the variant sites have less than 10 carriers).

For example, the following illustrates six example VCF input files, with each entry comprising the genomic coordinates of a variant:

| VCF1 | VCF2 | VCF3 | VCF4 | VCF5 | VCF6 |
|---|---|---|---|---|---|
| 1:1002:A:T | 1:1002:A:T | 1:1039:G:C | 1:1039:G:C | 1:2107:T:G | 1:1002:A:C |
| 1:1039:G:C | 2:5268:C:A | 3:3024:T:C | 3:3024:T:C | 4:9848:A:C | 1:1039:G:C |
| 1:2017:T:G | 4:9848:A:C | 4:9848:A:C | 4:9848:A:C | 5:3243:T:G | 2:5268:C:A |
| 4:9848:A:C | | | 5:3243:T:G | | |

The resulting table indicating which of each variant is included in each VCF file can then be expressed as the following, with “A” indicating that the corresponding variant is absent from the corresponding VCF file, and “P” indicating that the corresponding site is present in the corresponding VCF file:

| SITE | VCF1 | VCF2 | VCF3 | VCF4 | VCF5 | VCF6 | RLE |
|---|---|---|---|---|---|---|---|
| 1:1002:A:C | A | A | A | A | A | P | 5AP |
| 1:1002:A:T | P | P | A | A | A | A | 2P4A |
| 1:1039:G:C | P | A | P | P | A | P | PA2PAP |
| 1:2017:T:G | P | A | A | A | P | A | P3APA |
| 2:5268:C:A | A | P | A | A | A | P | AP3AP |
| 3:3024:T:C | A | A | P | P | A | A | 2A2P2A |
| 4:9848:A:C | P | P | P | P | P | A | 5PA |
| 5:3243:T:G | A | A | A | P | P | A | 3A2PA |

Thus, the table as expressed above allows for multiple VCF files to be consolidated into a single table, allowing for reduced data storage as well as increased speed of access when identifying variants. Moreover, the table can be used to regenerate the original VCF files from which the table was generated.

The method 800 can further comprise encoding additional information for each site. Such additional information can include whether or not there is a variant call, variant level (e.g. L1, L2, and/or L3), VQSR, zygosity, etc. In an aspect, each attribute to be encoded can be expressed as a bit flag. For example, the following attributes, along with an American Standard Code for Information Interchange (ASCII) offset to be addressed below, can be encoded as follows:

| Attribute | Bit Flag | Integer Value |
|---|---|---|
| ASCII_OFFSET | 01000000 | 64 |
| NO_CALL | 00111111 | 63 |
| CALL | 00000000 | 0 |
| HOM | 00000001 | 1 |
| VQSR | 00000010 | 2 |
| L2 | 00000100 | 4 |
| L3 | 00001000 | 8 |

Thus the method 800 can receive a plurality of VCF files, determine one or more variant sites in common among the plurality of VCF files, generate an index identifying presence or absence of the one or more variant sites for each of the plurality of VCF files, encode a plurality of attributes as a single value for each of the plurality of VCF files, and generate a final VCF file comprising the index and the encoded plurality of variables, wherein the query/visualization component is configured to query genetic variant data stored in the final VCF file as shown in FIG. 8B. FIG. 8B shows an example final VCF file that comprises allele frequencies for each quality metric (L1, L2, L3) 801, a number of HET and HOM carriers for the quality metrics 803, run-length encoded sample indicators 805, and a sample indicator index 807 relating sample indicators to sample names.

The method 800 can further comprise determining which of the plurality of variants are included on a white list of transcripts and filtering the plurality of variants included on the white list, resulting in a filtered set of variants. The method 800 can further comprise selecting the most deleterious functional effect class for each gene represented by the filtered set of variants. Selecting the most deleterious functional effect class for each gene can comprise applying a deleteriousness hierarchy to the filtered set of variants.

The method 800 can further comprise receiving a search query comprising a query variant and identifying one or more individuals associated with the query variant. The method 800 can further comprise receiving a request for one or more de-identified medical records associated with the one or more individuals, transmitting the request, wherein the request comprises an identifier for each of the one or more individuals, and receiving, the one or more de-identified medical records a remote computing device. By way of example, the method 800 can be performed via the genetic variant data interface 304.

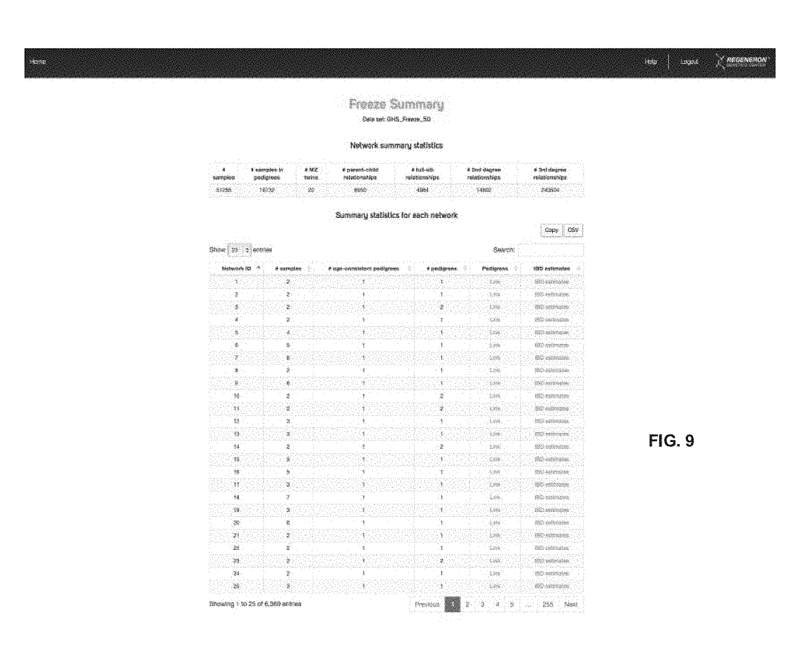

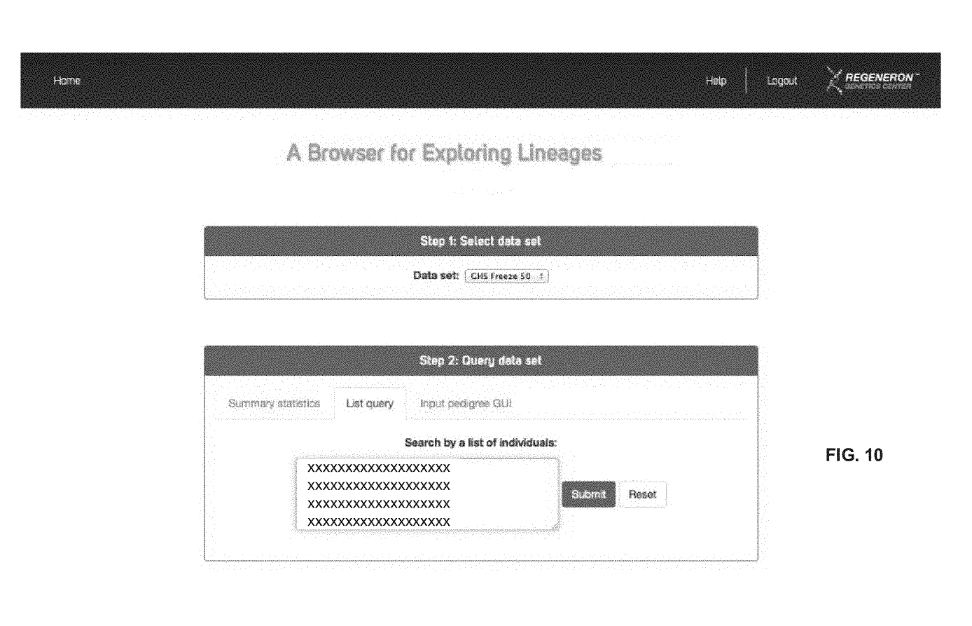

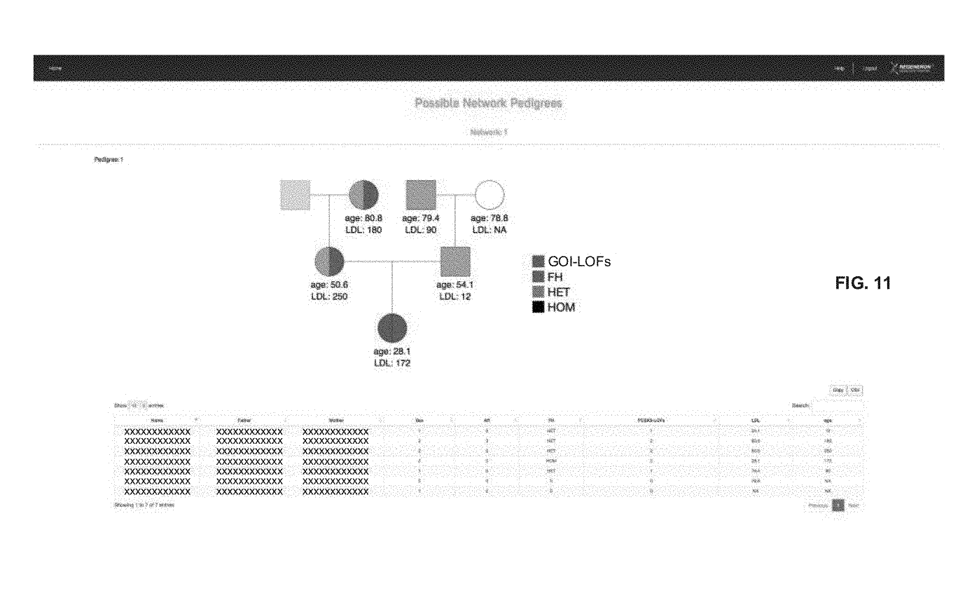

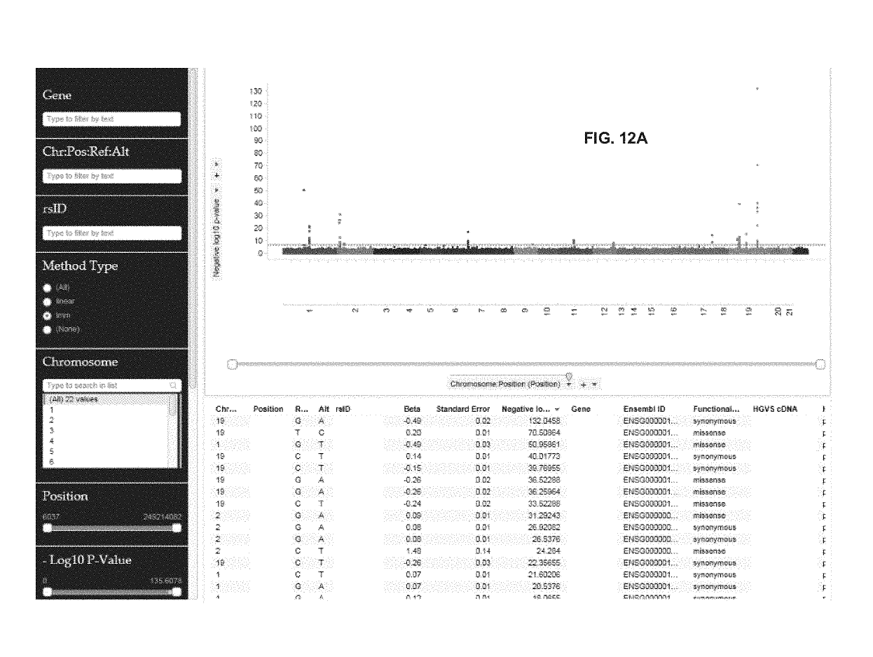

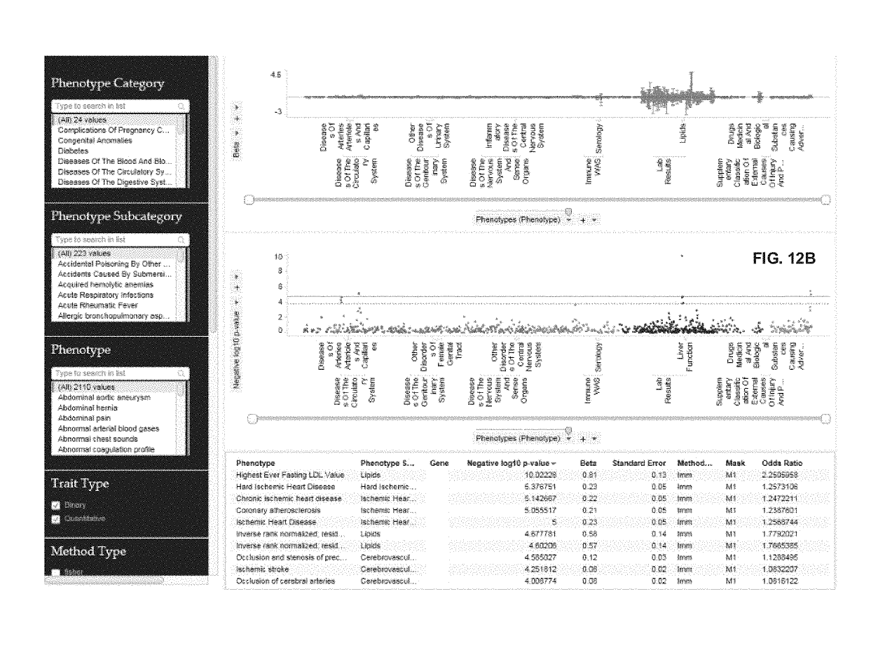

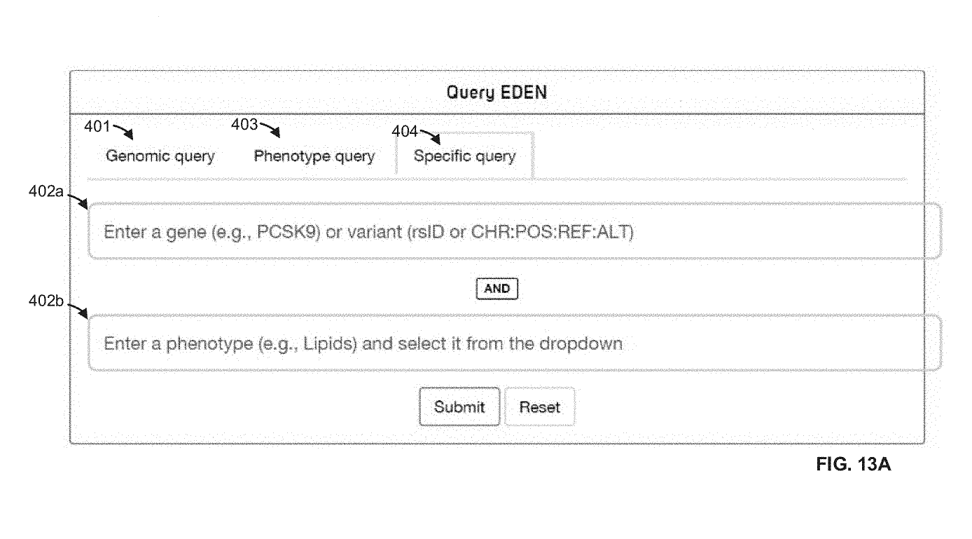

The pedigree interface 306 can be configured to reconstruct pedigrees within a genetic dataset. The pedigree interface 306 can generate Identity By Descent (IBD) estimates used for pedigree reconstruction. The pedigree interface 306 can use the IBD estimates to break the genetic dataset into family networks and then reconstruct each family network separately. The pedigree interface 306 can access data stored in the genetic data component 202. The pedigree interface 306 can comprise one or more of a pedigree data viewer 306a, a query/visualization component 306b, and/or a data exchange interface 306c. The pedigree data viewer 306a can comprise a graphical user interface configured to permit a user to input one or more queries into the query/visualization component 306b. The graphical user interface can also be configured to display one or more data visualizations, such as pedigrees. The one or more data visualizations can be static or can be interactive. The pedigree data viewer 306a can enable the viewing of annotated genetic variant data. FIG. 9, FIG. 10, and FIG. 11 illustrate an example pedigree data viewer 306a.

The query/visualization component 306b can comprise data querying functionality, data visualization functionality, and the like. For example, the query/visualization component 306b can be configured to query genetic variant data stored in one or more VCF files in the genetic data component 202. For example, the query/visualization component 306b can query by gene, by gene sets, and/or by variant. The query/visualization component 306b can analyze query results to determine IBD estimates and assemble one or more pedigrees for display via the pedigree data viewer 306a.

The data exchange interface 306c permits output of other interfaces to be used as input into the pedigree interface 306 and permits output of the pedigree interface 306 to be used as input into other interfaces. In an aspect, one or more other interfaces can be launched from the pedigree interface 306 and one or more query results of the pedigree interface 306 passed to the one or more other interfaces as input. For example, the pedigree interface 306 can receive a gene or genetic variant of interest from a genetic variant data interface 304. The pedigree interface 306 can apply a query based on the received gene or genetic variant of interest and construct a pedigree based on the query results. The data exchange interface 306c can also provide query results as input to the phenotype data interface 302 to determine which patients contained in the query results are in a pedigree.

The pedigree interface 306 can be configured to visualize one or more pedigrees relevant to a set of genetic sample identifiers, identify and export genetic data sample information for subjects related to a given genetic data sample, identify variants enriched in a set of related samples (relative to the expectation based on a larger data set), look up estimates of identity-by-descent for subject samples closely related to a given sample, and identify sets of related samples for export, for example, to a spreadsheet (such as an Excel spreadsheet), a PDF document or to phenotype data interface 302.

The results interface 308 can access data stored in the data analysis component 208 and the phenotypic data analysis component 208. The results interface 308 enables viewing and interaction with computed results from one or more association studies stored in data analysis component 208. The results interface 308 permits a user to select (navigate to) a dataset and interact with visual representations of the dataset. The results interface 308 permits filtering of datasets based on a comprehensive set of analytical outputs. Findings generated via the results interface 308 can be stored, exported (for example, in PDF or Excel format) and shared for further interpretation.

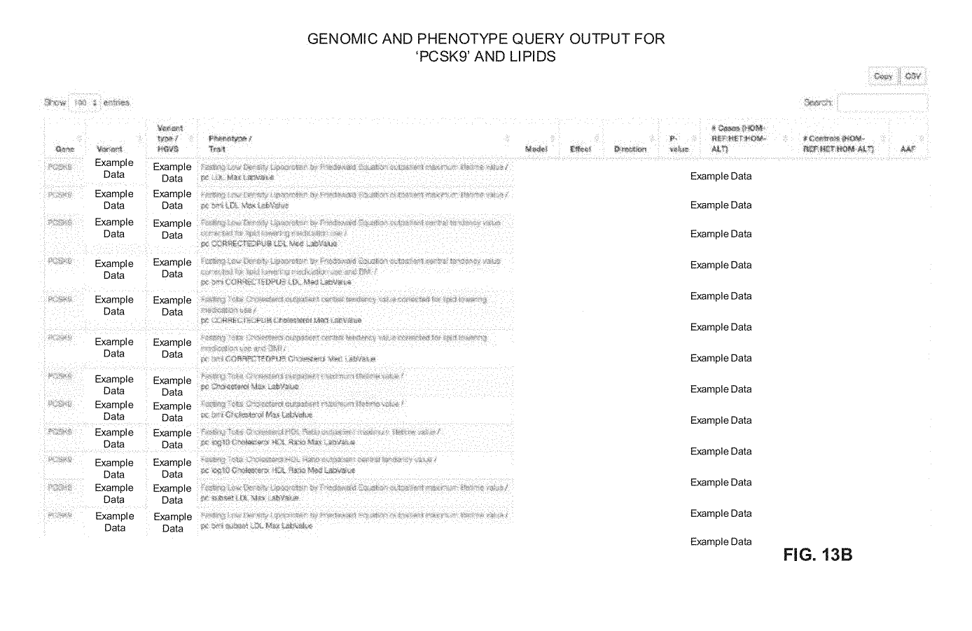

In an aspect, the results interface 308 can comprise one or more of a results viewer 308a, a query/visualization component 308b, and/or a data exchange interface 308c. The results viewer 308a can comprise a graphical user interface configured to permit a user to input one or more queries into the query/visualization component 308b. The graphical user interface can also be configured to display one or more data visualizations. The one or more data visualizations can be static or can be interactive. The results viewer 308a can enable the viewing of annotated genetic variant data. FIG. 12A and FIG. 12B illustrate an example results viewer 308a. FIG. 13A illustrates an example graphical user interface for querying and/or displaying results from both the phenotype data interface 302 and the genetic data interface 304 by selection of the user interface element 404. A specific gene or a specific variant can be entered as a query into the query entry element 402a and a specific phenotype can be entered into the query element 402b. The query entry elements 402a and 402b can further comprise a drop down list of genes and/or variants (402a) and phenotypes (402b). In a further aspect, a graphical depiction of phenotypes (e.g., graphical depiction of phenotypes 405 described in FIG. 4B and FIG. 4C) can be used. An example query result is illustrated in FIG. 13B for a gene query of “PCSK9” and a phenotype query of “Lipids”. The query result indicates all genes associated with both PCSK9 and Lipids. The query result can include various data associated with the genes (e.g., gene, chromosome number, genomic position, a reference, alternative alleles, variant, variant name, predicted type of variant, amino acid change, specific phenotype, and the like).

The query/visualization component 308b can comprise data querying functionality, data visualization functionality, and the like. For example, the query/visualization component 308b can be configured to query genetic variant data stored in one or more VCF files in the genetic data component 202 and/or a matrix file in the data analysis component 208. For example, the query/visualization component 308b can query by gene, by gene sets, by variant, and/or by phenotype.

In one embodiment, the results interface 308 can display results from a GWAS statistical analysis. In one embodiment, the results are visualized in what is referred to herein as “GWAS view.” In the case of a gene query or a genetic variant query, the query/visualization component 308b can retrieve variants that overlap with a gene of interest and display the results in a dynamic plot. A Manhattan Plot depicts the significance of the association between a gene or a genetic variant and a phenotype. The Y-axis shows the −log₁₀ transformed p-values, which represent the strength of association. The X-axis shows genes or variants along chromosomes, and can include chromosome number, chromosome position or genome position. The Manhattan plot can include a horizontal line at the appropriate level of genome-wide significance, for example, after a Bonferroni correction calculation that takes into account all of the tests performed in analysis. The height of the data points in the plot relate directly to significance: the higher the data point on the scale, the more significant is the association of a gene or a genetic variant with a phenotype.

In another embodiment, the results interface 308 can display results from a PheWAS statistical analysis. In one embodiment, the results are visualized in what is referred to herein as a “PheWas view.” In PheWas view, the user can visualize the phenotype(s) association with a gene or a genetic variant of interest. In one embodiment, the query/visualization component 308b can display the results in a dynamic plot. In another embodiment, the results can be displayed and visualized in a plot that is referred to herein as a “PHEHATTAN style plot.” In another embodiment, the PHEHATTAN style plot is a dynamic plot. A PHEHATTAN style Plot depicts the significance of the association between a gene or a genetic variant and a one or more phenotypes. The Y-axis shows the −log₁₀ transformed p-values, which represent the strength of association. The X-axis shows phenotype(s). The PHEHATTAN style plot can include a horizontal line at the appropriate level of genome-wide significance, for example, after a Bonferroni correction calculation that takes into account all of the tests performed in analysis. The height of the data points in the plot relate directly to significance: the higher the data point on the scale, the more significant is the association of a gene or a genetic variant with a phenotype.

The query/visualization component 308b can generate and display one or more visualizations of query results. The one or more visualizations enable users to view graphical representations of query results. Data visualization formats include by way of example, bar charts, tree charts, pie charts, line graphs, bubble graphs, geographic maps, and any other format in which data can be graphically represented.

In another embodiment, the results interface 308 can display results from a PheWAS statistical analysis. Using the query/visualization component 308b, the user can navigate through phenotype categories, and the Manhattan plot will dynamically display what genetic variant-phenotype results were obtained for that phenotype, what statistical test(s) was(were) used, and the genetic variant(s) associated with the phenotype.

The query/visualization component 308b can be used to isolate a genetic variant-phenotype association result (for example, by hovering over a result data point), and to display information relevant to the result.

Using the query/visualization component 308b, the user can filter the genetic variant-phenotype association results by any parameter of interest. Non-limiting examples of parameters of interest by which the user can filter results include genetic variant, gene, a subset of the subject cohort from whom the genetic data in genetic data component 202 were obtained, type of phenotype category (binary or quantitative), phenotype category, chromosome, degree of significance (by p-value), and effect size (for example, odds ratio).

The query/visualization component 308b can display various fields of information that relate to a genetic variant-phenotype association result. Non-limiting examples of information that can be visualized and investigated further using results interface 308 include variant name, chromosome, genome position, reference allele, alternate allele, RSID, an indicator to flag analysis with poor test calibration, and indicator to flag with low case counts, an indicator to flag tests with low minor allele count, an indicator to flag variants out of Hardy Weinberg Equilibrium (HWE), Beta, standard error, an odds ratio, the confidence interval of an odds ratio, −log₁₀ p-value, standard error, standard error of Beta, gene name, Ensembl ID, functional annotation, HGVS cDNA change, HGVS amino acid change, gene expression product location (for example, secreted, transmembrane, nuclear, etc.), if the variant is a loss of function variant, if the variant is an insertion or a deletion, the alternate allele frequency in the dataset, the number of heterozygotes, the number of subjects with at least one alternate allele, the number of alternate allele homozygotes, the HWE p-value and the source data file name.

The query/visualization component 308b can also be used to dynamically generate quality information, for example, a Q-Q plot, for the result. The query/visualization component 308b can also be used to filter results by the type of statistical test that was used to generate the result. The query/visualization component 308b can also be used to filter to a chromosome of interest or to a chromosome or genome position of interest.

By accessing computed results contained in the data analysis component 208 the query/visualization component 308b can determine what results have been obtained for a given variant and what results have been obtained for a given phenotype. The results interface 308 thus affords novel data representation and by enabling a user to search/browse computed results of the genetic variant-phenotype association data component 206 stored in data analysis component 208.

The results interface 308 can permit a user to mark or otherwise indicate association result hits, filter hits (e.g., based on gene, mask, phenotype, chromosome, position, and the like), and permit the user to bookmark a prior visualization for later access and sharing with other users. The results interface 308 can permit export of data in any file format, such as text files, spreadsheets, PowerPoint, portable document format, and the like.

A user can interact with the visualizations generated by the query/visualization component 308b to further “drill down” into the data. For example, a user can click on a query result to retrieve phenotypes (binary, quantitative, etc.) associated with a variant, gene, etc. A user can navigate back and forth between variant and phenotype data.

The results interface 308 can be configured to manipulate and display data in any amount, affording for high data scalability. The results interface 308 provides a conformed, single version of the truth regarding the underlying data. The results interface 308 enables a user to validate data that may not seem to fit. As the results interface 308 operates on computed results, the need for R-scripts and flat files is avoided. The results interface 308 enables users to save time (minutes, instead of hours, required to visualize results) and facilitates analysis by data scientists—networks, clustering, classification, etc.

The data exchange interface 308c permits output of other interfaces to be used as input into the results interface 308 and permits output of the results interface 308 to be used as input into other interfaces. In an aspect, one or more other interfaces can be launched from the results interface 308 and one or more query results of results interface 308 passed to the one or more other interfaces as input. For example, the results interface 308 can receive a gene of interest from a genetic variant data interface 304. The results interface 308 can apply a query based on the received gene of interest. The data exchange interface 308c can also provide query results as input to the phenotype data interface 302 to determine medical information of the patients contained in the query results.

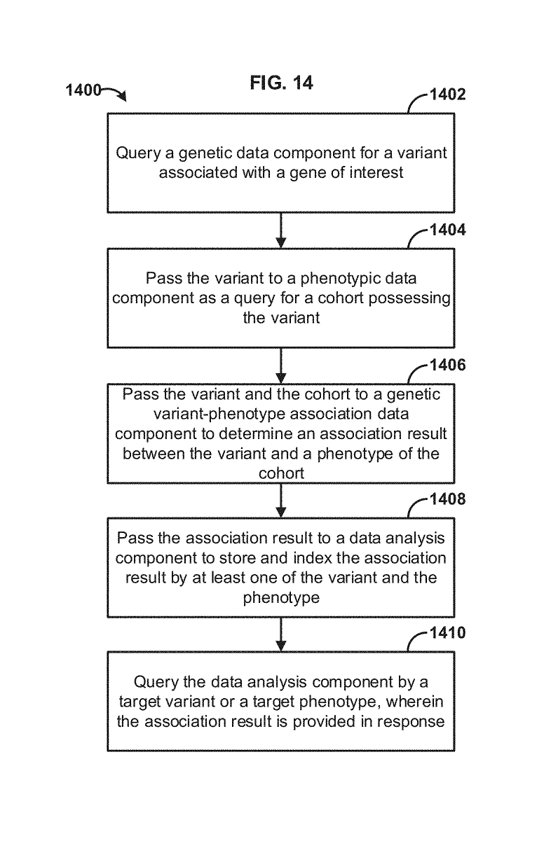

In an aspect, illustrated in FIG. 14, provided is a method 1400 comprising querying a genetic data component for a variant associated with a gene of interest at 1402. The genetic data component can comprise the genetic data component 202 and/or the genetic variant data interface 304.

The method 1400 can comprise passing the variant to a phenotypic data component as a query for a cohort possessing the variant at 1404. The phenotypic data component can be configured to apply the query to phenotype data stored in an acyclic graph. The phenotype data stored in the acyclic graph can comprise one or more relationships based on Unified Medical Language System (UMLS) hierarchies. The phenotypic data component can comprise the phenotypic data component 204 and/or the phenotypic data interface 302.

The method 1400 can comprise passing the variant and the cohort to a genetic variant-phenotype association data component to determine an association result between the variant and a phenotype of the cohort at 1406. The genetic variant-phenotype association data component can comprise the genetic variant-phenotype association data component 206.

The method 1400 can comprise passing the association result to a data analysis component to store and index the association result by at least one of the variant and the phenotype at 1408. The data analysis component can comprise the data analysis component 208 and/or the results interface 308. The method 1400 can comprise querying the data analysis component by a target variant or a target phenotype, wherein the association result is provided in response at 1410.

The method 1400 can further comprise generating, by the data analysis component, one or more of a Manhattan Plot and a PHEHATTAN Plot. The method 1400 can further comprise generating, by the data analysis component, quality information for the association result. The quality information can comprise a Q-Q plot. The method 1400 can further comprise generating, by the data analysis component, one or more visualizations. The one or more visualizations can be static or interactive. The method 1400 can comprise providing an interface to a user to indicate one or more of a hit in the association result and a filter hit (e.g., based on gene, mask, phenotype, chromosome, position, and the like). The interface can further permit the user to bookmark a prior visualization for later access and sharing with other users.

The method 1400 can further comprise receiving a plurality of association results and filtering the plurality of association results by one or more of a genetic variant, a gene, a subset of the cohort, a type of phenotype category (binary or quantitative), a phenotype category, a chromosome, a degree of significance (by p-value), and an effect size (for example, odds ratio).

The method 1400 can further comprise providing the association result to a pedigree interface. The pedigree interface can construct a pedigree indicating one or more relationships between one or more subjects in the cohort.

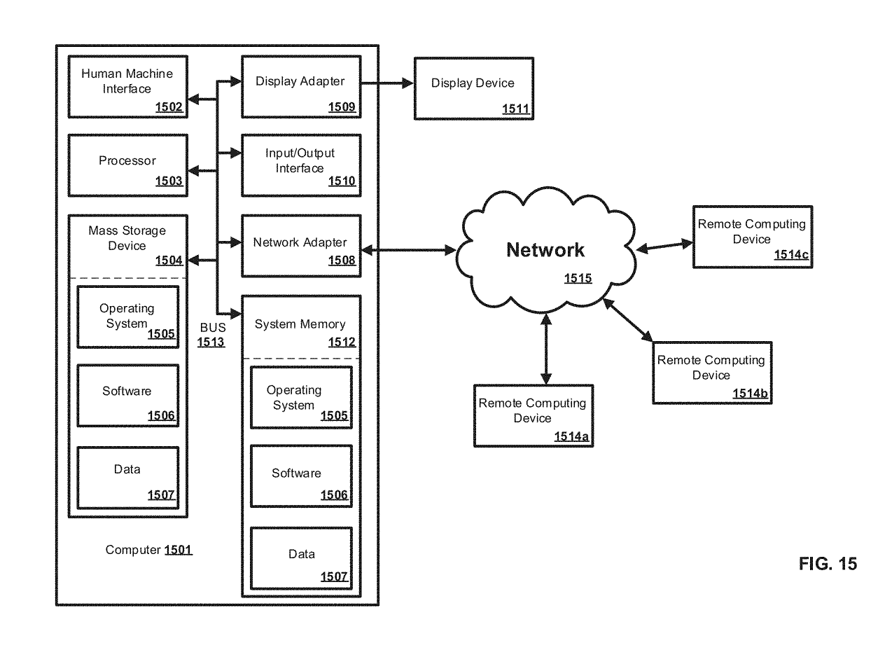

In an exemplary aspect, the methods and systems can be implemented on a computer 1501 as illustrated in FIG. 15 and described below. Similarly, the methods and systems disclosed can utilize one or more computers to perform one or more functions in one or more locations. FIG. 15 is a block diagram illustrating an exemplary operating environment for performing the disclosed methods. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems can be operational with numerous other general purpose or special purpose computing system environments or configurations. Examples of computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

The processing of the disclosed methods and systems can be performed by a cluster computing framework, such as APACHE SPARK. In an aspect, the cluster computing framework can provide an application programming interface centered on a resilient distributed data set (RDD). The RDD can comprise a read-only multiset of data items distributed across a cluster of computers or other processing devices. In an aspect, the cluster is implemented with one or more fault tolerances. In an aspect, the cluster computing framework can include a cluster manager, managing the performance of each device in the cluster, and a distributed storage system.

In an aspect, the cluster computing framework an implement an application programming interface (API) centered on RDD abstraction. In an aspect, the API can provide distributed task dispatching, scheduling, and/or input/output (I/O) functionalities. In an aspect, the API can mirror a functional/higher-order model of programming. For example, a program can invoke parallel operations such as mapping, filtering, or reduction on an RDD by passing a function to a scheduler, which then schedules the function's execution in parallel in the cluster. In an aspect, such operations can accept an RDD as input and produce a new RDD as output. In an aspect, fault-tolerance can be achieved by keeping track of a sequence of operations to produce each RDD, thereby allowing the reconstruction of an RDD in the event of a data loss.

In an aspect, the cluster computing framework can implement a data abstraction that provides support for structured and semi-structured data, also referred to as “DataFrames.” In an aspect, the cluster computing framework can implement a domain specific-language to manipulate DataFrames encoded in a given programming language or format. In an aspect, this can facilitate Structured Query Language (SQL) queries.

In an aspect, the cluster computing framework can perform streaming analytics to ingest data in batches or portions, and performing RDD transformations on those batches of data. This enables the same set of application code written for batch analytics to be used for streaming analytics, thus facilitating lambda architecture. In another aspect, data can be processed event by event instead of in batches. In an aspect, the cluster computing framework can include a distributed machine learning framework. Streaming enables scalable, high-throughput, fault-tolerant stream processing of live data streams. Data can be ingested from many sources and can be processed using complex algorithms (e.g., algorithms expressed with high-level functions like map, reduce, join and window, among others). Finally, processed data can be pushed out to filesystems, databases, and live dashboards. In an aspect, one or more machine learning and/or graph processing algorithms can be performed on data streams.

In an aspect, cluster computing framework can receive live input data streams and divide the data into batches, which are then processed to generate a final stream of results in batches. Streaming provides a high-level abstraction called discretized stream or DStream, which represents a continuous stream of data. DStreams can be created either from input data streams from sources, or by applying high-level operations on other DStreams. Internally, a DStream can be represented as a sequence of Resilient Distributed Dataset (RDDs). A Resilient Distributed Dataset (RDD) represents an immutable, partitioned collection of elements that can be operated on in parallel.

Further, the systems and methods disclosed herein can be implemented via a general-purpose computing device in the form of a computer 1501. The components of the computer 1501 can comprise, but are not limited to, one or more processors 1503, a system memory 1512, and a system bus 1513 that couples various system components including the one or more processors 1503 to the system memory 1512. The system can utilize parallel computing.

The system bus 1513 represents one or more of several possible types of bus structures, including a memory bus or memory controller, a peripheral bus, an accelerated graphics port, or local bus using any of a variety of bus architectures. The bus 1513, and all buses specified in this description can also be implemented over a wired or wireless network connection and each of the subsystems, including the one or more processors 1503, a mass storage device 1504, an operating system 1505, software 1506, data 1507, a network adapter 1508, the system memory 1512, an Input/Output Interface 1510, a display adapter 1509, a display device 1511, and a human machine interface 1502, can be contained within one or more remote computing devices 1514a,b,c at physically separate locations, connected through buses of this form, in effect implementing a fully distributed system.

The computer 1501 typically comprises a variety of computer readable media. Exemplary readable media can be any available media that is accessible by the computer 1501 and comprises, for example and not meant to be limiting, both volatile and non-volatile media, removable and non-removable media. The system memory 1512 comprises computer readable media in the form of volatile memory, such as random access memory (RAM), and/or non-volatile memory, such as read only memory (ROM). The system memory 1512 typically contains data such as the data 1507 and/or program modules such as the operating system 1505 and the software 1506 that are immediately accessible to and/or are presently operated on by the one or more processors 1503.

In another aspect, the computer 1501 can also comprise other removable/non-removable, volatile/non-volatile computer storage media. By way of example, FIG. 15 illustrates the mass storage device 1504 which can provide non-volatile storage of computer code, computer readable instructions, data structures, program modules, and other data for the computer 1501. For example and not meant to be limiting, the mass storage device 1504 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 1504, including by way of example, the operating system 1505 and the software 1506. Each of the operating system 1505 and the software 1506 (or some combination thereof) can comprise elements of the programming and the software 1506. The data 1507 can also be stored on the mass storage device 1504. The data 1507 can be stored in any of one or more databases. Examples of such databases comprise, DB2®, MICROSOFT® Access, MICROSOFT® SQL Server, ORACLE®, MYSQL®, POSTGRESQL®, and the like. The databases can be centralized or distributed across multiple systems.

In another aspect, the user can enter commands and information into the computer 1501 via an input device (not shown). Examples of such input devices comprise, but are not limited to, a keyboard, pointing device (e.g., a “mouse”), a microphone, a joystick, a scanner, tactile input devices such as gloves, and other body coverings, and the like. These and other input devices can be connected to the one or more processors 1503 via the human machine interface 1502 that is coupled to the system bus 1513, but can be connected by other interface and bus structures, such as a parallel port, game port, an IEEE 1394 Port (also referred to as a Firewire port), a serial port, or a universal serial bus (USB).

In yet another aspect, the display device 1511 can also be connected to the system bus 1513 via an interface, such as the display adapter 1509. It is contemplated that the computer 1501 can have more than one display adapter 1509 and the computer 1501 can have more than one display device 1511. For example, a display device can be a monitor, an LCD (Liquid Crystal Display), or a projector. In addition to the display device 1511, other output peripheral devices can comprise components such as speakers (not shown) and a printer (not shown) which can be connected to the computer 1501 via the Input/Output Interface 1510. Any step and/or result of the methods can be output in any form to an output device. Such output can be any form of visual representation, including, but not limited to, textual, graphical, animation, audio, tactile, and the like. The display 1511 and computer 1501 can be part of one device, or separate devices.

The computer 1501 can operate in a networked environment using logical connections to one or more remote computing devices 1514a,b,c. By way of example, a remote computing device can be a personal computer, portable computer, smartphone, a server, a router, a network computer, a peer device or other common network node, and so on. Logical connections between the computer 1501 and a remote computing device 1514a,b,c can be made via a network 1515, such as a local area network (LAN) and/or a general wide area network (WAN). Such network connections can be through the network adapter 1508. The network adapter 1508 can be implemented in both wired and wireless environments. Such networking environments are conventional and commonplace in dwellings, offices, enterprise-wide computer networks, intranets, and the Internet. In an aspect, the system memory 1512 can store one or more objects made accessible to the one or more remote computing devices 1514a,b,c via the network 1515. Thus, the computer 1501 can serve as cloud-based object storage. In another aspect, one or more of the one or more remote computing devices 1514a,b,c can store one or more objects made accessible to the computer 1501 and/or the other of the one or more remote computing devices 1514a,b,c. Thus, the one or more remote computing devices 1514a,b,c can also serve as cloud-based object storage.

For purposes of illustration, application programs and other executable program components such as the operating system 1505 are illustrated herein as discrete blocks, although it is recognized that such programs and components reside at various times in different storage components of the computing device 1501, and are executed by the one or more processors 1503 of the computer. In an aspect, at least a portion of the software 1506 and/or the data 1507 can be stored on and/or executed on one or more of the computing device 1501, the remote computing devices 1514a,b,c, and/or combinations thereof. Thus the software 1506 and/or the data 1507 can be operational within a cloud computing environment whereby access to the software 1506 and/or the data 1507 can be performed over the network 1515 (e.g., the Internet). Moreover, in an aspect the data 1507 can be synchronized across one or more of the computing device 1501, the remote computing devices 1514a,b,c, and/or combinations thereof.

An implementation of the software 1506 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The present methods and systems also provides a method of determining the association of one or more genes or one or more genetic variants with one or more phenotypes, the method comprising accessing data from the genetic data component 202, accessing data from the phenotypic data component 204, and performing a statistical analysis of the association of the one or more genes or one or more genetic variants with the one or more phenotypes in the genetic variant-phenotype association data component 206. In one embodiment the one or more phenotypes is one or more binary phenotypes. In another embodiment, the one or more phenotypes is one or more quantitative phenotypes. Non-limiting examples of the statistical analysis include Fisher's exact test, a linear mixed model, a Bolt-linear mixed model, logistic regression, Firth regression, a general regression model and linear regression.

The present methods and systems also provide a method of visualizing genetic variant-phenotype association results, the method comprising accessing data from the genetic data component 202, accessing data from the phenotypic data component 204, and performing a statistical analysis of the association of the one or more genes or one or more genetic variants with the one or more phenotypes in the genetic variant-phenotype association data component 206, and visualizing one or more genetic variant-phenotype association results in results interface 308. In one embodiment, the results are visualized in GWAS view. In another embodiment, the results are visualized in GWAS view as a Manhattan plot. In another embodiment, the Manhattan plot is a dynamic plot. In another embodiment, the results are visualized in PheWas view. In another embodiment, the results are visualized in PheWAS view as a PHEHATTAN style plot. In another embodiment, the PHEHATTAN style plot is a dynamic plot.

The present methods and systems also provide a method of visualizing genetic data, the method comprising accessing data from genetic data component 202, and visualizing genetic data in genetic variant data interface 304.

The present methods and systems also provide a method of visualizing phenotypic data, the method comprising accessing data from phenotypic data component 204, and visualizing genetic data in phenotype data interface 302.

The present methods and systems also provide a method of visualizing pedigrees, the method comprising accessing data from genetic data component 202, and visualizing one or more pedigrees in pedigree interface 306.

In the present methods and systems the computational component 222 and any other component/interface can employ supervised and unsupervised Artificial Intelligence techniques, such as machine learning and iterative learning. Examples of such techniques include, but are not limited to, expert systems, case based reasoning, Bayesian networks, clustering analysis, information retrieval, document retrieval, network analysis, association rules analysis, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

The present system and methods facilitate the study of the biological pathway(s) that are relevant to a phenotype identified as being associated with a genetic variant. The biological pathway can be studied in detail, for example, in support of drug development, to identify a putative biological target for pharmacologic intervention. Such study can include biochemical, molecular biological, physiological, pharmacological and computational study.

In one embodiment, the putative biological target is the polypeptide encoded by the gene that contains the variant identified in the genetic variant-phenotype association. In another embodiment, the putative biological target is a molecule (for example, a receptor, cofactor or a polypeptide component of a larger polypeptide complex) that binds to the polypeptide encoded by the gene that contains the variant identified in the genetic variant-phenotype association.

In another embodiment, the putative biological target is the gene that contains the variant identified in the genetic variant-phenotype association.

The present methods and systems also facilitate the identification of a therapeutic molecule that binds to a putative biological target discussed immediately above. Non-limiting examples of a suitable therapeutic molecule include peptides and polypeptides that bind specifically to a putative biological target, for example an antibody or a fragment thereof, and small chemical molecules. For example, a candidate therapeutic molecule can be tested for binding to a putative biological target in a suitable screening assay.

The present methods and systems also facilitate the identification of therapeutic methods for influencing the expression of a gene that contains the variant identified in the genetic variant-phenotype association. Non-limiting examples of suitable therapeutic methods include genome editing, gene therapy, RNA silencing, and siRNA.

The present methods and systems also facilitate the identification of diagnostic methods and tools that leverage the identification of a genetic variant-phenotype association.

The present methods and systems also facilitate the construction of genetic constructs (for example an expression vector) and cell lines that leverage the identification of a genetic variant-phenotype association.

The present methods and systems also facilitate the construction of knockout and transgenic rodents, for example, mice. Genetically modified non-human animals and embryonic stem (ES) cells can be generated using any appropriate method. For example, such genetically modified non-human animal ES cells can be generated using VELOCIGENE® technology, which is described in U.S. Pat. Nos. 6,586,251, 6,596,541, 7,105,348, and Valenzuela et al., Nat Biotech 2003; 21: 652, each of which is hereby incorporated by reference.

### Example 1

Functional Variants Study

Sequenced and Phenotyped Population

Described herein are the initial insights gained from whole exome sequencing of 50,726 adult MyCode participants with electronic health record (HER)-derived clinical phenotypes in the DiscovEHR cohort. Described herein is the spectrum of protein coding variation by functional class identified in these participants, and the unique familial substructure resulting from ascertainment in a stable regional US healthcare population. Loss-of-function and other functional genetic variation in these participants is surveyed, examples linking these data to EHR-derived clinical phenotypes for the purposes of genomic discovery are provided. Finally, clinically actionable genetic variants in these individuals are reported on, and plans to return and act clinically on this information are outlined.

The MyCode Community Health Initiative enrolls participants who are patients of the Geisinger Health System (GHS) (Carey et al., Genes in Medicine, in press 2016). GHS is a fully integrated health system that provides primary and specialty medical care in more than 70 outpatient and inpatient care sites primarily in north central and northeastern Pennsylvania. GHS was an early adopter of EHR systems, which provides a comprehensive, longitudinal source of clinical data on its patients. MYCODE® participants consent to provide blood and DNA samples for a system-wide biorepository for broad research purposes, including genomic analysis, and linking to data in the GHS EHR. All active GHS patients are eligible to participate, and consent rates are high (>85% of individuals invited to participate). The cohort of consented patients is large enough (>90,000 consented participants) to provide a representative sample of the GHS patient population. MyCode participants agree to be re-contacted for additional phenotyping and return of clinically actionable results.

Large-scale exome sequencing and whole genome genotyping methods were applied to individuals enrolled in the MyCode Community Health Initiative (Geisinger Health System), an EHR-linked biobank from patients who consented to broad research use, recontact, and return of clinically actionable results. The ability to combine genomic data with longitudinal EHR data in a large, stable patient population creates a powerful platform for broad genome-phenome analyses of a vast array of phenotypes captured through clinical care. EHR-linked cohorts from integrated health systems allow broad genome-phenome analyses due to the vast array of phenotypes captured through clinical care. Embedding such an effort into an integrated health system also affords a unique opportunity to develop processes to use genomic information to inform individual and population health.

The DiscovEHR cohort reported on herein consists of more than 50,000 MyCode participants that have undergone whole exome sequence analysis. This includes 6,672 individuals recruited from the cardiac catheterization laboratory and 2,785 individuals recruited from the bariatric surgery clinic, with the remaining ˜41,000 individuals representing otherwise unselected GHS patients who are MyCode participants.

These DiscovEHR participants have clinical phenotypes recorded in the GHS EHR over a median of 14 years, with a median of 87 clinical encounters, 687 laboratory tests and 7 procedures captured per participant (Table 2). Demographics and patient counts for a selection of diseases in cardiometabolic, respiratory, neurocognitive, and oncology domains are described in Table 2.

TABLE 2
Demographics and Clinical Characteristics of Adult (>18 yo)
DiscovEHR Study Population

| | GHS | | DiscovEHR | |
|---|---|---|---|---|
| Basic Demographics | Active Patients | | Sequenced Patients | |
| N | 1,173,589 | | 50,726 | |
| Female, N (%) | 622022 | (53) | 29,928 | (59) |
| Median Age, yr | 48 | (30-66) | 61 | (48-74) |
| Median BMI, kg/m² | 27 | (22-32) | 30 | (28-33) |
| Median Years of EHR Data | 5 | (0-10) | 14 | (11-17) |
| Median Medication Orders | 16 | (0-42) | 129 | (37-221) |
| per Patient | | | | |
| Median Lab Results per | 115 | (0-274) | 658 | (197-1,119) |
| Patient | | | | |

Cardiometabolic Phenotypes

| | | | | |
|---|---|---|---|---|
| Coronary Artery Disease, | 61,389 | (5) | 12,298 | (24) |
| N (%) | | | | |
| Type 2 Diabetes, N (%) | 81,363 | (7) | 11,474 | (23) |
| Heart Failure, N (%) | 39,168 | (3) | 5,596 | (11) |
| Bariatric Surgery, N (%) | 6,115 | (0.5) | 3,112 | (6) |

Respiratory and Immunological Phenotypes

| | | | | |
|---|---|---|---|---|
| COPD, N (%) | 52,932 | (5) | 6,181 | (12) |
| Atopic Asthma, N (%) | 74,638 | (6) | 7,363 | (15) |
| Rheumatoid Arthritis, N (%) | 10,505 | (1) | 1,586 | (3) |
| Ulcerative Colitis, N (%) | 4,550 | (0.4) | 553 | (1) |

Neurodegenerative Phenotypes (0.5)

| | | | | |
|---|---|---|---|---|
| Alzheimers Disease, N (%) | 6,323 | (0.5) | 233 | (0.5) |
| Parkinsons Disease, N (%) | 6,217 | (0.5) | 555 | (1) |
| Multiple Sclerosis, N (%) | 4,164 | (0.4) | 487 | (1) |
| Myasthenia Gravis, N (%) | 698 | (0.06) | 90 | (0.2) |

Oncology Phenotypes

| | | | | |
|---|---|---|---|---|
| Breast Cancer, N (%) | 14,894 | (1) | 1,362 | (3) |
| Prostate Cancer, N (%) | 10,964 | (1) | 1,349 | (3) |
| Lung Cancer, N (%) | 7,073 | (0.6) | 550 | (1) |
| Colorectal Cancer, N (%) | 7,047 | (0.6) | 616 | (1) |

Unless otherwise noted, values are expressed as median (interquartile range).
Abbreviations:
EHR, electronic health records;
GHS, Geisinger Health System.
Diseases defined by International Classification of Disease, Ninth Edition (ICD-9) Diagnosis Codes.

An integrated health system also provides an ideal platform to develop and test ways to use genomic data in clinical care. The informed consent process used to enroll participants into MyCode allows banking of biological samples for broad research use, linking of samples to participant's EHR data, re-contact, and return of clinically actionable research findings. Data are presented herein on a subset of clinically actionable genomic variants in this large clinical population, and describe a framework for delivering this information to patients and providers to advance individual health.

Sample Preparation and Sequencing

In brief, sample quantity was determined by fluorescence (Life Technologies) and quality assessed by running 100 ng of sample on a 2% pre-cast agarose gel (Life Technologies). The DNA samples were normalized and one aliquot was sent for genotyping (Illumina, Human OmniExpress Exome Beadchip) and another sheared to an average fragment length of 150 base pairs using focused acoustic energy (Covaris LE220). The sheared genomic DNA was prepared for exome capture with a custom reagent kit from Kapa Biosystems using a fully-automated approach developed at the Regeneron Genetics Center. A unique 6 base pair barcode was added to each DNA fragment during library preparation to facilitate multiplexed exome capture and sequencing. Equal amounts of sample were pooled prior to exome capture with NimbleGen probes (SeqCap VCRome). Captured fragments were bound to streptavidin-conjugated beads and non-specific DNA fragments removed by a series of stringent washes according to the manufacturer's recommended protocol (Roche NimbleGen). The captured DNA was PCR amplified and quantified by qRT-PCR (Kapa Biosystems). The multiplexed samples were sequenced using 75 bp paired-end sequencing on an Illumina v4 HiSeq 2500 to a coverage depth sufficient to provide greater than 20× haploid read depth of over 85% of targeted bases in 96% of samples (approximately 80× mean haploid read depth of targeted bases).

Sequence Alignment, Variant Identification, and Genotype Assignment

Upon completion of sequencing, raw sequence data from each Illumina Hiseq 2500 run was gathered in local buffer storage and uploaded to the DNAnexus platform (Reid J G, et al., BMC Bioinformatics, 2014; 15: 30) for automated analysis. After upload was complete, analysis began with the conversion of BCL files to FASTQ-formatted reads and assigned, via specific barcodes, to samples using the CASAVA software package (Illumina Inc., San Diego, Calif.). Sample-specific FASTQ files, representing all the reads generated for that sample, were then aligned to the GRCh37.p13 genome reference with BWA-mem (Li H and R Durbin, Bioinformatics, 2009; 25: 1754).

The resultant binary alignment file (BAM) for each sample contained the mapped reads' genomic coordinates, quality information, and the degree to which a particular read differed from the reference at its mapped location. Aligned reads in the BAM file were then evaluated to identify and flag duplicate reads with the Picard MarkDuplicates tool, producing an alignment file (duplicatesMarked.BAM) with all potential duplicate reads marked for exclusion in later analyses.

Variant calls were produced using the Genome Analysis Toolkit (GATK) (McKenna A, et al., Genome Res 2010; 20: 1297). GATK was used to conduct local realignment of the aligned, duplicate-marked reads of each sample around putative indels. GATK's HaplotypeCaller was then used to process the INDEL-realigned, duplicate-marked reads to identify all exonic positions at which a sample varied from the genome reference in the genomic VCF format (GVCF). Genotyping was accomplished using GATK's GenotypeGVCFs on each sample and a training set of 50 randomly selected samples, previously run at the Regeneron Genetics Center (RGC), outputting a single-sample VCF file identifying both SNVs and indels as compared to the reference. Additionally, each VCF file carried the zygosity of each variant, read counts of both reference & alternate alleles, genotype quality representing the confidence of the genotype call, the overall quality of the variant call at that position, and the QualityByDepth for every variant site.

Variant Quality Score Recalibration (VQSR), from GATK, was employed to evaluate the overall quality score of a sample's variants using training datasets (e.g., 1000 Genomes) to assess and recalculate each variant's score, increasing specificity. Metric statistics were captured for each sample to evaluate capture, alignment, and variant calling using Picard, bcftools, and FastQC.

Following completion of cohort sequencing, samples showing disagreement between genetically-determined and reported sex (n=143); low quality DNA sequence data indicated by high rates of heterozygosity or low sequence data coverage (less than 75% of targeted bases achieving 20× coverage) (n=181); or genetically-identified sample duplicates (n=222) were excluded (n=494 unique samples excluded). Following these exclusions, 51,298 exome sequences were available for downstream analysis, and findings from exome sequences corresponding to 50,726 individuals who were 18 years of age or older at the time of initial consent are reported herein. These samples were used to compile a project-level VCF (PVCF) for downstream analysis. The PVCF was created in a multi-step process utilizing GATK's GenotypeGVCFs to jointly call genotypes across blocks of 200 samples, recalibrated with VQSR and aggregated into a single, cohort-wide PVCF using GATK's CombineVCFs. Care was taken to carry all homozygous reference, heterozygous, homozygous alternate, and no-call genotypes into the project-level VCF. For the purposes of downstream analyses, samples with QD<5.0 and DP<10 from the single sample pipeline had genotype information converted to ‘No-Call’, and variants falling more than 20 bp outside of the target region were excluded.

Sequence Annotation and Identification of Functional Variants

Sequence variants were annotated with snpEff (Cingolani P, et al., Fly (Austin) 2012; 6: p. 80-92.) using the Ensembl75 gene definitions to determine their functional impact on transcripts and genes. In order to reduce the number of false-positive pLoF calls related to inaccurate transcript definitions, a “whiteList” set of 56,507 protein-coding transcripts that have an annotated start and stop codon (corresponding to 19,729 genes) were selected as a reference for functional annotations. These transcripts were also flagged to allow for downstream filtering for the following features: a) small introns (<15 bp), b) small exons (<15 bp), c) non-canonical splice sites (non-“GT/AG” splice sites).

The snpEff predictions that correspond to the “whiteList” filtered transcripts are then collapsed into a single most-deleterious functional impact prediction (i.e., the Regeneron Effect Prediction) by selecting the most deleterious functional effect class for each gene according to the hierarchy in Table 1. Predicted loss of function mutations were defined as SNVs resulting in a premature stop codon, loss of a start or stop codon, or disruption of canonical splice dinucleotides; open-reading-frame shifting indels, or indels disrupting a start or stop codon, or indels disrupting of canonical splice dinucleotides (Table 1). Predicted loss of function variants that correspond to the ancestral allele or that occur in the last 5% of all affected transcripts were excluded.

Principal Components and Ancestry Estimation

Principal component (PC) analysis was performed in PLINK2 (Chang C C et al., Gigascience 2015; 4: 7) using the subset of overlapping variant sites (n=6,331) from GHS whole exome sequence and the 1000 genomes Omni chip platform. This analysis was further restricted to common (MAF>5%) autosomal variant sites with high genotyping rate (>90%) in both Hardy-Weinberg (p>1×10⁻⁸) and linkage equilibrium which did not map to the MHC region (n sites after filters=3,974). Initial calculations were based on 1000 genomes samples and GHS individuals were projected onto these PC's.

To identify a subset of European individuals within GHS, a linear model trained on PCs estimates from 1000 genomes of known ancestry groups (EUR, ASN, AFR) using the first three PCs was constructed. Thresholds for each model (EUR=0.9, AFR=0.7, ASN=0.8) were applied to determine the best continental ancestry match for each GHS individual; samples not meeting any of these thresholds were designated as “Admixed”. Within the GHS European population, a new set of PCs was calculated for the maximum unrelated set (MUS) of individuals using similar variant filtering criteria. Related individuals within GHS were subsequently projected onto these PCs. These European-only PCs calculated from unrelated GHS individuals were used in phenotype association analyses.

Distribution of Protein Coding Variation Discovered by Sequencing 50,726 Exomes

The protein coding regions of 18,852 genes in 50,726 DiscovEHR participants were sequenced. Sequence coverage was sufficient to provide at least 20× haploid read depth at an average of >85% of targeted bases in 96% of samples. Genome-wide array genotyping was also performed using the OmniExpress Exome Platform. A median of 21,409 single nucleotide variants (SNVs) and 1,031 indel variants per person were identified in protein coding regions of the genome; a median of 887 of these variants in each individual were novel.

The median transition to transversion ratio was 3.04 and the median heterozygous to homozygous ratio was 1.51. Among all study participants, a total of 4,028,206 unique SNVs and 224,100 unique indels were identified (Table 3), of which 98% occurred at an alternative allele frequency of less than 1%, a frequency below which considered variants were considered to be rare. Among this set of rare variants, 2,002,912 were predicted to be nonsynonymous variants. 176,365 variants were found that were predicted to result in loss of gene function (pLoF) on the basis of a predicted effect on one or more transcripts of the following types: SNVs leading to a premature stop codon, loss of a start codon, or loss of a stop codon; SNVs or indels disrupting canonical splice acceptor or donor dinucleotides; open reading frame shifting indels leading to the formation of a premature stop codon. Of these pLoFs, 114,340 (65% of all pLoFs) are predicted to cause loss of function of all transcripts cataloged in RefSeq.

TABLE 3
Sequence Variants Identified Using Whole Exome Sequencing of 50,726
DiscovEHR Participants

| Variant type | All variants | Allele frequency ≦1% |
|---|---|---|
| Single nucleotide variants | 4,028,206 | 3,947,488 |
| Insertion/deletion variants | 224,100 | 218,785 |
| Predicted loss of function | 176,365 | 175,393 |
| variants | | |
| Nonsynonymous variants | 2,025,800 | 2,002,912 |
| Total | 4,252,306 | 4,166,273 |

A median of 21 rare pLoFs and several hundred more common pLoFs (Table 4) were identified per individual; an average of 43% of these pLoF variants were frameshift indels, and the remainder were SNVs.

TABLE 4
Median Number of Predicted Loss of Function Variants per Individual in
50,726 DiscovEHR Participants

| | Allele frequency ≦1%, | Allele frequency >1%, |
|---|---|---|
| Variant type | median (IQR) | median (IQR) |
| Splice donor | 2 (1-3) | 14 (13-16) |
| Splice acceptor | 2 (1-3) | 43 (40-45) |
| Stop gain | 6 (5-8) | 49 (45-52) |
| Frame shift | 9 (7-11) | 153 (146-160) |
| Stop loss | 0 (0-1) | 10 (9-11) |
| Start loss | 1 (0-1) | 14 (12-15) |
| Total | 21 (18-24) | 283 (272-293) |

Abbreviations:
IQR, interquartile range

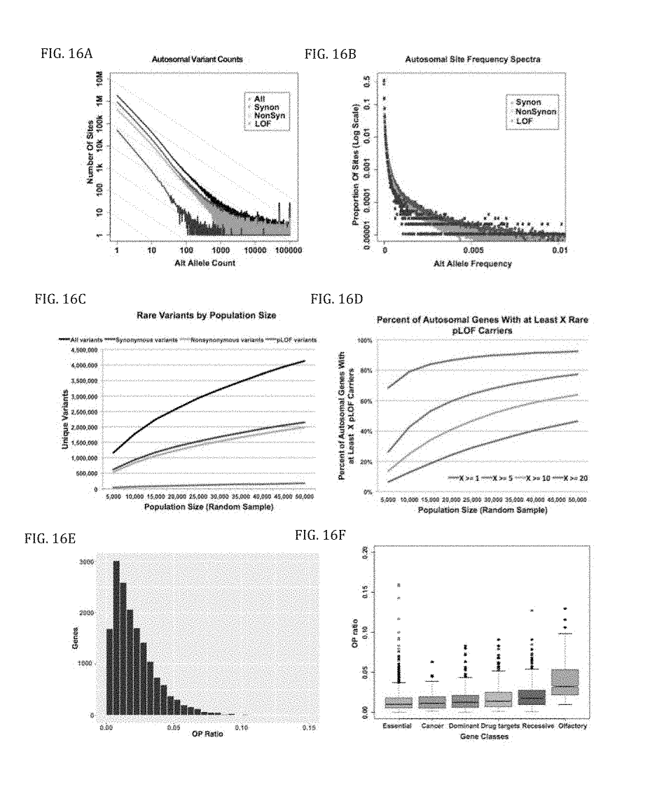

The frequency distribution for SNVs and indels by functional class was next examined (FIG. 16A and FIG. 16B). More functionally deleterious variants were enriched among rare alleles; 60% of possible loss-of function (pLoF) variants were singletons (observed only once among 50,726 participants), compared with 56% of nonsynonymous non-pLoF variants and 49% of synonymous variants. These findings suggest that pLoF variants are maintained at lower frequencies in the population by stronger purifying selection compared to less deleterious functional variant classes.

To estimate the accrual of sequence variants by functional class as sample size grows, the 50,726 sequenced individuals were randomly sampled in increments of 5,000, creating 10 samples for each increment (FIG. 16C).

FIG. 16D shows the estimated accrual of pLoF mutations per autosomal gene as a function of sequenced sample size. In the samples sequenced to date, rare pLoF variants were observed in at least one individual in 17,414 genes (92% of targeted genes); 15,525 genes (82% of targeted genes) harbored rare pLoFs in at least one individual that are predicted to cause loss of function of all protein-coding transcripts with an annotated start and stop cataloged in Ensembl 75. Homozygous pLoF variants were found in at least one individual in one or more transcripts in 1,313 genes (7% of targeted genes), and 868 genes (5% of targeted genes) harbored rare pLoFs that impacted all transcripts. A total of 312 genes harbored rare homozygous pLoF variants in five or more individuals (Table 5), and 203 genes (1° % of targeted genes) harbored pLoFs in five or more individuals that were predicted to cause homozygous loss of function of all transcripts. The latter category constitutes a cohort of human gene knockouts, providing opportunities for phenotypic association discovery for highly deleterious mutations.

TABLE 5
Number of Genes Affected by Predicted Loss of Function Variants
with Allele Frequency ≦1% in 50,726 DiscovEHR Participants

| | Number of genes affected (%) | | |
|---|---|---|---|
| Number of | All, | Heterozygotes, | Homozygotes, |
| participants | N (%) | N (%) | N (%) |
| ≧1 | 17,414 (92) | 17,409 (92) | 1,313 (7) |
| ≧5 | 14,608 (77) | 14,598 (77) | 312 (2) |
| ≧10 | 12,105 (64) | 12,093 (64) | 161 (1) |
| ≧20 | 8,815 (47) | 8,803 (47) | 81 (0.4) |

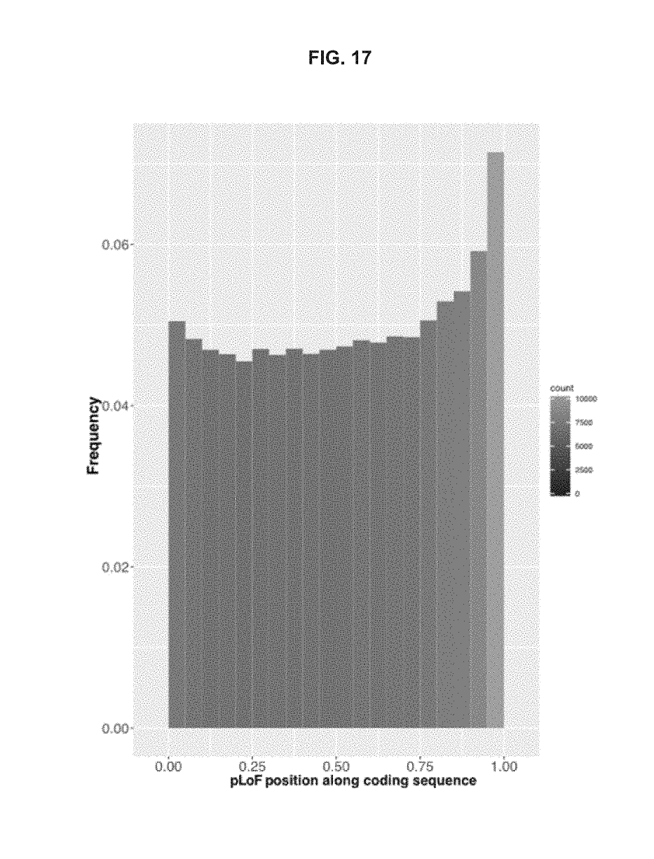

The functional context of pLoF variants was next examined, both their distribution within transcripts and representation in genes of different functional classes. Similar to MacArthur et al. (MacArthur D G, et al., Science 2012; 335: 823), a higher abundance of pLoF variants were observed in the terminal portion of transcripts, consistent with greater tolerance to putatively protein truncating mutations that result in near-full length proteins (FIG. 17). To assess the tolerance, by gene, to loss of function variation, the ratio of observed to expected premature stop mutations, calculated by in silico permutation of every nucleotide position in each protein-coding transcript, was examined (Yang J, et al., Am J Hum Genet 2011; 88: 76). The distribution of these ratios genome-wide is displayed in FIG. 16E, and by gene class in FIG. 16F. These findings suggest lower tolerance to loss of function variation in essential genes, cancer associated genes, and genes associated with autosomal dominant human diseases than genes associated with autosomal recessive disease genes, drug targets, and olfactory receptors.

Genetically Inferred Relatedness in the DiscovEHR Population Relationship Estimation

Accurate pairwise identity-by-decent (IBD) estimates were calculated using PLINK2 (Chang C C et al., Gigascience 2015; 4: 7) and were used to reconstruct pedigrees with PRIMUS (Staples J, et al., Am J Hum Genel 2014; 95: 553). Common variants (MAF>10%) were used in Hardy-Weinberg-Equilibrium (p-val>0.000001) to calculate IBD proportions all pairs of samples, excluding individuals with >10% missing variant calls (−mind 0.1) and abnormally low inbreeding-coefficient (−0.15) calculated with the −het option in PLINK. Samples with >100 relatives with pi_hat>0.1875 were removed if the proportion of relatives with pi_hat>0.1875 was less than 40% of the sample's total relationships determined by a pi_hat of 0.05, and removed all samples with >300 relatives. The remaining samples were grouped into family networks. Two individuals are in the same network if they were predicted to be second-degree relatives or closer. The IBD pipeline implemented in PRIMUS was run to calculate accurate IBD estimates among samples within each family network. This approach allowed for better-matched reference allele frequencies to calculate relationships within each family network.

Analysis of Runs of Homozygosity

Analysis of runs of homozygosity (ROH), which arise from shared parental ancestry in an individual's pedigree, is a powerful approach to estimate the extent of ancient kinship and recent parental relationship within a population. Typically, offspring of cousins have long ROH, commonly over 10 Mb. By contrast, almost all Europeans have ROH of ˜2 Mb in length, reflecting shared ancestry from hundreds to thousands of years ago. By focusing on ROH of different lengths, it is therefore possible to infer aspects of demographic history at different time depths in the past (Genomes Project, C., et al., Nature 2012; 491: 56). FROH measures were used to compare and contrast GHS to populations form 1000 genomes. These measures are genomic equivalents of the pedigree inbreeding coefficient, but do not suffer from problems of pedigree reconstruction. By varying the lengths of ROH that are counted, they may be tuned to assess parental kinship at different points in the past. FROH5, the fraction of the autosomal genome existing in ROH over 5 Mb in length, reflective of a parental relationship in the last four to six generations, was used as a metric of autozygosity.

For a subset of GHS individuals for which Omni HumanOmniExpressExome-8v1-2 genotype data were available (N=34,246), genotypes were merged with 1092 individuals from 1000 genomes phase I. ROH were identified using PLINK2 (Chang C C et al., Gigascience 2015; 4: 7). LD-based SNP pruning in windows of 50 kb was performed with a step size of 5 variants and a r-squared threshold of 0.2. On the pruned subset of variants (N=114,514), the following parameters for calculating ROH were applied: 5 MB window size; a minimum of 100 homozygous SNPs per ROH; a minimum of 50 SNPs per ROH window; one heterozygous and five missing calls per window; a maximum between-variant distance within a run of homozygosity of no more than 1 Mb. ROH were identified separately GHS individuals and for each 1000 genomes population.

Three features of ROH were assessed: (i) number of homozygous segments (average and range, calculated across individuals within a population), (ii) summed segment length (average and range, calculated across individuals within a population) and (iii) FROH, a genomic measure of individual autozygosity, defined as the proportion of the autosomal genome in ROH above a specified length threshold (FROH1 was used to define the proportion of the genome in runs 1 Mb or greater in length, and FROH5 to define proportions in runs of 5 Mb or greater in length) (Genomes Project, C., et al., Nature 2012; 491: 56).

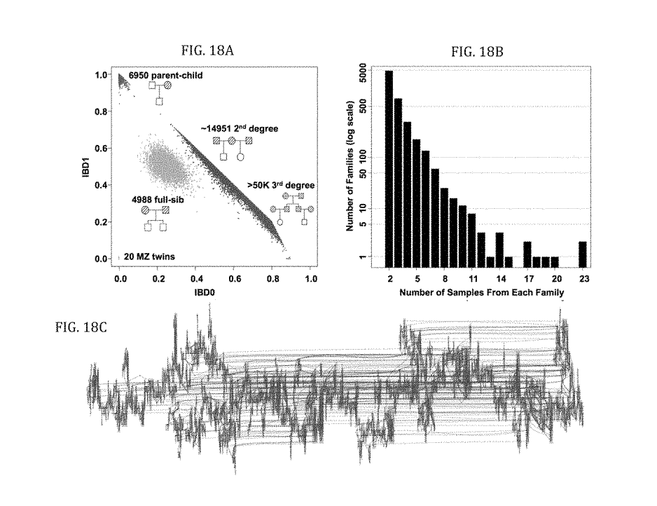

Because study participants were sampled from a stable regional healthcare population, close familial relationships were expected, and in some cases, large multigenerational kindreds, to be represented in the study population. To understand the extent of family relationships in the data, PRIMUS (Staples J, et al., Am J Hum Gelet 2014; 95: 553) was used to identify closely related individuals and infer pedigrees from whole exome sequence data. Among the 50,726 sequenced participants, 11,958 first-degree family relationships were identified (20 identical twin pairs, 6,950 parent-child relationships, and 4,988 full-sibling relationships), 14,951 second-degree relationships, and >50,000 third-degree relationships (FIG. 18A).

Altogether, 48% of sequenced participants had one or more first- or second-degree relative in the dataset (FIG. 18B). Using only the first- and second-degree relationships to cluster individuals into family networks, over 6,000 pedigrees were identified with a median pedigree size of 2 sequenced individuals. This is consistent with GHS patients receiving care (and enrolling in MyCode) as family units, which is to be expected for a large integrated system serving a largely rural population (FIG. 18C). The largest single relationship network including 1^{st} and 2^{nd} degree relatives consisted of 3,144 individuals (FIG. 18C).

For GHS individuals, a mean FROH5 of 0.0006 was noted. For CEU individuals, a mean FROH5 of 0.0008 was noted. This is consistent with previous estimates for European and European-derived populations, where HapMap CEU individuals also had a mean FROH5 of 0.0008 and English individuals had a mean FROH5 of 0.0001 (O'Dushlaine C T, et al., Eur J Hum Genet 2010; 18: 1248). It was concluded that as a population as a whole, GHS individual have level of genomic autozygosity that is lower than CEU and only slightly higher than individuals from England.

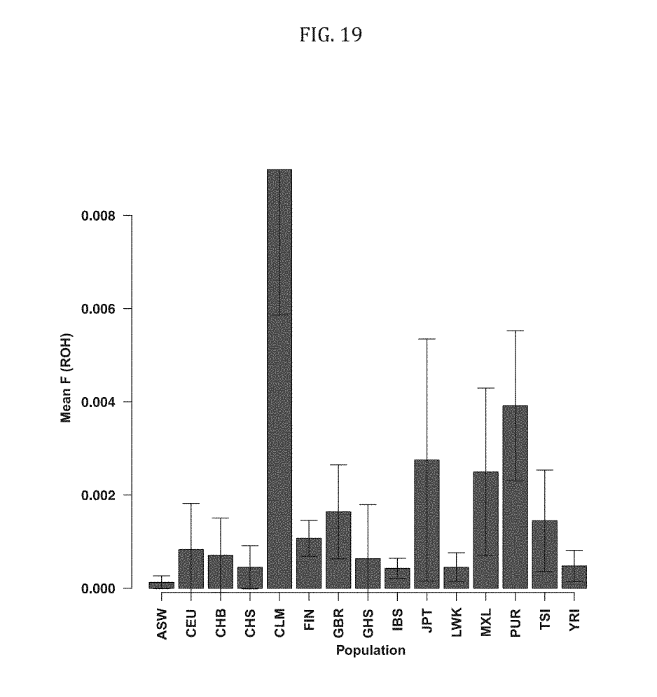

Analysis of runs of homozygosity (ROH), which arise from shared parental ancestry in an individual's pedigree, is a powerful approach to estimate the extent of ancient kinship and recent parental relationship within a population. Runs of homozygosity calculated from 34,246 GHS individuals for which Omni HumanOmniExpressExome-8v1-2 genotype data were available was examined, and compared these findings to 1092 individuals from 1000 genomes phase I. FROH5, the fraction of the autosomal genome existing in ROH over 5 Mb in length, was used, which is reflective of a parental relationship in the last four to six generations, as a metric of autozygosity. In this analysis a mean FROH5 of 0.0006 was observed. For CEU individuals from the 1000 genomes project phase I, a mean FROH5 of 0.0008 was noted. This is consistent with previous estimates for European and European-derived populations, where HapMap CEU individuals also had a mean FROH5 of 0.0008 and English individuals had a mean FROH5 of 0.0001 (O'Dushlaine C T, et al., Eur J Hum Genet 2010; 18: 1248) (FIG. 19). Overall, an average of 1.2% of autosomal genomic regions in DiscovEHR participants are estimated to be autozygous. Collectively, these findings indicate substantial familial substructure in the DiscovEHR population, with rates of autozygosity similar to other outbred European populations (O'Dushlaine C T, et al., Eur J Hum Genet 2010; 18: 1248).

Exome Wide Association Discovery for Serum Lipids

Phenotype Definitions

Disease status was defined using International Classification of Diseases, Ninth Edition (ICD-9) diagnosis codes. ICD-9 based diagnoses required one or more of the following: a problem list entry of the diagnosis code, an inpatient hospitalization discharge diagnosis code, or an encounter diagnosis code entered for two separate outpatient encounters on separate calendar days. Median values for serially measured laboratory and anthropomorphic traits, including total cholesterol, low-density lipoprotein cholesterol (LDL-C), high-density lipoprotein cholesterol (HDL-C), triglycerides, body mass index were calculated for all individuals with two or more measurements in the EHR following removal of likely spurious values that were >3 standard deviations from the intra-individual median value. For the purposes of exome-wide association analysis of serum lipid levels, total cholesterol and LDL-C were adjusted for lipid-altering medication use by dividing by 0.8 and 0.7, respectively, to estimate pre-treatment lipid values based on the average reduction in LDL-C and total cholesterol for the average statin dose (Baigent C, et al., Lancet 2005; 366: 1267). HDL-C and triglyceride values were not adjusted for lipid-altering medication use. HDL-C and triglycerides were log₁₀ transformed, and medication-adjusted LDL-C and total cholesterol values were not transformed. Trait residuals were calculated after adjustment for age, age², sex, and the first ten principal components of ancestry, and rank-inverse-normal transformed these residuals prior to exome-wide association analysis.

Association Analysis for Serum Lipid Levels

To illustrate the potential for association discovery using EHR-derived phenotypes and whole exome sequence data in DiscovEHR, exome-wide association study for median fasting lipid levels (total cholesterol, HDL-C, LDL-C, and triglycerides) was performed in 39,087 participants of European American ancestry from the DiscovEHR cohort. This included 32,840 participants with two or more serially gathered measurements and a median of 6 measurements per individual. Fasting lipid levels are heritable risk factors for ischemic vascular diseases such as coronary artery disease, myocardial infarction, and stroke.

In single-marker exome-wide association analysis of lipid levels, all bi-allelic variants with missingness rates <1%, Hardy-Weinberg equilibrium p-values >1.0×10⁻⁶, and minor allele frequency >0.1% were analyzed. Genotypes were coded according to an additive model (0 for homozygous reference, 1 for heterozygous, and 2 for homozygous alternative). To account for population structure from ancestry and relatedness, mixed linear models of association were used to test for associations between single variants and lipid trait residuals, fitting a genetic relatedness matrix (constructed from 39,858 non-MHC markers in approximate linkage equilibrium with minor allele frequency >0.1%) as a random-effects covariate.

The same statistical testing framework was used to identify associations between variants, aggregated over the gene (Li B and S M Leal, Am J Hum Genet 2008, 83: 311) and the traits enumerated above. Three variant sets for association analysis were used:

1. Predicted loss of function mutations.
2. Predicted loss of function mutations and non-synonymous variants that were predicted deleterious by consensus of 5/5 algorithms (SIFT, LRT, MutationTaster, PolyPhen2 HumDiv, PolyPhen2 HumVar).
3. Predicted loss of function mutations and rare (alternative allele frequency <1%) non-synonymous variants that were predicted deleterious by at least ⅕ algorithms.

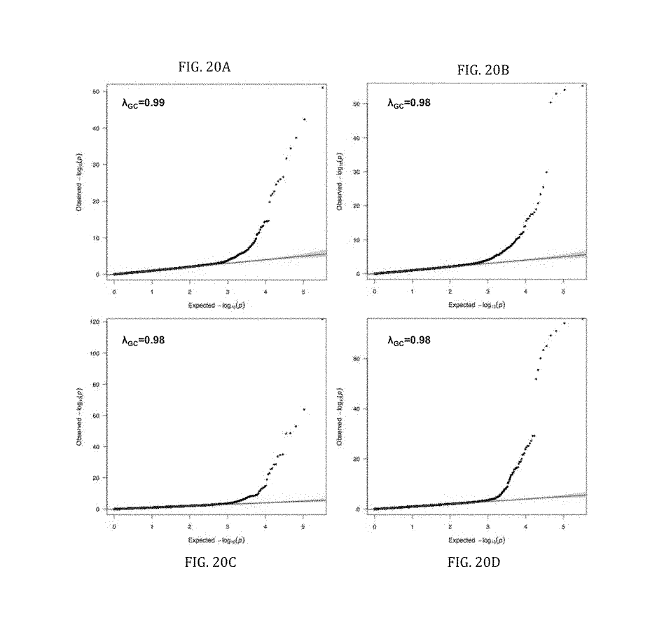

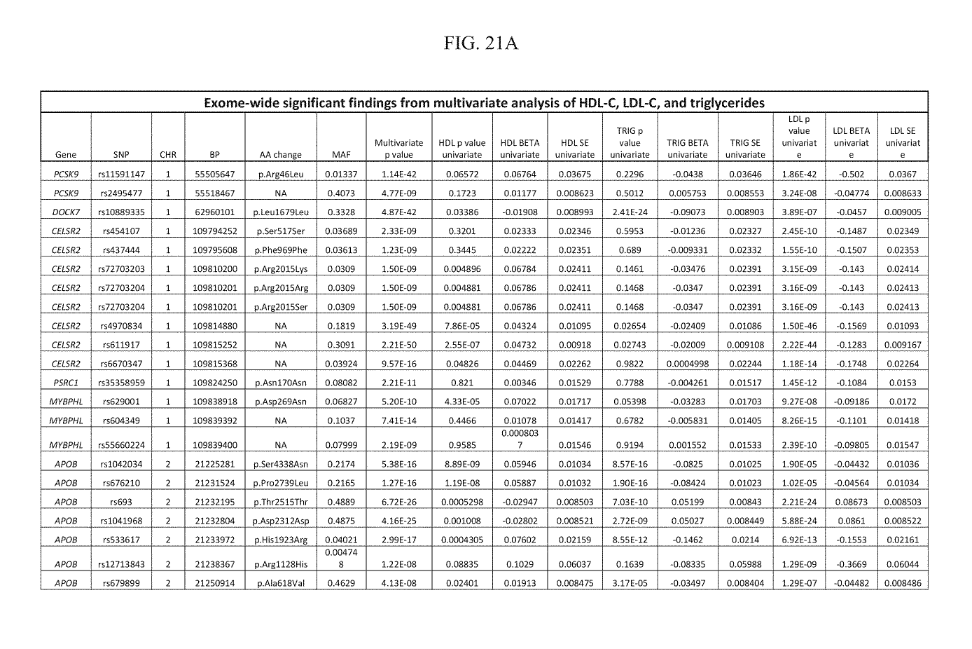

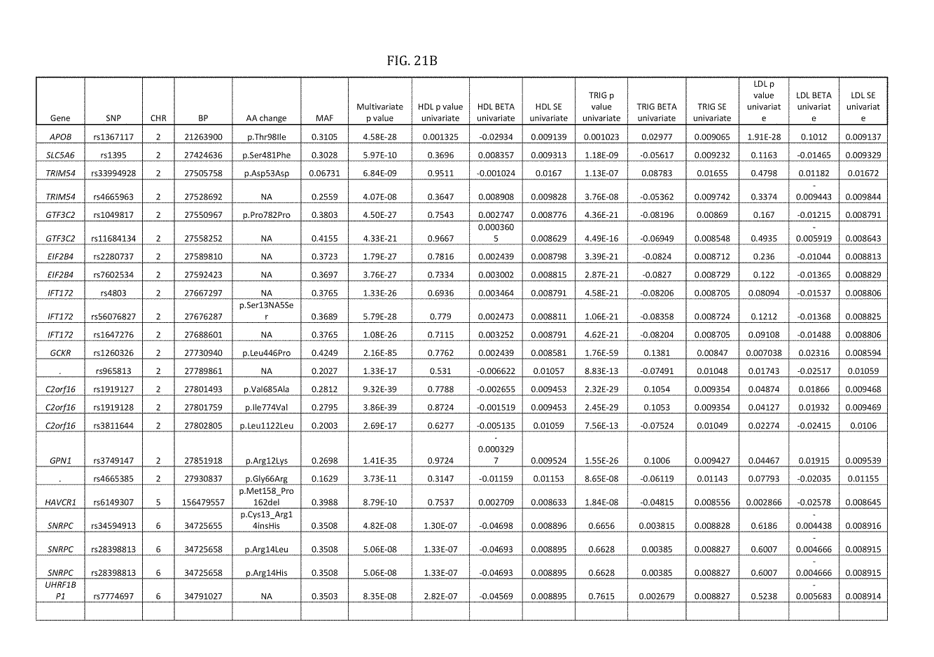

Alleles were coded 0, 1, 2 for non-carriers, heterozygotes for at least one allele who were homozygotes for no alleles, and homozygotes for at least one allele in each variant set, respectively. Exome-wide quantile-quantile plots and genomic control lambda values for single-marker and gene-based burden tests are provided in FIG. 20A-D. No problematic systematic inflation of p values was observed. GTCA v1.2.4 (Yang J, et al., Am J Hum Genet 2011; 88: 76) and R version 3.2.1 (R Project for Statistical Computing) were used for all statistical analyses.

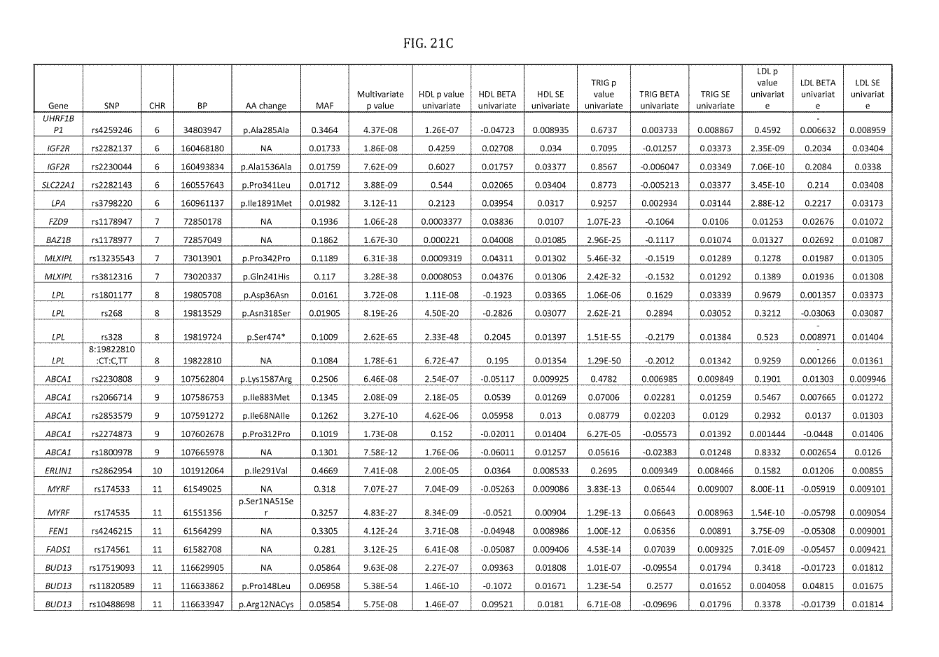

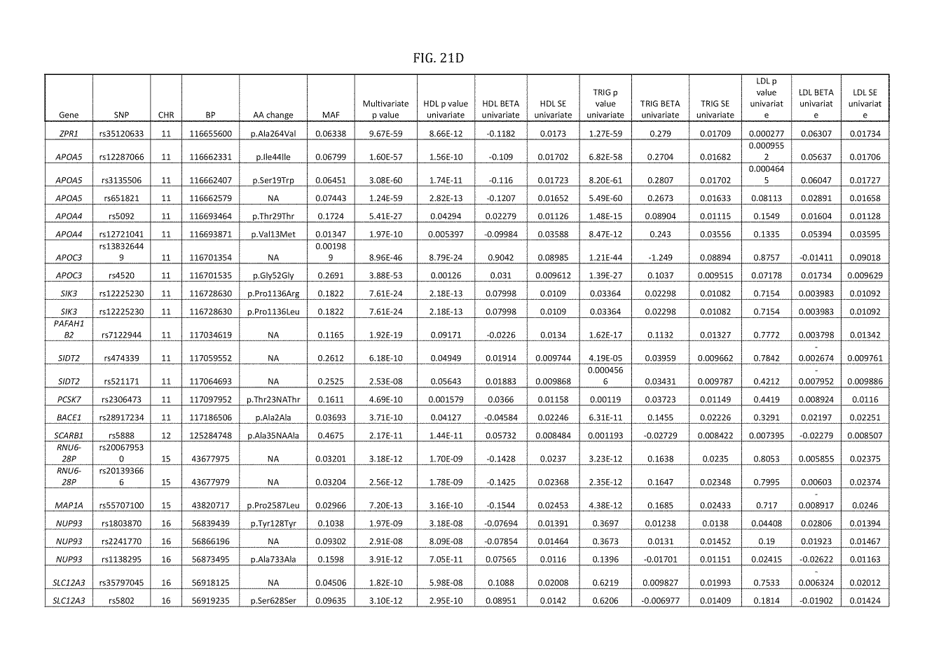

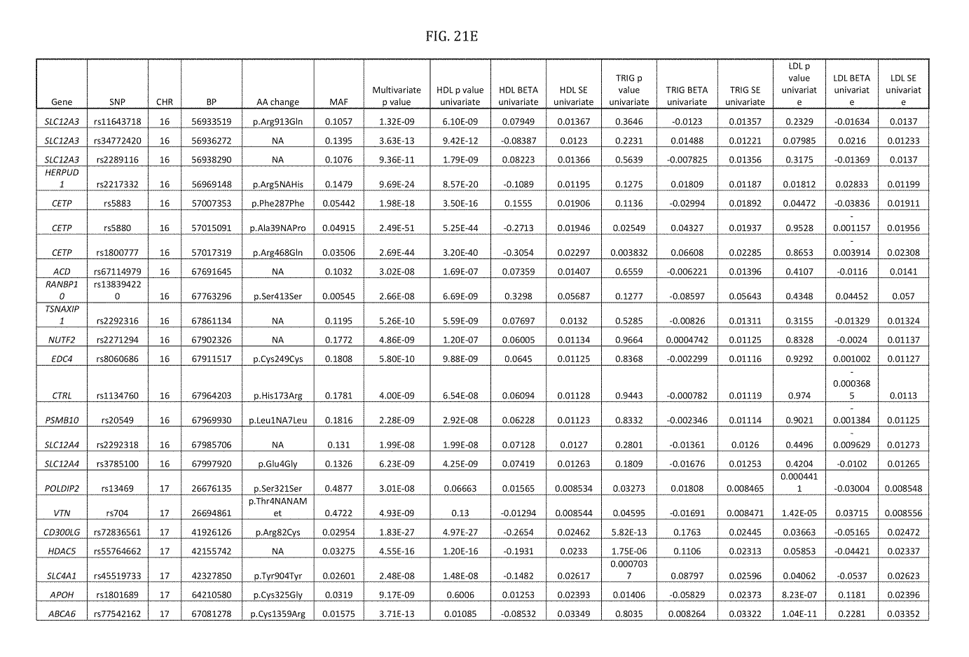

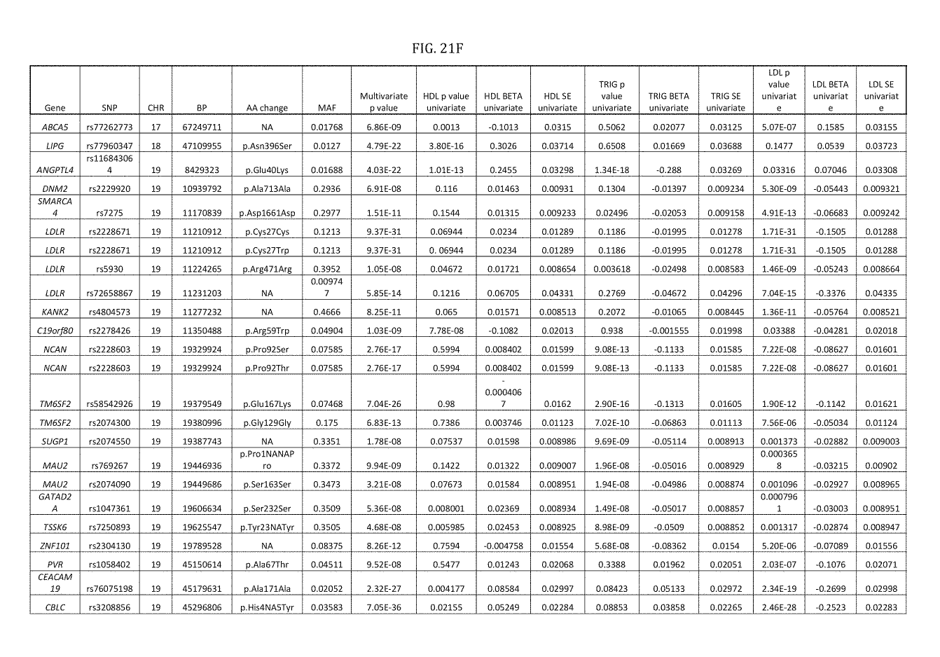

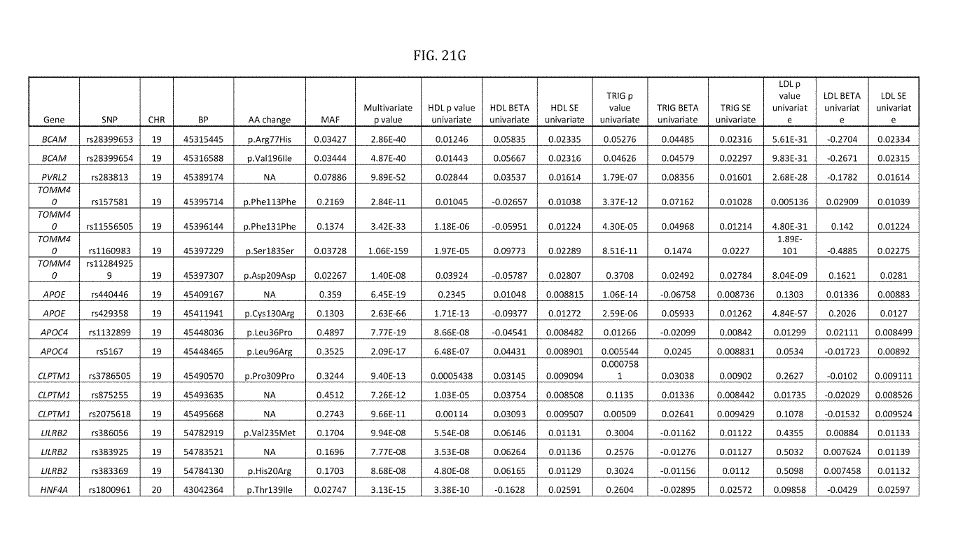

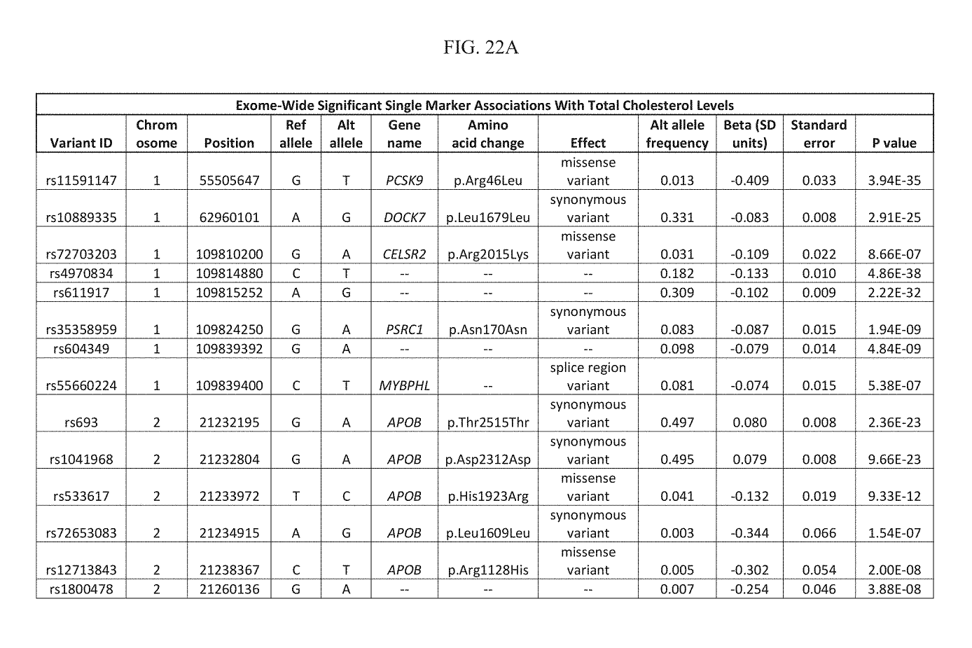

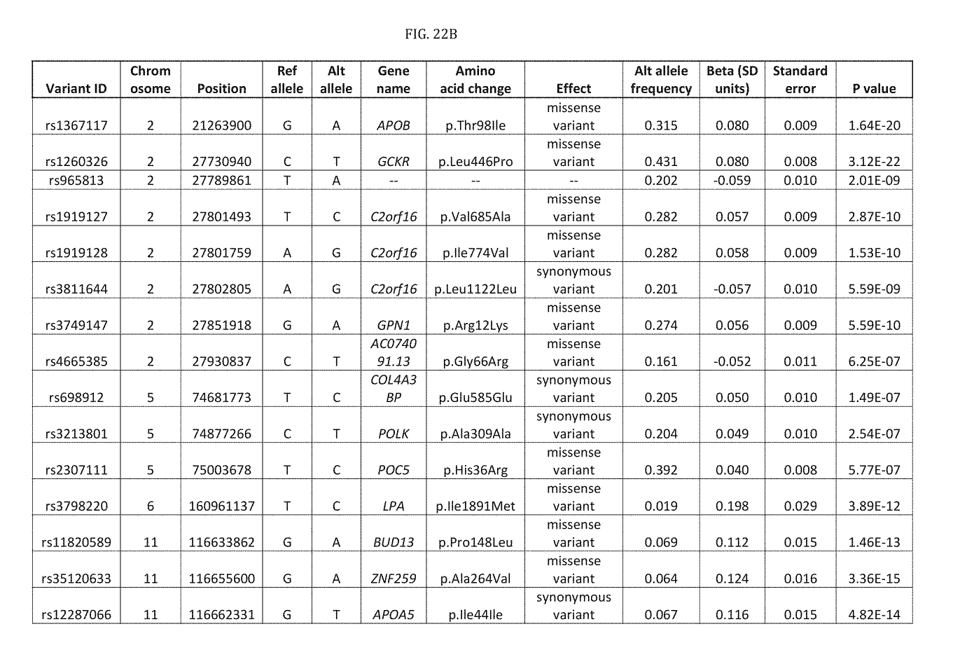

Canonical correlation analysis, a multivariate generalization of the Pearson product-moment correlation, was also used to jointly measure the association between genotypes and lipid traits. The lipid traits used in joint testing by computing correlation between all exonic variants and all traits, extracted from the electronic health record (EHR), were median lifetime LDL-C, HDL-C and triglycerides. There is a high correlation between LDL-C and total cholesterol thus total cholesterol was not included in the multivariate model. 27,511 unrelated individuals of European ancestry with complete data on all 3 lipid traits were used to perform multivariate analysis implemented in MV-PLINK (Ferreira M A and S M Purcell, Bioinformatics, 2009; 25: 132 25)—the command used for association testing with MV-PLINK was: plink.multivariate -noweb -file geno -mqfam -mult-pheno pheno.phen -out output. An additive model was applied. The same model adjustment for age, sex, medication use and principle components for the lipid traits as done in the univariate lipid exwas analysis was performed, and the residuals were used as an input in MV-PLINK. MV-PLINK produces an F-statistic and a p-value per genetic variant analyzed. SNPs that have a multivariate p-value below a 1×10⁻⁷ threshold were considered exome wide significant SNPs. The univariate p-value and beta was computed using Plink linear regression to obtain the effect size estimate for the each trait. The pleiotropic effect was considered when a SNP is associated with two or more traits. These results are depicted in FIG. 21A-G.

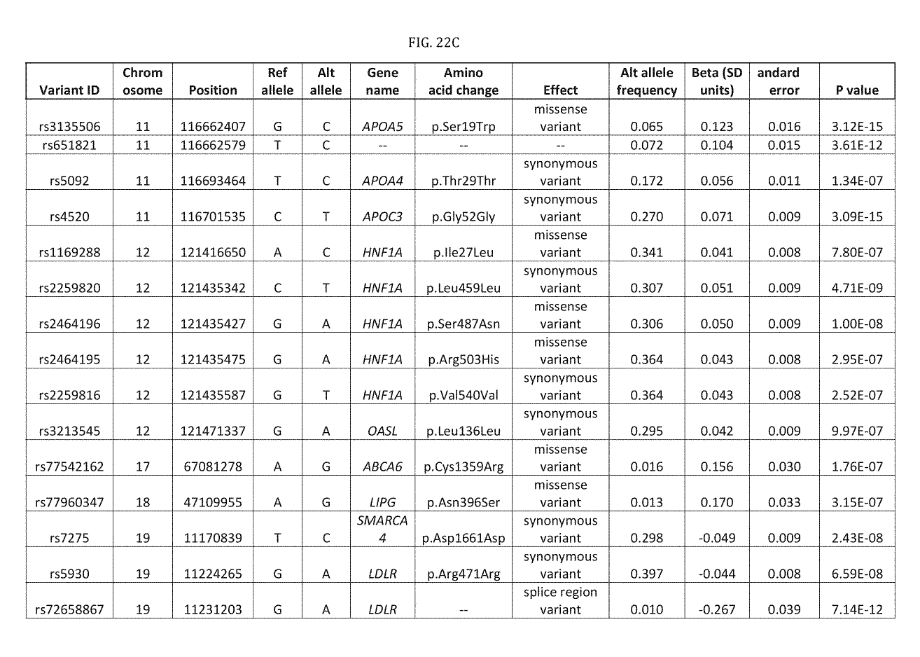

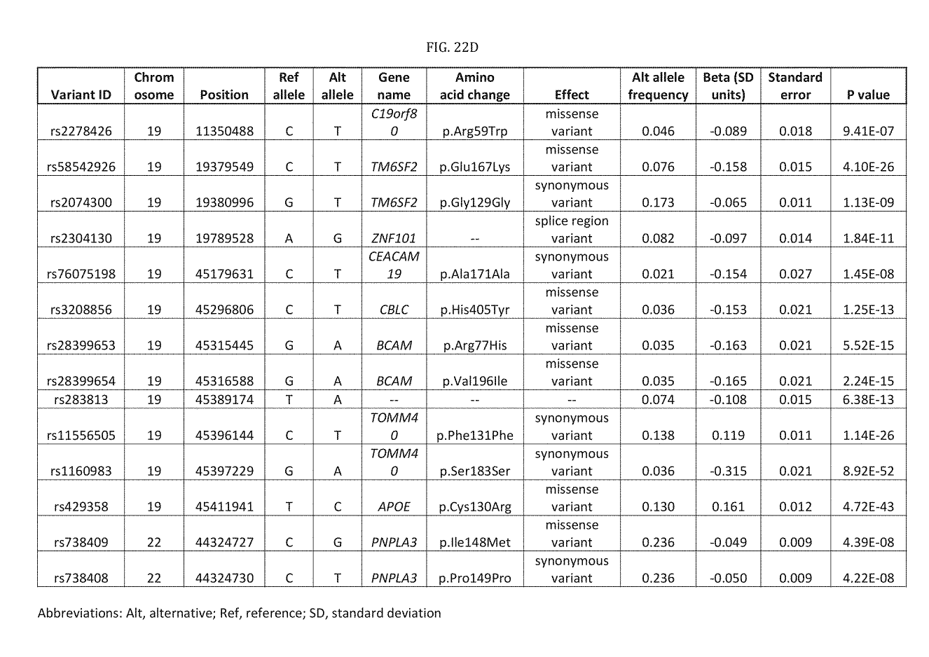

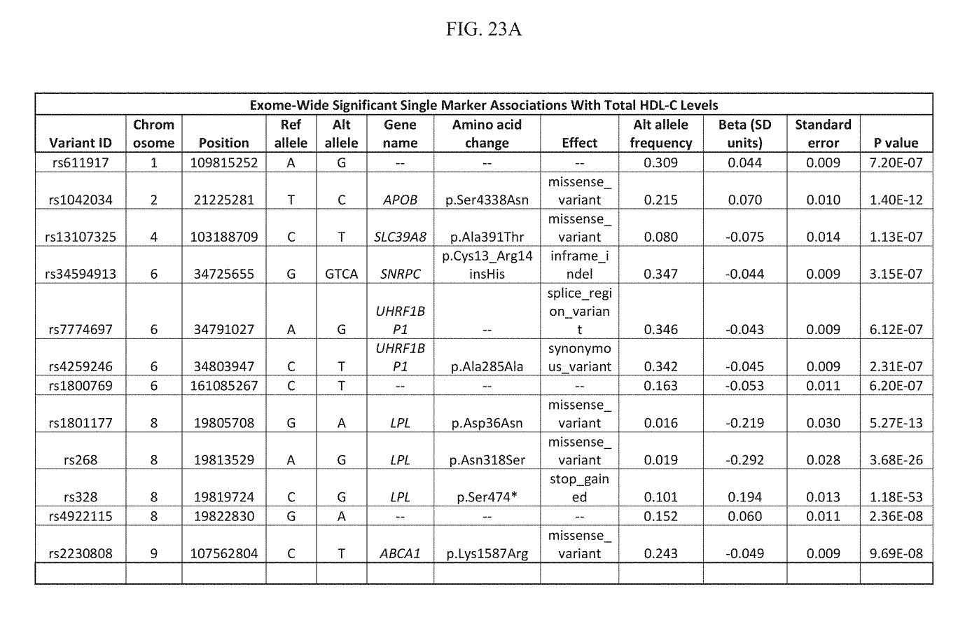

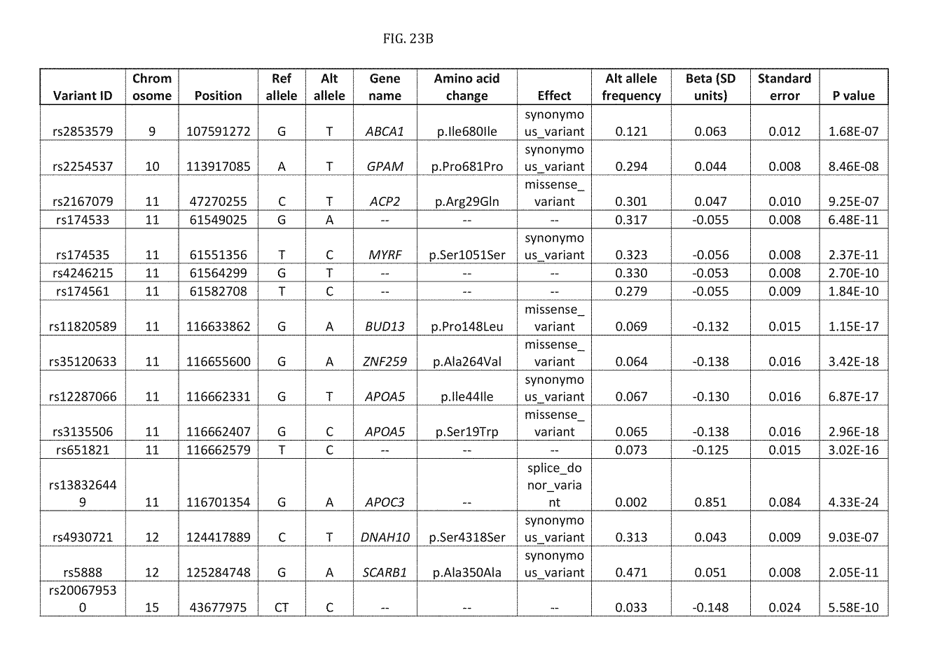

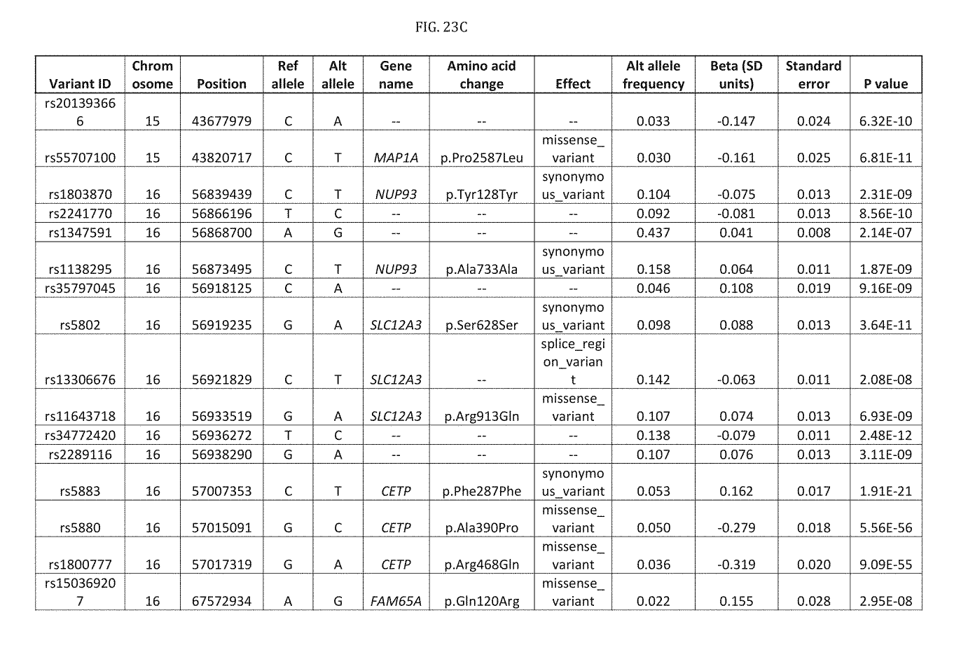

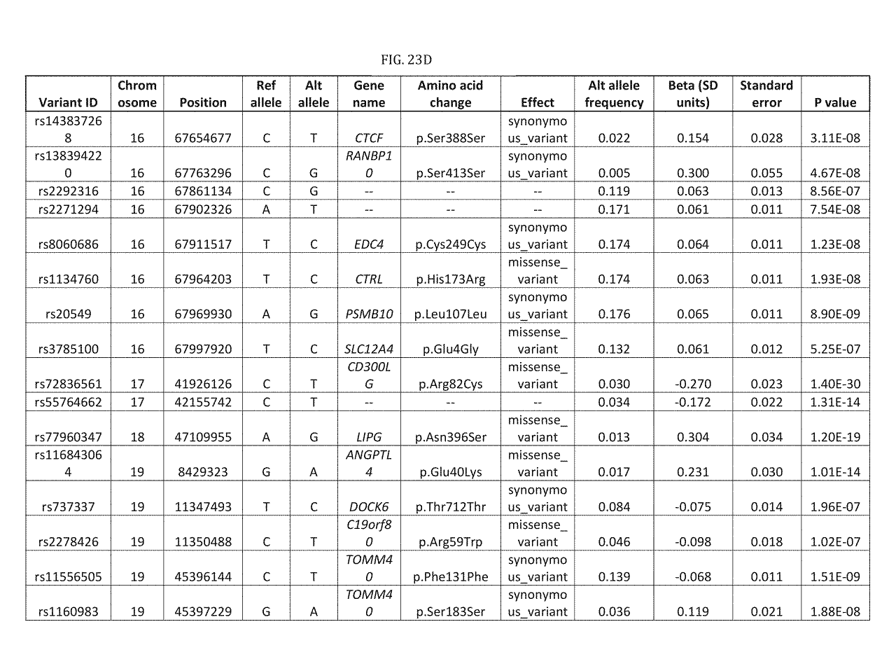

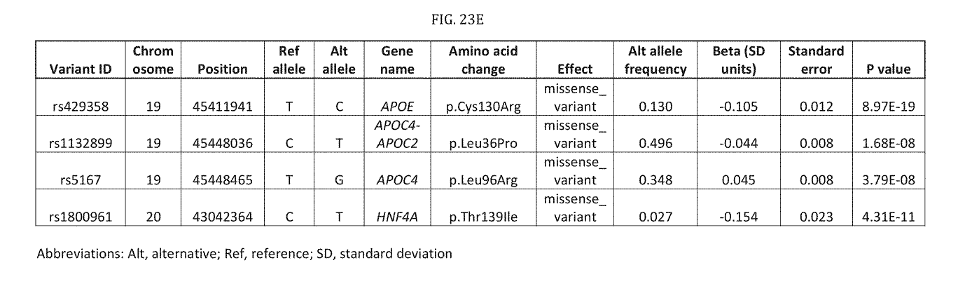

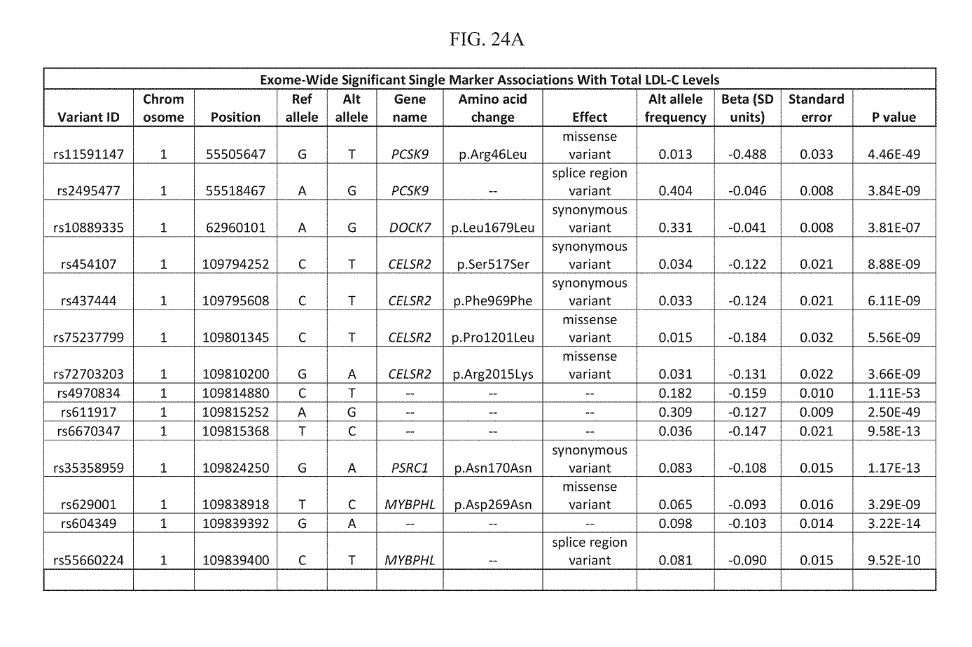

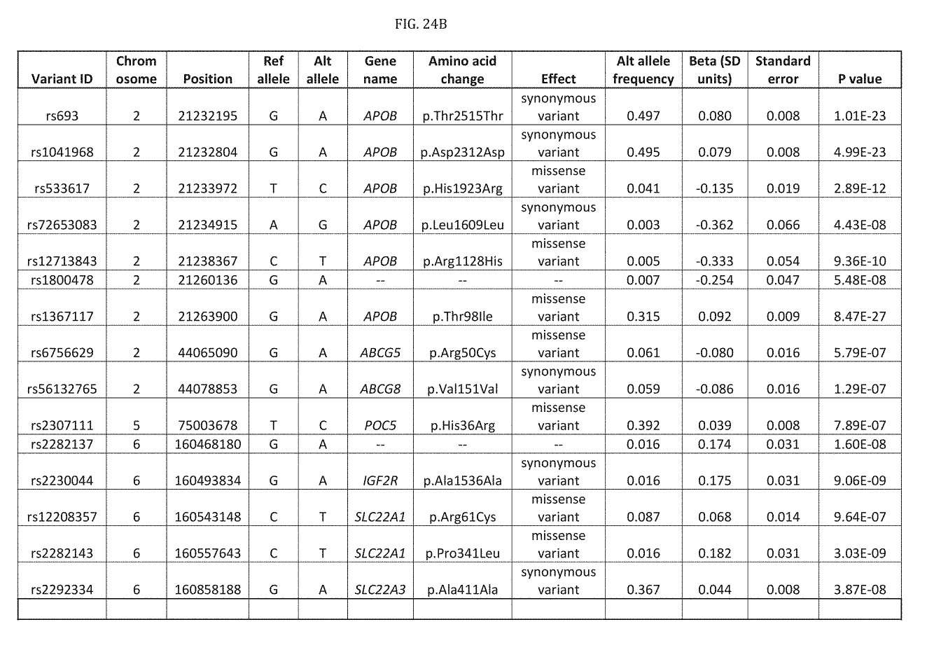

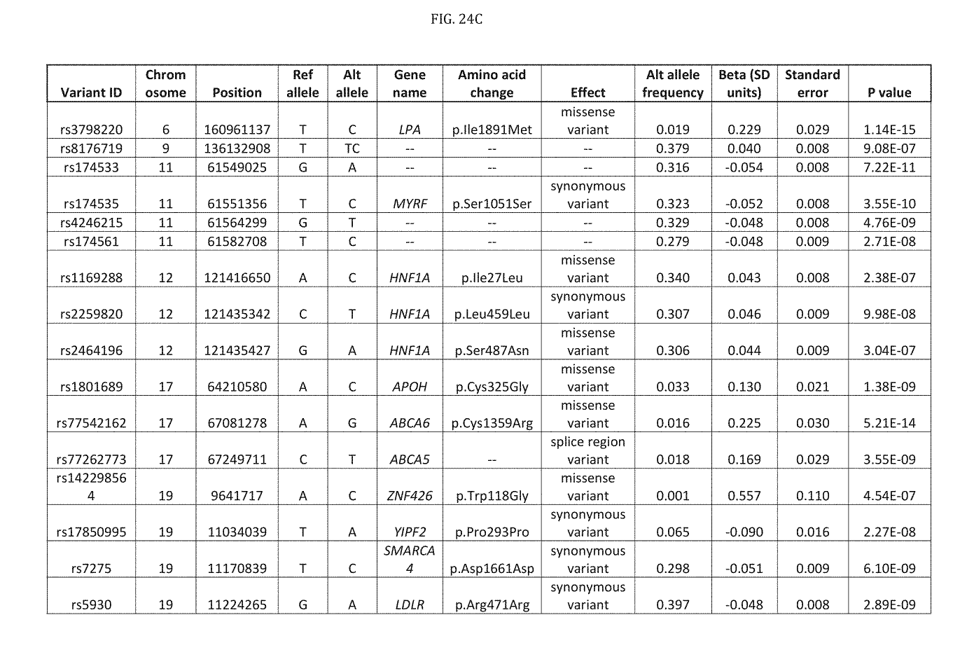

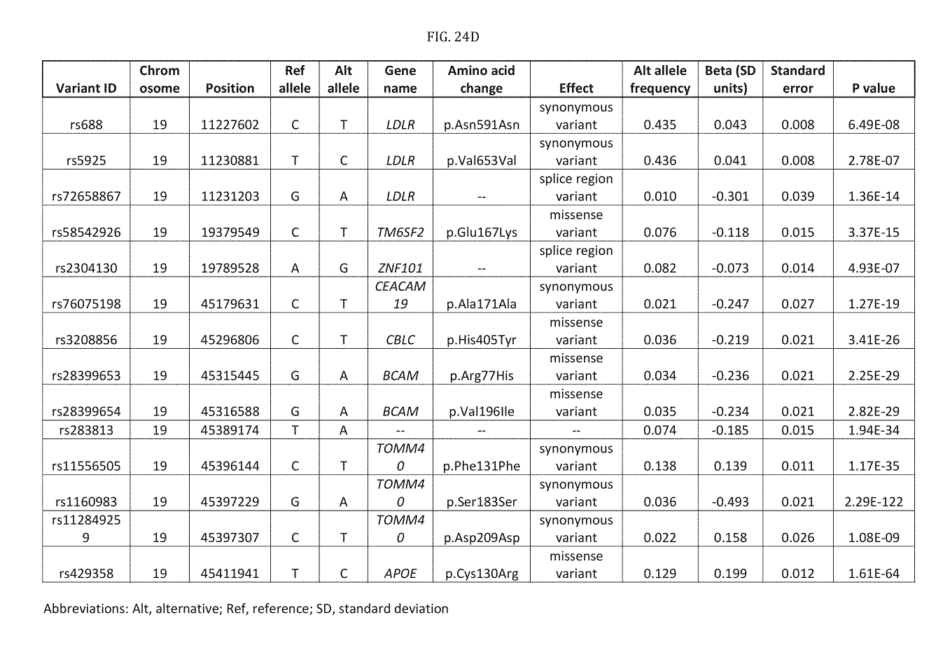

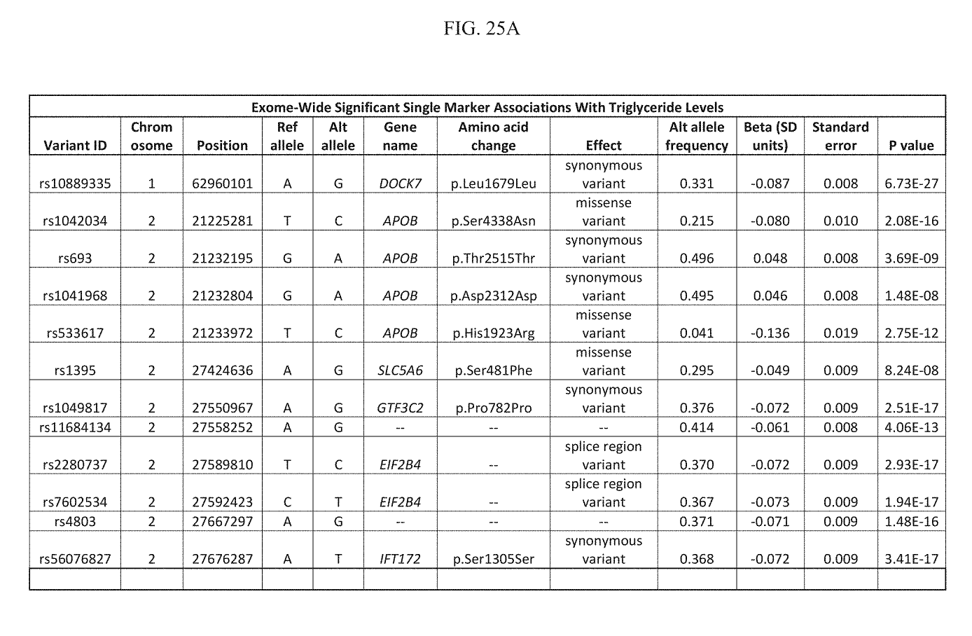

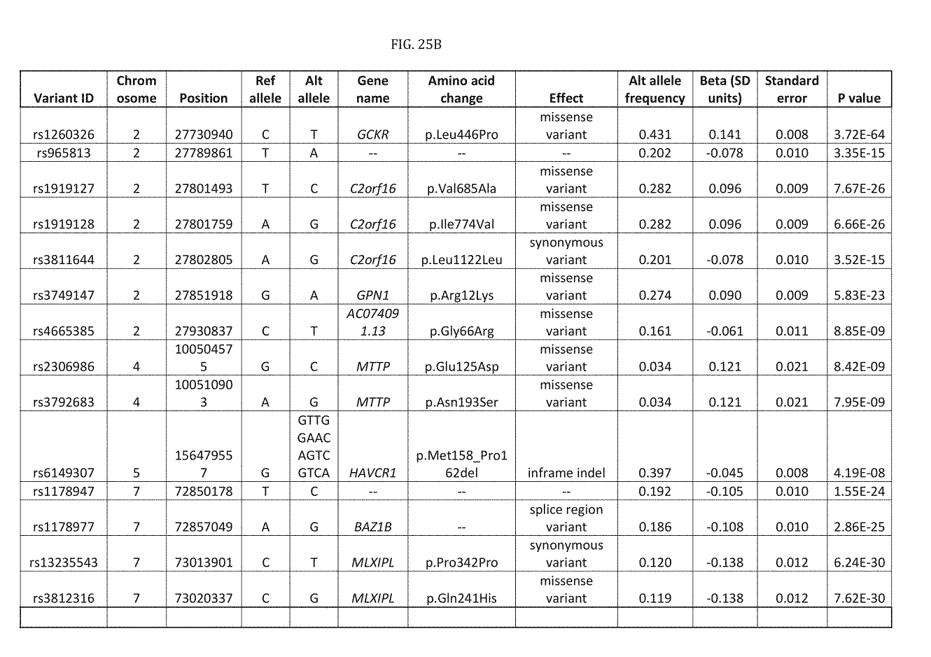

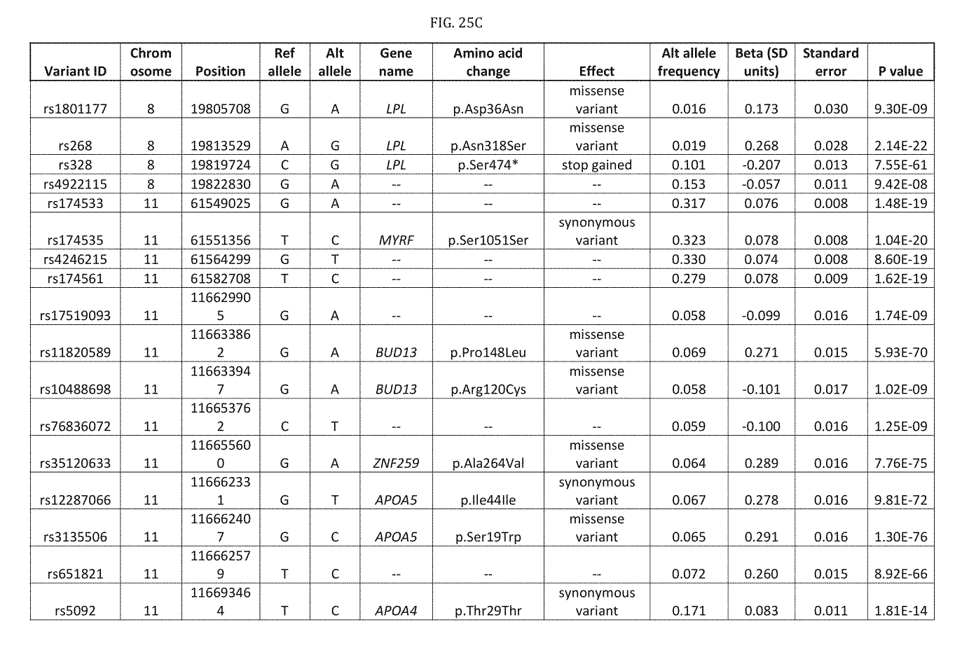

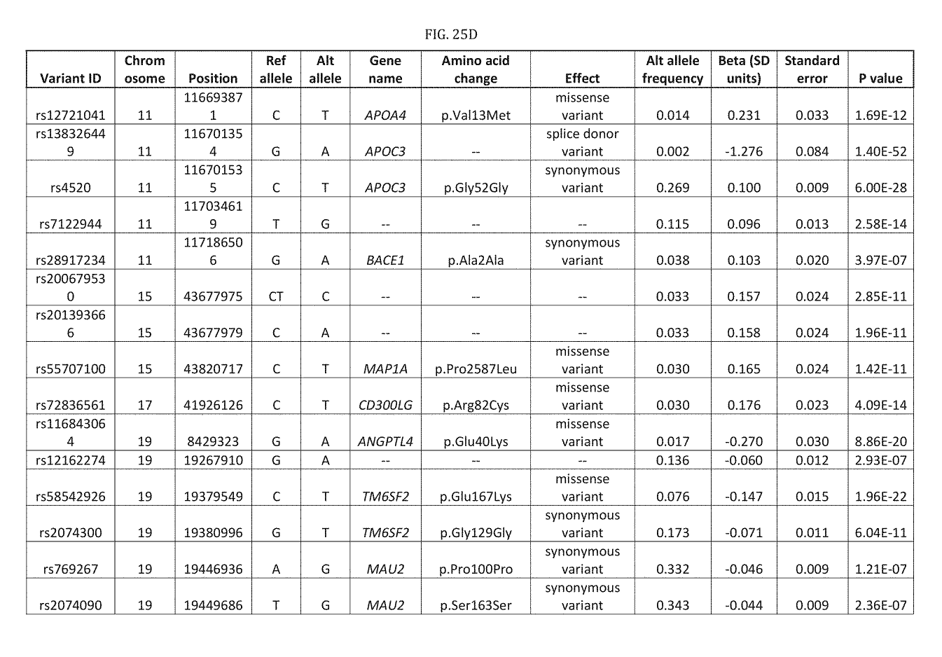

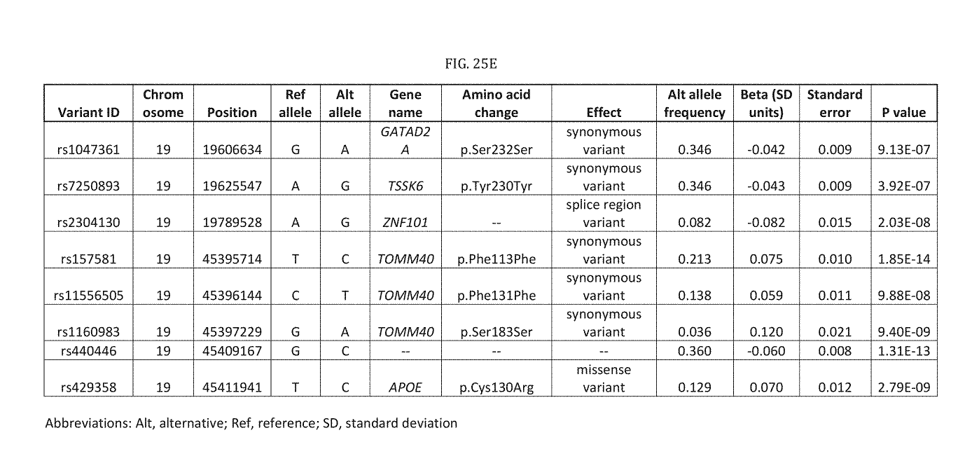

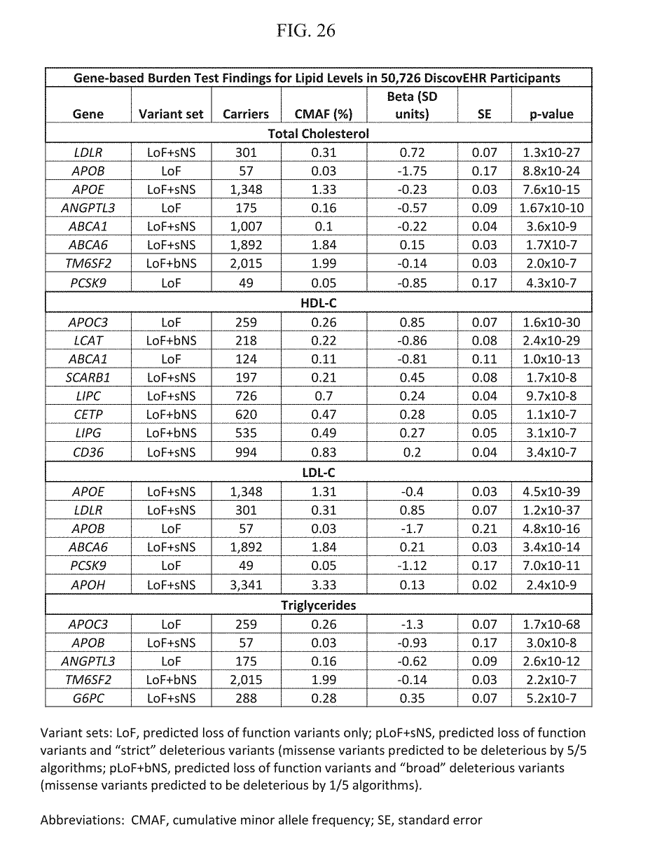

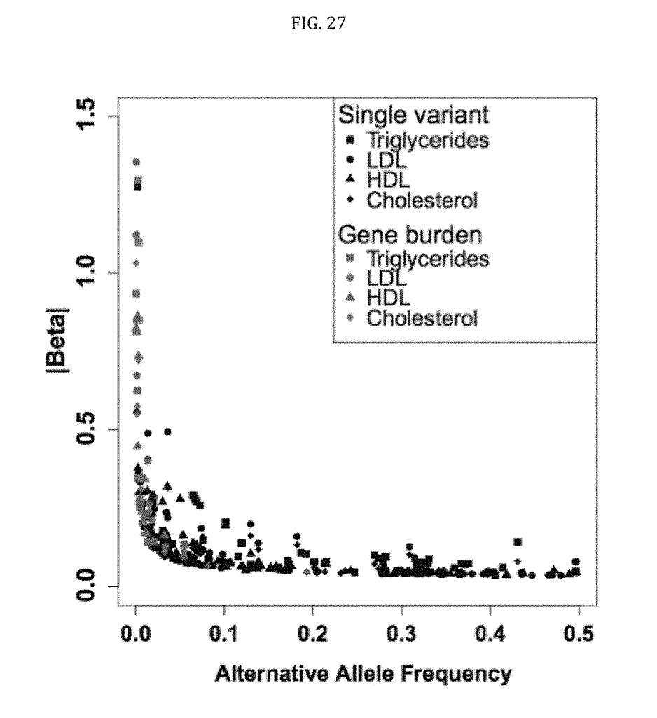

In tests of association for 160,341 biallelic single variants with minor allele frequency greater than 0.1%, 51 SNVs or indel variants (30 nonsynonymous or splice) were identified in 17 loci with exome-wide significant associations (p<1×10⁻⁷) with total cholesterol, 57 variants (29 nonsynonymous or splice) in 20 loci with exome wide significant associations with HDL-C, 55 variants (27 nonsynonymous or splice) in 16 loci with exome-wide significant associations with LDL-C, and 65 variants (30 nonsynonymous or splice) in 17 loci with exome-wide significant associations with triglycerides (FIG. 22A-D, FIG. 23A-E, FIG. 24A-D, FIG. 25A-E, FIG. 26). Consistent with other reports (Consortium, U K, et al., Nature 2015; 526: 82; Peloso G M, et al., Am J Hum Genet 2014; 94: 223; Lange, L A, et al., Am J Hum Genet 2014; 94: 233), an inverse association was observed between allele frequency and effect size (FIG. 27), finding a total of four independent exome-wide significant associations with lipid levels for rare single variants: rs138326449-A in APOC3 (IVS2+1G>A, allele frequency 0.2%), which was associated with lower triglyceride levels (beta=−1.27, p=1.4×10⁻⁵²) and higher HDL-C levels (beta=0.85, p=4.3×10⁻²⁴); rs12713843-T in APOB (p.Arg1128His, allele frequency 0.5%) associated with lower LDL-C levels (beta=−0.33, p=9.4×10⁻¹⁰) and lower total cholesterol levels (beta=−0.30, p=2.0×10⁻⁸); rs72658867-A (allele frequency 0.1%), an intronic variant in LDLR associated with lower LDL-C levels (beta=−0.30, 1.4×10⁻¹⁴) and lower total cholesterol levels (beta=−0.27, p=7.1×10⁻¹²), which corroborates a recent report of a similar association with LDL-C levels for this rare variant Consortium, U K, et al., Nature 2015; 526: 82; rs142298564-C in ZNF426 (p.Trp118Gly, allele frequency 0.1%) associated with higher LDL-C levels (beta=0.55, p=4.5×10⁻⁷). The last association was newly discovered by this project, and nominates ZNF426, encoding zinc finger 426, as a novel LDL-associated gene.

To capture additional associations for variants of similar functional consequences that might be too rare in isolation to associated with lipid levels at exome-wide levels of significance, gene-based association testing was performed for three sets of variants: 1) pLoFs, 2) pLoFs and non-synonymous variants that were predicted deleterious by consensus of five algorithms, and 3) pLoFs and rare non-synonymous variants that were predicted deleterious by one algorithm. This analysis identified novel rare alleles associated with HDL-C (LIPG, LIPC, LCAT, SCARB1), LDL-C (ABCA6, APOH), and triglycerides (ANGPTL3) (FIG. 21) at exome-wide levels of significance for gene-based burden testing (p<1×10⁻⁶), in addition to rare alleles with well-established associations with lipid levels.

One gene was newly implicated by variant burden tests for associations with lipid levels in the European population: 288 heterozygous carriers of pLoF variants and predicted deleterious variants in G6PC had significantly higher triglyceride levels (beta=0.35, p=5.2×10⁻⁷). G6PC encodes glucose 6 phosphatase, catalytic subunit, one of three catalytic-subunit encoding genes in humans. Homozygous and compound heterozygous mutations in G6PC are associated with glycogen storage disease type I, characterized by lipid and glycogen accumulation in the liver and kidneys accompanied by hypoglycemia, lactic acidosis, hyperuricemia, and hyperlipidemia (Chou J Y, et al., Curr Mol Med 2002; 2: 121).

These results suggest that heterozygotes for protein disrupting mutations in G6PC may manifest an intermediate phenotype characterized by moderate levels of hypertriglyceridemia. 994 heterozygous carriers of pLoF variants and predicted deleterious variants were identified in CD36 who had significantly higher HDL-C levels (beta=0.20, p=3.4×10⁻⁷). CD36 encodes a broadly expressed membrane glycoprotein that serves as a receptor for various ligands, including oxidized lipoproteins and fatty acids (Thorne R F, et al., FEBS Lett 2007; 581: 1227). A role in HDL-C uptake in the liver has been proposed by studies of CD36 knockout mice (Brundert M, el al., J Lipid Res 2011; 52: 745), and common variation at the CD36 locus has been associated with HDL-C levels in African Americans (Coram M A, et al., Am J Hum Genet 2013; 92: 904; Elbers C C, et al., PLoS One 2012; 7: e50198). These results provide further evidence of a role for CD36 in modulation of HDL-C levels in humans via this association with aggregated rare functional variants in individuals of European ancestry. These results demonstrate that comprehensive interrogation of rare coding variation using exome sequencing, and considering coding variants in aggregate in association testing can reveal novel associations with EHR-derived phenotypes.

Protein Disrupting Mutations in Drug Target Genes Recapitulate Therapeutic Effects

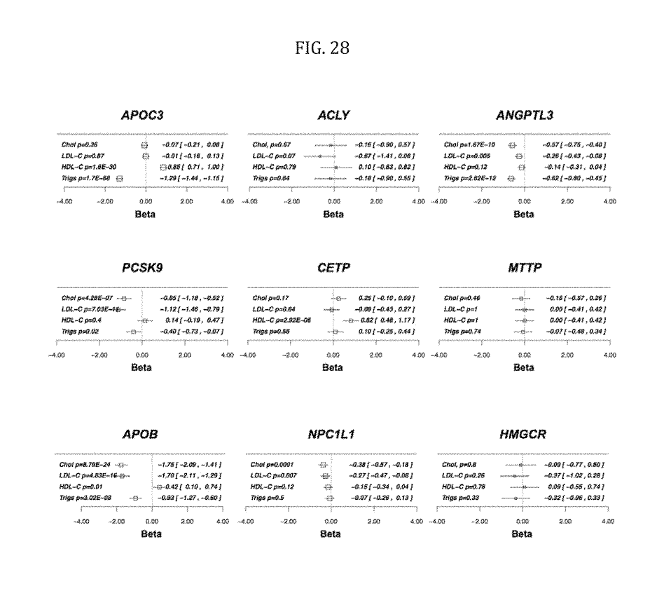

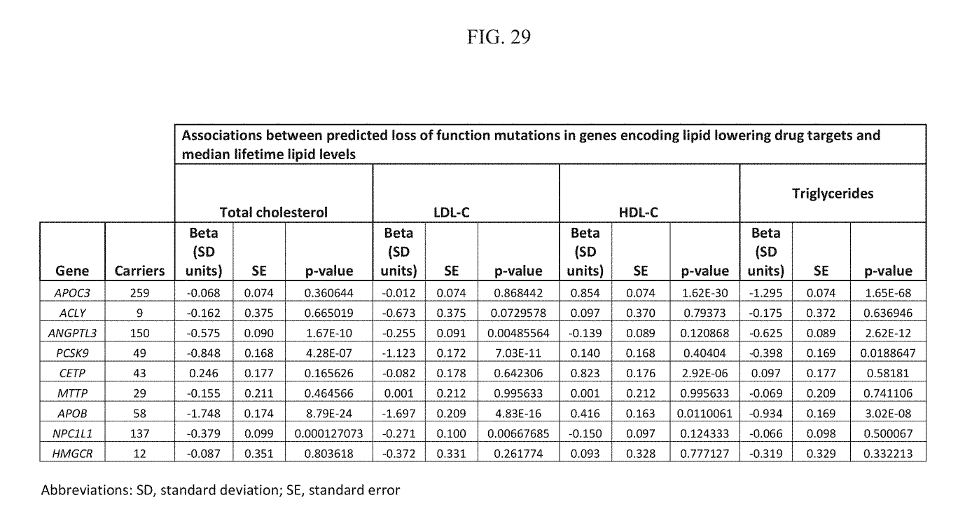

Genetic variants in human populations may illuminate new therapeutic targets. Human genetic variants that inactivate a gene encoding drug targets may mimic the action of therapeutic antagonism of these targets, thereby providing an “experiment of nature” that may be used to infer the clinical effects of such drugs. To illustrate the potential of coupling clinical phenotypes from the DiscovEHR population to loss of function variants for therapeutic target discovery, association analyses was performed with median lifetime lipid levels extracted from the EHR for pLoF variants, aggregated by gene, in nine therapeutic targets of drugs in development or approved by the US Food and Drug Administration for lipid modification. The results of these analyses are described in FIG. 28 and FIG. 29.

Of these drug target genes, 6/9 harbored pLoF variants that were at least nominally associated with lipid phenotypes recapitulating clinical effects of the therapeutic agent. Among currently approved therapeutics, these observations confirm associations between rare pLoF variants in NPC1L1 (n=137 heterozygotes), which encodes the target of ezetemibe, and PCSK9 (n=49 heterozygotes), which encodes the target of alirocumab, evolocumab, and bococizumab and reduced LDL-C levels (Kathiresan S and Myocardial Infarction Genetics, N Engl J Med 2008; 358: 2299; Benn M, et al., J Am Coll Cardiol 2010; 55: 2833; Cohen J C, et al., N Engl J Med 2006; 354: 1264; Myocardial Infarction Genetics Consortium, I., et al., N Eng J Med 2014; 371: 2072), mirroring the clinical effects of therapeutic antagonism of these genes. Highly statistically significant associations were observed between heterozygous pLoF variants in APOB and reduced LDL-C and triglyceride levels among 58 pLoF carriers, recapitulating the effect of therapeutic antagonism with mipomersen, an antisense oligonucleotide to apo-B100 (Thomas G S, et al., J Am Coll Cardiol 2013; 62: 2178; Raal F J, et al., Lancet 2010; 375: 998).

Homozygous or compound heterozygous truncating mutations in APOB have been implicated in familial hypobetalipoproteinemia, characterized by profound depression of apoB-containing lipoproteins, including LDL-C and triglyceride-rich lipoproteins, and hepatic triglyceride accumulation (Welty F K, Curr Opin Lipidol 2014; 25: 161. Consistent with observed autosomal codominant transmission of clinical features of the disease, most commonly fatty liver, these results suggest that heterozygous carriers of such variants in the tested population also manifest an intermediate phenotype characterized by moderate depression of LDL-C and triglyceride levels. In contrast, 29 DiscovEHR participants who were heterozygous for predicted loss of function mutations in MTTP did not have lipid levels that were significantly different from non-carriers, suggesting that MTTP-associated abetalipoproteinemia segregates exclusively as a recessive trait in this study population.

A small number of heterozygous predicted loss of function mutations were observed in HMGCR (n=12 carriers), the gene encoding the target of HMG-coA reductase inhibitors (statins), and did not observe significantly different lipid levels among these carriers than non-carriers. This may be due to low power to detect modest associations with lipid levels, or a requirement for biallelic hypomorphic or loss of function alleles to impact lipid levels in humans.

Among unapproved drugs in late phase clinical trials, an association between pLoF variants was observed in CETP, encoding the target of anacetrapib (currently in Phase III clinical trials), and higher HDL-C (beta=0.82, p=2.9×10⁻⁶). Two of three genes encoding targets of therapeutic agents currently in Phase II clinical trials for lipid modification (APOC3, ANGPTL3) harbored pLoFs that were associated with lipid profiles recapitulating therapeutic effects. Nine heterozygotes for predicted loss of function variants in ACLY, a target gene of the ACLY-antagonist bempodoic acid in Phase II clinical trials for lipid lowering, had a trend towards lower LDL-C values (beta=−0.67, p=0.07).

Prevalence of Clinically Returnable Genetic Findings in 50,726 Exomes

All of the coding variants identified in the ACMG 56 recommended gene list (Consortium, U. K., et al., Nature 2015; 526: 82) and additional GHS 20 genes for returnable secondary findings were extracted. Those variants were cross-referenced with the ClinVar dataset [updated December 2015], restricting to those with a Pathogenic classification and a minor allele frequency of less than 1% in the GHS population. Also cross-referenced were the variants with the Human Gene Mutation Database [HGMD 2015.4], restricting to DM-Disease causing mutations of High-confidence variants only with a MAF<1%. The list of returnable variants was compiled according to the published guidelines for the genes where Expected Pathogenic (EP), comprising non-reported putative loss-of-function (pLoF), and/or Known Pathogenic (KP) variants are recommended for clinically actionable return of results (FIG. 21).

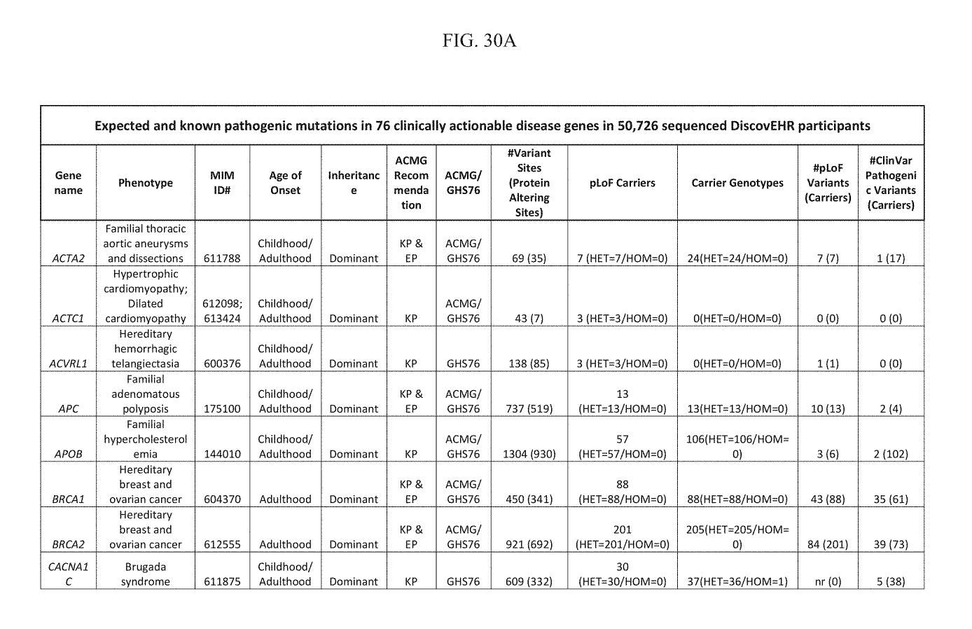

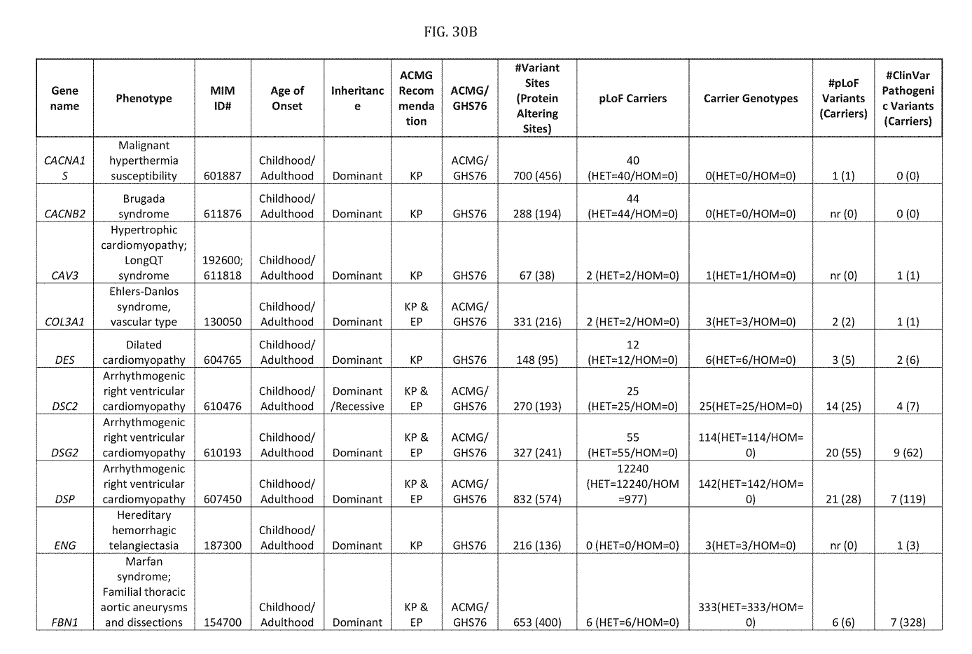

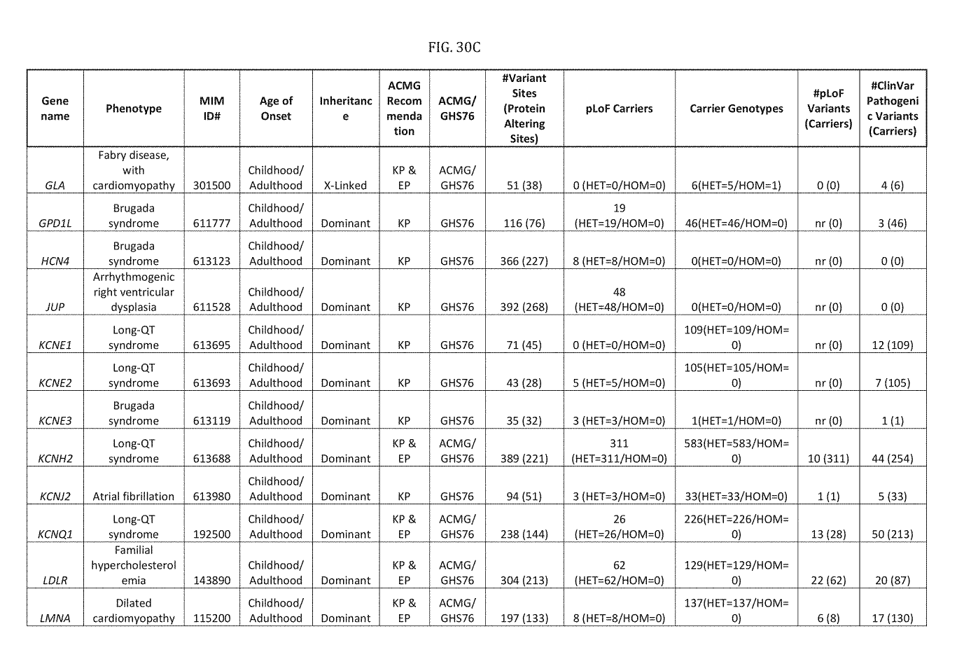

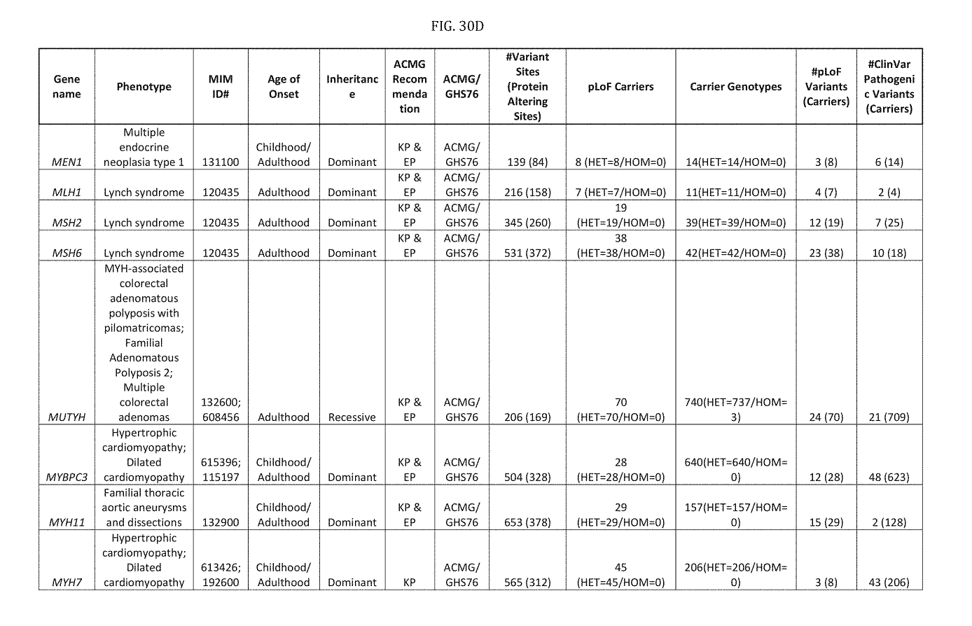

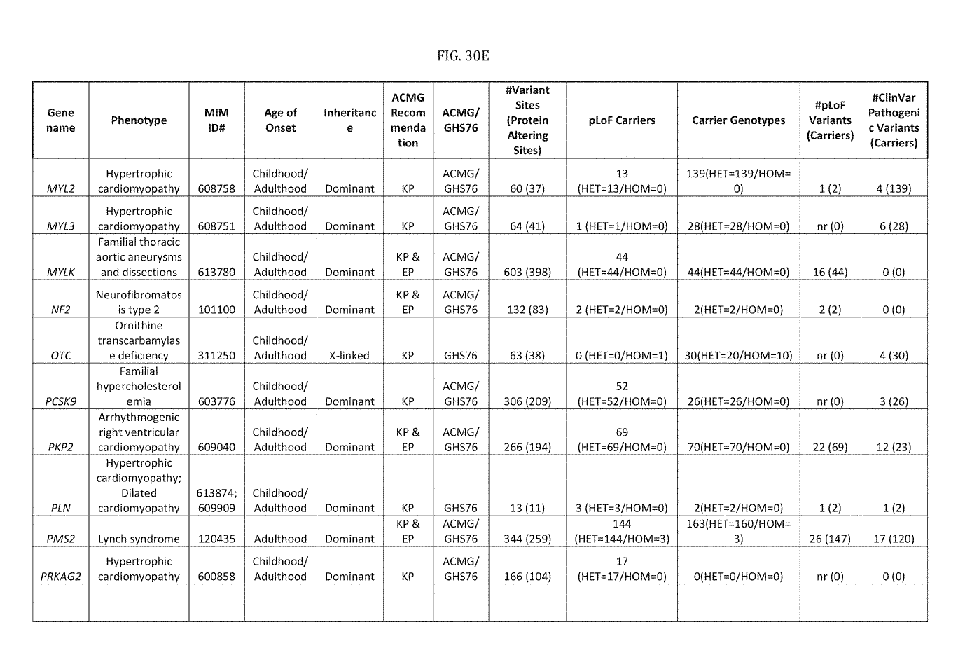

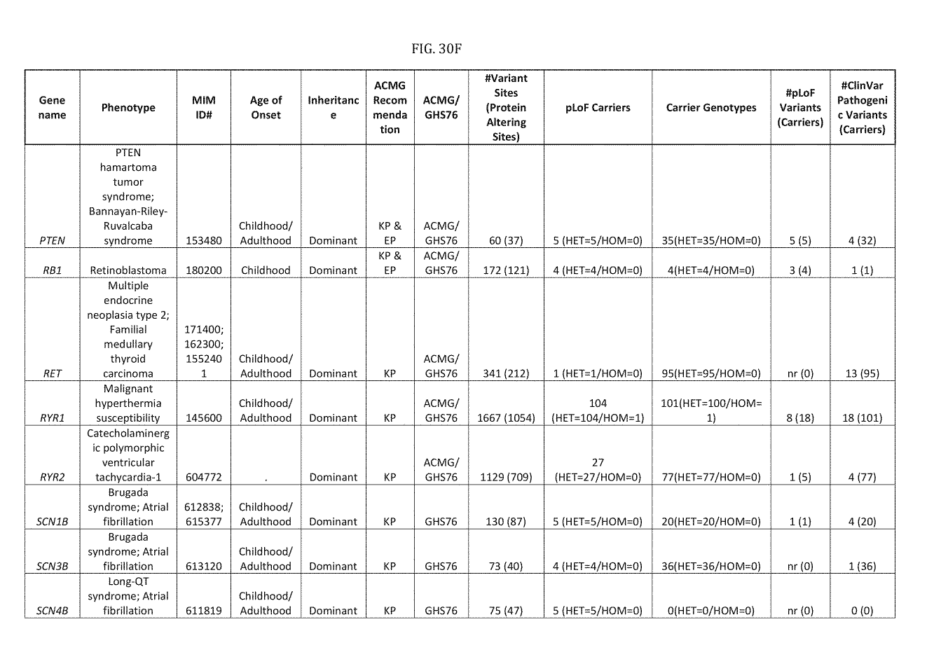

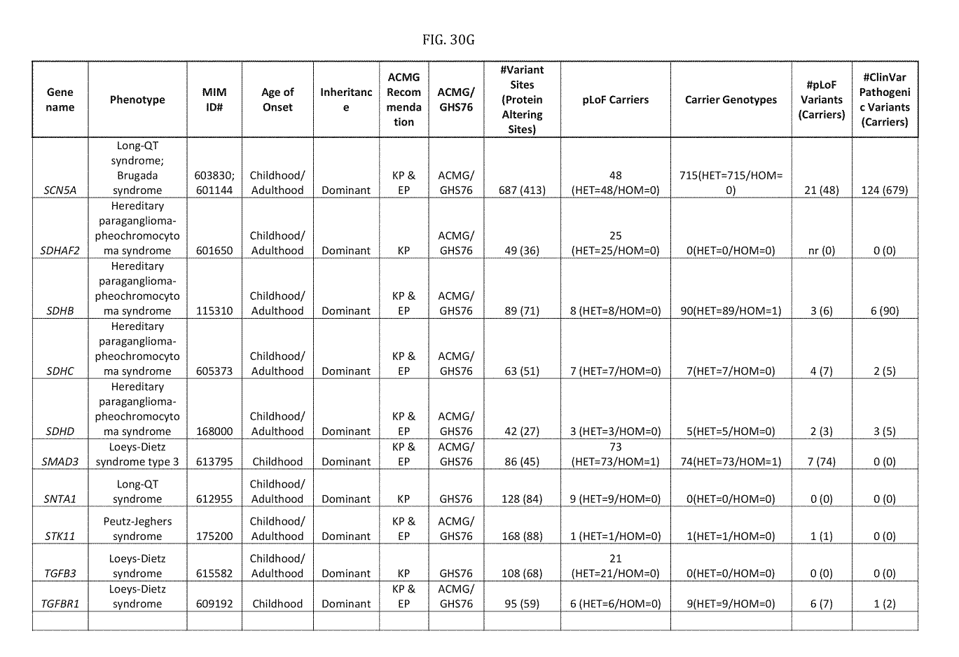

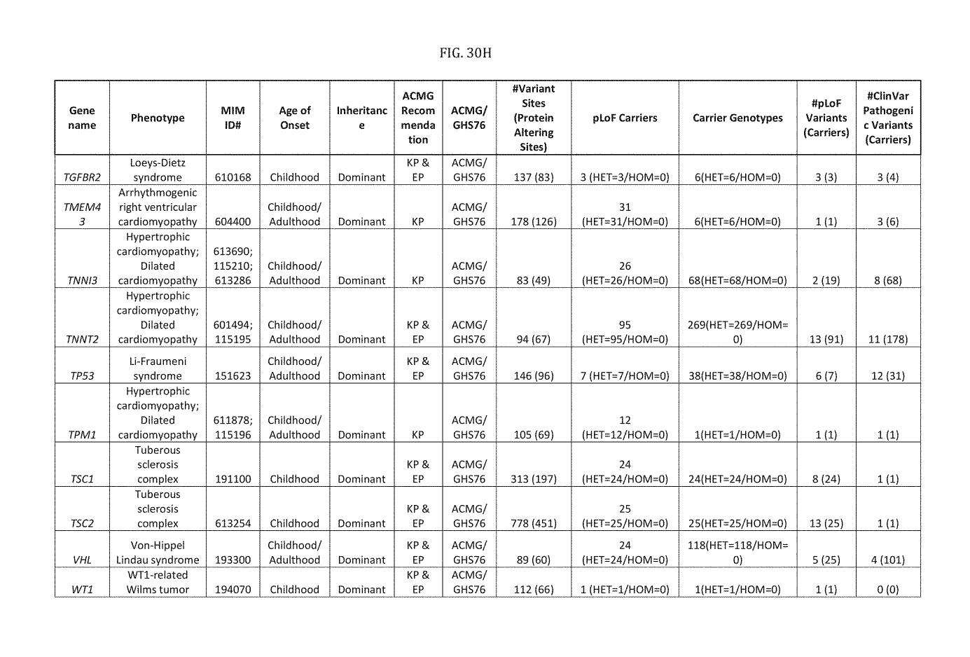

The availability of whole exome sequence data from a large number of appropriately consented patients of an integrated health system provides a unique opportunity to implement genomic information in patient care. Exome sequence data was analyzed to identify all potentially pathogenic variants, according to the ClinVar “pathogenic” classification (Landrum M J. et al., Nucleic Acids Res 2014; 42: D980), in a subset of 76 genes (G76) that when altered lead to clinically actionable findings for 27 medical conditions (FIG. 30A-H). The G76 is inclusive of the 56 genes recommended within the ACMG guidelines for identification and reporting of clinically actionable genetic findings, those 56 and the additional 20 genes were chosen on the basis of being associated with highly penetrant monogenic disease, as well as potential clinical actionability, defined as opportunities for either preventive measures or early therapeutic interventions to ameliorate pathologic features of the condition.

pLoF variants were identified in a subset of these genes in which loss of function variation is predicted to cause genetic disease (expected pathogenic) as recommended by the ACMG guidelines for identification and reporting of clinically actionable genetic findings (Green R C, et al., Genet Med 2013; 15: 565). In aggregate, approximately 13% of sequenced participants (6,653 individuals) harbored one or more such potentially pathogenic variants in this gene list: 5,435 individuals with at least one variant in these genes with a “pathogenic” assertion in ClinVar and 1,218 additional participants with predicted pathogenic LoF variants. A pilot set of 2,500 sequence files (4.9% of total) then underwent clinical curation, applying the standards from Richards et al. (Richards S, et al., Genet Med 2015; 17: 405) in order to identify pathogenic or likely pathogenic variants in the G76 within those files for potential return to clinical care. This curation will be followed by CLIA confirmation of the variant at a certified laboratory prior to return.

Within the pilot set, after bioinformatic filtration, 641 variants in the G76 were reviewed: 32 (5.0%) were considered “pathogenic”, 23 (3.6%) were considered “likely pathogenic”, and the remainder 586 (91.4%) were considered either variants of uncertain significance, likely benign, benign, or false positives. Variants that are classified as “pathogenic” or “likely pathogenic” and confirmed in a CLIA-certified molecular diagnostic laboratory are considered as eligible for return to patients and providers. It was estimated that 4.4% of study participants will receive such a clinical result from the G76 that meets or exceeds current clinical standards for asserting a prediction of pathogenicity, namely >90% certainty of the variant being disease causing (Richards S, et al., Genet Med 2015; 17: 405). These results highlight the persistent need for expert clinical review and curation of assertions of pathogenicity for variants cataloged in mutation databases, and establish an expectation for the burden of medically actionable genetic findings in a largely unselected clinical population.

Discussion

The findings discussed herein demonstrate the value of large-scale sequencing in a clinical population from an integrated health system, and add to the base of knowledge regarding human genetic variation. One of the main objectives of the program is to identify functional variants with large effects on disease related traits and those that are clinically and therapeutically actionable. To date, most large effect variants and known pathogenic alleles have been observed in the protein coding regions of the genome (Chong J X, et al., Am J Hum Genet 2015; 97: 199; Green R C, et al., Genet Med 2013; 15: 565; Choi M., et al., Proc Natl Acad Sci USA 2009; 106: 19096), and are enriched within rare alleles. These results on the profile of exonic variants in the DiscovEHR cohort are similar to those reported in previous large-scale sequencing projects (Genomes Project, C., et al., Nature 2010; 467: 1061; Chong J X, et al., Am J Hum Genet 2015; 97: 199; Genomes Project, C., et al., Nature 2012; 491: 56). As expected, the vast majority of exonic variation is rare.

Very large genomic variant databases are needed to identify rare variants with large effects on clinical traits of interest; such variants can be exceedingly rare due to purifying selection, but can be extremely informative in revealing novel biological mechanisms and identifying therapeutic targets. Each individual in the cohort harbored ˜20 rare predicted LoF variants in multiple genes. In aggregate, across all sequenced participants, approximately 92% of genes harbor rare heterozygous predicted LoF variants and 7% of genes harbor rare homozygous predicted LoF variants in at least one individual, providing a rich resource to study the phenotypic effects of partial and complete gene knockouts in humans.

Detecting associations and the effects of rare functional variants requires very large sample sizes. The value of a cohort, such as the DiscovEHR cohort for such analyses has been demonstrated herein by identifying multiple novel rare coding alleles associated with serum lipid traits in exome wide association analyses. The results reported herein constitute the largest exome sequencing study of serum lipids to date, and nominate a novel triglyceride-associated gene (G6PC) and multiple novel rare alleles in known lipid genes. Furthermore, a set of 11 genes whose products are the targets of lipid lowering drugs were studied, and the results show that the majority harbor pLoF variants whose effects on serum lipids are consistent with the established pharmacologic effects of these drugs. These analyses demonstrate the utility of this resource to both identify novel large effect variants for phenotypes of interest, as well as the ability to interrogate gene centric hypothesis around specific phenotypic associations.

Another advantage of a cohort, such as the DiscovEHR cohort, is the large number of familial relationships, including multi-generation pedigrees, which are a result of a stable patient population receiving health care from an integrated regional health system. This makes it is possible to conduct population-based or family-based studies, as appropriate.

The DiscovEHR cohort is one non-limiting example of a cohort of subjects from which genetic variant and phenotypic data can be obtained to practice the present methods and systems.

### Example 2

Copy Number Variation Study

Structural variation, in addition to single nucleotide variation (SNVs) and small indels, encompasses the spectrum of genomic variation that can be identified in a given individual and interrogated for potential phenotypic consequences. Copy-number variants (CNVs) are a type of structural variation defined as regions in the genome that deviate in their number of copies from the expected normal diploid state through deletion or amplification. Unlike other structural variants such as inversions, CNVs are amenable for direct ascertainment through a variety of methods that can accurately estimate the number of copies present in the genome for a particular locus (0, 1, 2, >2). In addition, gene disruption or dosage change through deletion or duplication of coding regions can have significant phenotypic consequences as evidenced by the identification of multiple genomic disorders caused by rearrangements of the genome (Lupski J R, Environ Mol Multagen 2015; doi: 10.1002/em.21943). Copy number variation has been extensively studied in the context of neurodevelopmental disorders and Mendelian disease, but its role in the etiology of common disease remains largely unclear (Zhang F, et al., Annu Rev Genomics Hum Genet 2009; 10:451).

A handful of common CNVs have been associated with disease—CFHR deletions are protective against age-related macular degeneration (Hughes A E, et al., Nat Genet 2006; 38: 1173) and LCE3 deletions increase susceptibility to psoriasis (de Cid R, et al., Nat Genet 2009; 41: 211-5)—but previous studies have concluded that in aggregate, common CNVs do not contribute greatly to the genetic basis of disease (Conrad D F, et al., Nature 2010; 464: 704; Wellcome Trust Case Control Consortium, et al., Nature 2010; 464: 713).

Several rare variants with incomplete penetrance for neurodevelopmental disorders have been identified, including variants at 1q21.1 (Mefford H C, et al., N Engl J Med 2008; 359: 1685), 15q13.3 (van bon B W, et al. J Med Genet 2009; 46: 511), 16p11.2 (McCarthy S E, et al., Nat Genet 2009; 41: 1223) and 16p12.1 (Girirajan S, et al., Nat Genet 2010; 42: 203). However, while large-scale association studies have examined the role of rare SNVs on common diseases and complex traits (e.g. lipid levels; Surakka et al., 2015), these surveys have not been performed on CNVs.

The wide application of genomic sequencing (either through exome or whole genome) has made the calling of copy number variants an important and necessary part of modern human re-sequencing pipelines. Few population surveys of CNVs have been performed using genomic sequencing data (Korbel et al, Science 2007; 318: 420; Mills et al., 2011); therefore the catalogue of human copy-number variation across different sizes and allelic frequencies remains incomplete. Several algorithms have been developed to identify CNVs from sequencing data, these usually vary in their sensitivity and specificity, favoring one over the other and having restrictions in the size and frequency spectrum at which they can detect an event.

In this study, CLAMMS (Packer J S, et al., Bioinformatics 2015; 32: 133) was used to compile a catalog of rare and common CNVs in 50,726 exomes sampled from study participants who are patients of the Geisinger Health System. Additionally, an exome-wide survey of CNV burden on genes was performed to analyze high-level characteristics of CNVs and their propensity to cause genetic loss-of-function. In the process of generating these datasets, an automated CNV-calling pipeline and novel quality-control procedures were developed that were used to construct a catalog of CNV allele frequencies and a CNV-SNV linkage map that are provided as resources for the genomics community. To illustrate the potential for novel phenotypic association discovery using these variants, association analyses was performed on lipid profiles extracted from the EHR and examined penetrance of lipid-associated CNVs to coronary heart disease.

Primary Sequence Analysis, CNV Calling, and Quality Control

In this study, demographic information and quantitative serum lipid data from laboratory tests from the population discussed in Example 1 above, and the sequence information obtained in Example 1 were used to perform association analyses, demonstrating the utility provided by CNVs and the feasibility of incorporating them into association studies with clinical data.

All samples were prepared and sequenced using consistent procedures prior to calling CNVs from read depths with CLAMMS (Packer J S, et al., Bioinformatics 2016; 32: 133), an efficient algorithm that was previously developed to call exome CNVs of any allele frequency at population scale. Quality control procedures used herein integrate two model-based quality metrics (Q_{non-dip} and Q_{exact}) as well as information on the allele balance and zygosity of SNPs within called CNVs.

Regarding filtering criteria for CLAMMS CNV calls, deletions must have Q_non_dip>=50 and Q_exact>=0.5. Duplications must have Q_non_dip>=50 and Q_exact>=−1.0. Q_non_dip is the Phred-scaled probability of any part of the called CNV region being non-diploid under the CLAMMS model. In practice, many regions are inconsistent with the model for diploid state but not necessarily consistent with the model for the CNV as called. Q_exact is a measure (not Phred-scaled) of how consistent coverage in a CNV region is with the exact claimed copy number state and breakpoints. It is a new feature added to CLAMMS since the algorithm's publication.

Deletions must satisfy at least one of two additional criteria: 1) Q_non_dip>=100 and Q_exact>=1.0, or 2) no heterozygous SNPs and at least one homozygous SNP are called in the CNV region. Duplications must satisfy at least one of two additional criteria: 1) Q_non_dip>=100 and Q_exact>=−0.5, or 2) at least one heterozygous SNP is called in the CNV region and the average allele balance across all heterozygous SNPs in the region is in the range [0.611, 0.723], corresponding to the 15^{th} and 85^{th} percentiles of inlier duplication calls. The “allele balance” of a SNP is defined as being equal to max(# reads supporting REF, # reads supporting ALT)/total # reads.

For each CNV call, the set of CNV calls from other samples in this study which overlap it by at least 90% (reciprocal) was identified. Deletions were filtered if [total # of homozygous SNPs called within this set of CNVs+5]/[total # of SNPs called within this set of CNVs+5]<0.9 and the average allele balance of heterozygous SNPs called within this set of CNVs is <0.8. Allele balances >0.8 usually indicate a miscalled homozygous SNP in a low-coverage region. Duplications were filtered if the total # of heterozygous SNPs called within this set of CNVs is >=3 and their average allele balance is <0.611.

The sample a CNV is in must have <=28 calls total (=2× the median). Such samples are denoted “inliers.” Samples with a number of calls in [29, 280] are denoted “outliers,” and samples with >280 calls are denoted “extreme outliers.” For each CNV call, the set of CNV calls in inliers and the set of CNV calls in non-extreme outliers that overlap it by at least 33.3% (reciprocal) were identified. The call was filtered if 2*[# overlapping calls in inliers]<[# overlapping calls in outliers]−1. In effect, this procedure identifies “problem regions” within samples that are otherwise high-quality. Without being bound by theory, it is hypothesized that outlier samples are indicative of degraded DNA.

For example, heterozygous SNPs cannot occur in true heterozygously deleted (hemizygous) regions. Samples in which excessive numbers of CNVs were produced often exhibit very low transmission rates and were filtered from the high-confidence call set. Some cases have valid biological reasons for high CNV calls rates (e.g. somatic variation in cancer samples), while others may be outliers in sequencing quality that do not normalize properly relative to their reference panel.

For implementation of an automated pipeline for CNV calling and quality control, depth-of-coverage is computed for each sample using Samtools (Li H and Durbin R, Bioinformatics 2009; 25:1754; Li H, et al., Bioinformatics 2009; 15: 2078), including only reads with mapping quality >=30. Seven sequencing quality control metrics are computed for each sample using Picard: GC_DROPOUT, AT_DROPOUT, MEAN_INSERT_SIZE, ON_BAIT_VS_SELECTED, PCT_PF_UQ_READS, PCT_TARGET_BASES_10, and PCT_TARGET_BASES_50X. These two tasks are conducted in parallel for each sample.

A k-d tree in this metric space is used to index the first N samples processed, as described in the Supplement of Packer J S, et al., Bioinformatics 2015; 32: 133. After this index has been constructed, each of the N samples and each subsequent sample are processed in parallel. For each sample, a copy of the k-d tree index is downloaded. The k-d tree is used to identify the sample's m (=100) nearest neighbors in the sequencing QC metric space. The coverage files for these m samples are downloaded. CNVs are called for the sample using CLAMMS (Packer J S, et al., Bioinformatics 2015: 32: 133), which takes the coverage file for the sample in question plus the coverage files for the m-sample reference panel as input. The VCF file for the sample's SNP calls (generated in a separate process using GATK best-practices) is then downloaded. The VCF file is used to annotate each CNV call with three statistics: the number of SNPs called within the CNV's putative breakpoints, the number of those SNPs that are homozygous, and the mean allele balance of heterozygous SNPs within the CNV, as defined immediately below.

The LDLR duplication carrier pedigrees are all distantly related to one another. Although the true family history of these de-identified individuals is not known, PRIMUS (Staples J, et al., Am J Hum Genet 2014; 95: 553) was used to reconstruct pedigrees and ERSA (Huff C D, et al., Genome Res 2011; 21: 768) distant relationship predictions to estimate the best pedigree representation of these carriers shared ancestry. PRIMUS used HumanOmniExpress array data (or whole-exome sequencing data for whom the array data was unavailable) to estimate first- through third-degree relationships and reconstruct the corresponding sub-pedigrees. The more distant relationships connecting the sub-pedigrees were calculated by ERSA using available the HumanOmniExpress chip data for the sequenced samples. ERSA caps the distant relationship predictions at ninth-degree, giving us a lower bound for the most recent common ancestor for all LDLR duplication carriers. Two duplication carriers estimated to be second-degree relatives to each other did not contain array data, so it could not be verified that they are distantly related to the other carriers. The remaining seven carriers not represented in this pedigree are predicted to be seventh- to ninth-degree relatives to one or more carriers in this pedigree, but were not drawn so as to not clutter the figure. It is estimated that the founder carrier and common ancestor dates back at least six generations. Assuming an average of 25 years for each generation, it is predicted that the duplication occurred at least 150 years ago.

Finally, the quality control procedures described immediately above are applied to label each CNV call as high or low confidence. QC procedures that are based on average statistics for a particular CNV locus use statistics computed for the first N samples, which are compiled into a file that is downloaded by each parallel computing instance. The allows fully quality-controlled CNVs to be called for a sample as its data comes off the sequencer. When a batch of samples has been processed and is ready for analysis, the QC procedures may optionally be rerun to use aggregate statistics for that batch instead of the first N samples.

In total, 6.66% of samples were not considered in this analysis, yielding a high-confidence call set representing 47,349 individuals. CLAMMS focuses on exons where read coverage is expected to be consistent and predictable (e.g. non-extreme GC content and sequence polymorphism rates, high mappability, etc.; see Packer J S, et al., Bioinformatics 2015; 32: 133), representing 88% of all targeted exons. As discussed above, it is described herein how CLAMMS was used to implement an automated pipeline for CNV calling and quality control.

Several filters were applied to the raw set of CLAMMS CNV calls (discussed above) These filters consider the consistency of a sample's coverage profile in a called CNV region with the CLAMMS statistical model, information on the allele balance and zygosity of SNPs in the region, and coverage and SNP info for CNVs in other samples with approximately the same breakpoints. When designing the filters, the goal was to achieve the maximum sensitivity possible while maintaining a transmission rate of ˜47.5% for rare variants, reflecting an estimated false positive rate of ˜5%. This goal was achieved using a somewhat complex set of filtering criteria. To ensure that these criteria do not overfit the data, they were trained based on transmission rates in the first ˜30,000 samples sequenced and evaluated them on the next ˜20,000 samples. Transmission rates were slightly lower in the test set than in the training set, but not so much as to suggest gross overfitting (Table 6).

TABLE 6
Transmission rates in the QC training and test sets

| | | | Combined T- |
|---|---|---|---|
| | Training T-rate | Test T-rate | rate |
| CNV Subset | (sample size) | (sample size) | (sample size) |
| Heterozygous, AF <1% | 47.36% | 46.02% | 46.59% |
| | (3,913) | (5,198) | (9,111) |
| CN = 1, AF <1% | 48.01% | 45.76% | 46.74% |
| | (1,610) | (2,087) | (3,697) |
| CN = 3, AF <1% | 46.90% | 46.19% | 46.49% |
| | (2,303) | (3,111) | (5,414) |
| Heterozygous, | 42.26% | 42.10% | 42.17% |
| AF <1%, <=3 exons | (1,273) | (1,684) | (2,957) |
| CN = 1, | 43.79% | 42.48% | 43.05% |
| AF <1%, <=3 exons | (612) | (791) | (1,403) |
| CN = 3, | 40.84% | 41.77% | 41.38% |
| AF <1%, <=3 exons | (661) | (893) | (1,554) |
| Heterozygous, | 37.85% | 39.81% | 38.96% |
| AF <1%, 1 exon | (251) | (324) | (575) |
| CN = 1, | 36.64% | 42.77% | 40.07% |
| AF <1%, 1 exon | (131) | (166) | (297) |
| CN = 3, | 39.17% | 36.71% | 37.77% |
| AF <1%, 1 exon | (120) | (158) | (278) |

Transmission Rate Analysis

Pedigrees reconstructed from the exome data using PRIMUS (Staples J, et al., Am J Hum Genet 2014: 95: 553) identified 6,527 parent-child duos. Parents were distinguished from children based on their age as listed in the medical records. A putative CNV is defined as being transmitted from a parent to a child if the child has a call that overlaps at least 50%, of the call in the parent. For rare variants heterozygous in one parent, the probability of the child's other parent having the same variant is small, so the expected probability of transmission is ˜50%. Since common variants are more likely to have ambiguous parental origins (particularly when only one parent is sequenced), the transmission rate analysis was focused on rare variants having observed allele frequency <1%.

Association Analyses and Phenotype Data

Quantitative associations between CNV loci and lipid traits were performed using a linear mixed model implemented in BOLT-LMM (Loh P R, et al., Nature 2015; 47: 284) with a genetic relationship matrix (estimated using 200 common SNPs rather than CNV data) included as a random effect. This is the first implementation of a CNV association analysis using linear mixed models to ensure that relatedness in the data is appropriately accounted for in assessment of significance. Deletions and duplications at the same locus were considered separately.

Median values for serially measured laboratory traits, including total cholesterol, low-density lipoprotein cholesterol (LDL-C), high-density lipoprotein cholesterol (HDL-C) and triglycerides were calculated for all individuals with two or more measurements in the EHR following removal of likely spurious values that were >3 standard deviations from the intra-individual median value. For the purposes of exome-wide association analysis of serum lipid levels, total cholesterol and LDL-C were adjusted for lipid-altering medication use by dividing by 0.8 and 0.7, respectively, to estimate pre-treatment lipid values based on the average reduction in LDL-C and total cholesterol for the average statin dose. HDL-C and triglyceride values were not adjusted for lipid-altering medication use. HDL-C and triglycerides were log₁₀ transformed, and medication-adjusted LDL-C and total cholesterol values were not transformed. Trait residuals were then calculated after adjustment for age, age², sex, and the first ten principal components of ancestry, and rank-inverse-normal transformed these residuals prior to exome-wide association analysis. Ischemic Heart Disease (IHD) status was defined using International Classification of Diseases, Ninth Edition (ICD-9) diagnosis codes 410-414. ICD-9 based diagnoses required one or more of the following: a problem list entry of the diagnosis code or an encounter diagnosis code entered for two separate encounters on separate calendar days.

Whole-Genome Sequencing and Breakpoint Validation of LDLR Duplication and HMGCR-Spanning Duplication-Deletion-Duplication Observed in GCNT4 and SV2C

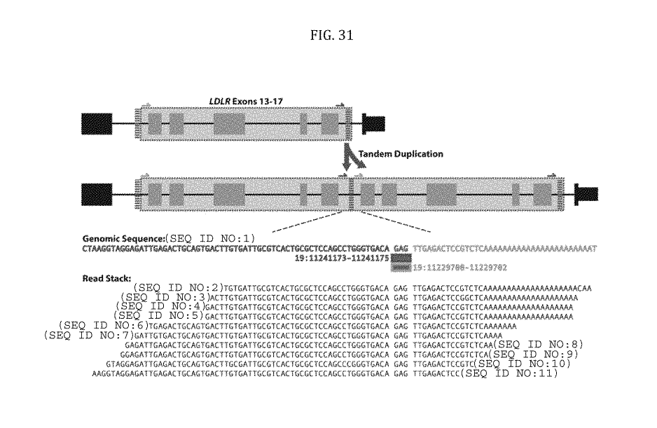

500 ng of genomic DNA was sheared to an average size of 160 bp on a Covaris LE220 and prepared for Illumina sequencing using a custom library preparation kit from Kapa Biosystems. The samples were sequenced to an average depth of 30× using v4 Illumina HiSeq 2500s with paired-end 75 base pair reads. Raw reads were processed using the same methods as utilized for the exome sequencing data. Pindel (Ye K, et al., Bioinformatics 2009; 25: 2865-71) and LUMPY (Layer R M et al., Genome Biol 2014; 15: R84) were used in combination to call structural variants genome-wide, both methods independently confirmed the LDLR duplication breakpoints (FIG. 31).

Whole-genome sequencing of one LDLR duplication carrier confirms the duplication of exons 13-17. Discordant mapping read-pairs and split-read alignments locate the breakpoint and insertion loci as chr19:11229700 and chr19:11241173, with a three nucleotide microhomology (green) shared at both loci. Both the breakpoint and insertion loci occur in Alu repeat sequences. The predicted protein translation is in-frame. The novel breakpoint-spanning sequence was confirmed in additional carriers using Sanger sequencing.

For the HMGCR-spanning dup-del-dup variant, Pindel identified the tandem duplication only while LUMPY identified the deletion only. Discordantly mapping mate pairs and split read alignments were manually analyzed to verify breakpoints and identify associated microhomology sequences.

Sanger Confirmation of LDLR Duplication

A ˜500 bp DNA fragment encompassing the LDLR CNV breakpoint was amplified from genomic DNA using Kapa HiFi polymerase. Amplification was performed with 25 ul of 2× Kapa HiFi PCR Master Mix, primers LDLR-CNV-F (5′-CATGTGATCCCAGAACTTGG-3′; SEQ ID NO:27) and LDLR-CNV-R (5′-ACCATCTCGACTATTTGTGAGTGC-3′; SEQ ID NO:28), 5 ul of PCRx enhancer (Invitrogen), 50 ng of genomic DNA, and water to a total volume of 50 ul. The PCR reaction conditions were: 95° C. for 3 min, followed by 30 cycles of 98° C. for 20 sec, 62° C. for 15 sec, and 72° C. for 1 min, with a final extension of 72° C. for 5 min. Sanger sequencing was performed at the Regeneron DNA Core with the forward primer only.

A Catalog of Copy Number Variants from a Large Health System Population

Common and rare CNVs were called for each exome based on read depths using CLAMMS (Packer J S, et al., Bioinformatics 2015; 32: 133), a method developed and previously reported, that is sensitive to CNVs of any allele frequency with resolution down to a single exon. Extensive quality control procedures were performed on called CNVs, integrating information from SNPs in CNV loci (allele balance and zygosity) and training CNV confidence filters based on transmission rates in parent-child duos identified with PRIMUS (Staples J, et al., Am J Hum Genet 2014; 95: 553), a pedigree reconstruction tool based on estimates of identity by descent. These pedigrees include 6,527 parent-child duos. Parents and children were distinguished using ages recorded in the EHR. Training procedures focused on transmission rates for rare (MAF<1%) heterozygous CNV calls; these rare CNVs are less likely to also be present and inherited from a parent for which genetic data is absent. The ideal transmission rate in the training set is therefore close to 50%, under the assumption that de novo exonic structural variants are rare (Kloosterman W P, et al., Genome Res 2015; 25: 792-801. Transmission rates of less than 50% result from both false positives in parents and false negatives in children. The results of this high-confidence CNV call set that includes 47,349 samples (˜93%) and 475,664 events at 13,782 loci (see Table 7) are reported.

TABLE 7
Exome-wide CNV statistics for the high-confidence CNV call set
including 47,349 individuals passing strict QC criteria

| | | |
|---|---|---|
| Total # CNVs | # Duplications | # Deletions |

CNV Frequency

| | | | |
|---|---|---|---|
| Total | 475664 | 130247 | 345417 |
| Very Rare (AF <0.1%) | 47170 | 28580 | 18590 |
| Rare (AF = [0.1-1%]) | 35850 | 22530 | 13320 |
| Common (AF > 1%) | 392644 | 79137 | 313507 |

Sample Means

| | | | |
|---|---|---|---|
| Total | 10.05 | 2.75 | 7.30 |
| Very Rare (AF <0.1%) | 1.00 | 0.60 | 0.39 |
| Rare (AF = [0.1-1%]) | 0.76 | 0.48 | 0.28 |
| Common (AF >1%) | 8.29 | 1.67 | 6.62 |

Locus Frequency

| | | | |
|---|---|---|---|
| Total | 13782 | 7680 | 6102 |
| Very Rare (AF <0.1%) | 13582 | 7563 | 6019 |
| Rare (AF = [0.1-1%]) | 142 | 89 | 53 |
| Common (AF >1%) | 58 | 28 | 30 |

Locus Median Size (kb)

| | | | |
|---|---|---|---|
| Total | 17.7 | 32.5 | 8.4 |
| Very Rare (AF <0.1%) | 17.9 | 33.0 | 8.4 |
| Rare (AF = [0.1-1%]) | 12.6 | 13.4 | 9.0 |
| Common (AF >1%) | 7.1 | 13.4 | 4.4 |
| Single-gene Locus | 8377 | 3970 | 4407 |
| Multi-gene Locus | 5180 | 3622 | 1558 |
| # Genes Covered* | 13170 | 11066 | 6492 |
| # with Overlapping | | 957 | 945 |
| Reciprocal Locus | | | |

*out of 18,046 Ensembl75 unfiltered genes with VCRome targets, only considering CNVs <2 Mb.

An average of 1.76 rare high-confidence CNVs are called per sample with an expected transmission rate of 46.59%. These include an average of 0.54 small (<=3 exon) rare variants per sample, with an expected transmission rate of 42.17%.

As described above, the CNV catalog also includes common variants (MAF>1%); an average of 6.6 deletions and 1.7 duplications were observed per sample. Common CNV genotypes for a subset of these samples were previously validated using TAQMAN® qPCR with only a 1% false positive rate of the validated variants (Packer J S, et al., Bioinformatics 2015; 32: 133). For the full set of samples, mean and median false negative rate for heterozygous deletions at 29 common-variant loci were estimated to be 8.5% and 1.1% respectively (based on expectations given Hardy-Weinberg equilibrium and the number of homozygous deletions).

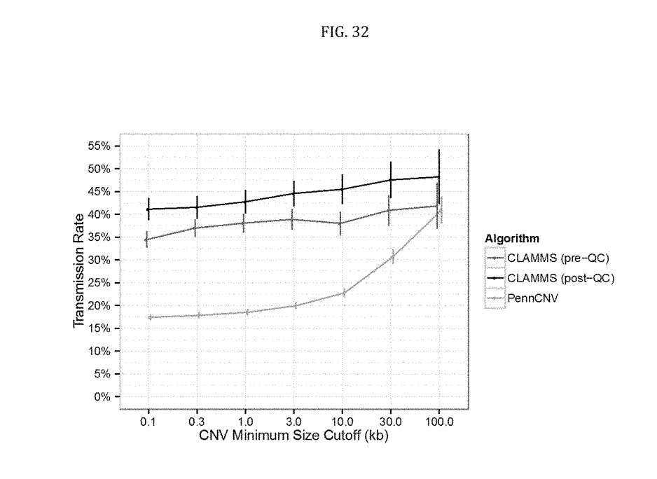

A comparison of the CNV catalog herein to previous reports was attempted, but no directly comparable call sets were found. Very few of the CNV loci can be found in existing CNV databases. For example, only 386 of the CNVs (<3%; 13 common, 22 rare, and 351 very rare loci with median size of ˜50 Kb) have a counterpart (20% reciprocal overlap criteria) in The Database of Genomic Variants (MacDonald J R, et al., Nucleic Acids Research 2013; 42: D986). Although many of the CNVs observed herein are rare and unlikely to have been observed before, existing datasets have been compiled from a variety of studies, most of which have used array-based platforms, such as array comparative genomic hybridization (aCGH) or SNP chips. However, the majority of these studies fail to identify CNVs in the lower size spectrum due to the limitations of the array technologies (e.g. probe density). As confirmed with the data herein, chip-based CNV calls have poor reproducibility below ˜50 Kb (Pinto et al, Nature Biotechnology 2011; 29; 512; see FIG. 32), while even high-density aCGH approaches cannot reliably identify CNVs below a ˜5 Kb size range.

CLAMMS produces CNVs with high transmission rates at any size threshold down to a single exon, and the QC filters are not heavily biased by CNV size. PennCNV, however, cannot make high quality calls (i.e. high transmission rates) on small loci due to the resolution of markers on the SNP arrays. A “post-QC” PennCNV call set would essentially apply a minimum size filter, which is reflected on the x-axis. The average number of genes affected by a CNV using a high-confidence size cutoff of 100 Kb for PennCNV is ˜3.2 genes per individual (2.6 from duplications, 0.7 from deletions). For CLAMMS, the high-confidence call set yields ˜14.2 genes per individual affected by a CNV (4.5 by duplications, 9.7 by deletions).

Outside of CLAMMS, other exome sequencing-based calling methods do not produce calls for common variants as they rely on normalization of read depths using dimensionality reduction techniques (e.g. PCA) across the sample cohort. This approach also limits their scalability as normalization becomes computationally limiting on large numbers of samples. Thus, previous sequencing-based CNV surveys (both whole-genome and whole-exome) have involved much smaller sample numbers.

CNVs Related to Mendelian Disease Phenotypes

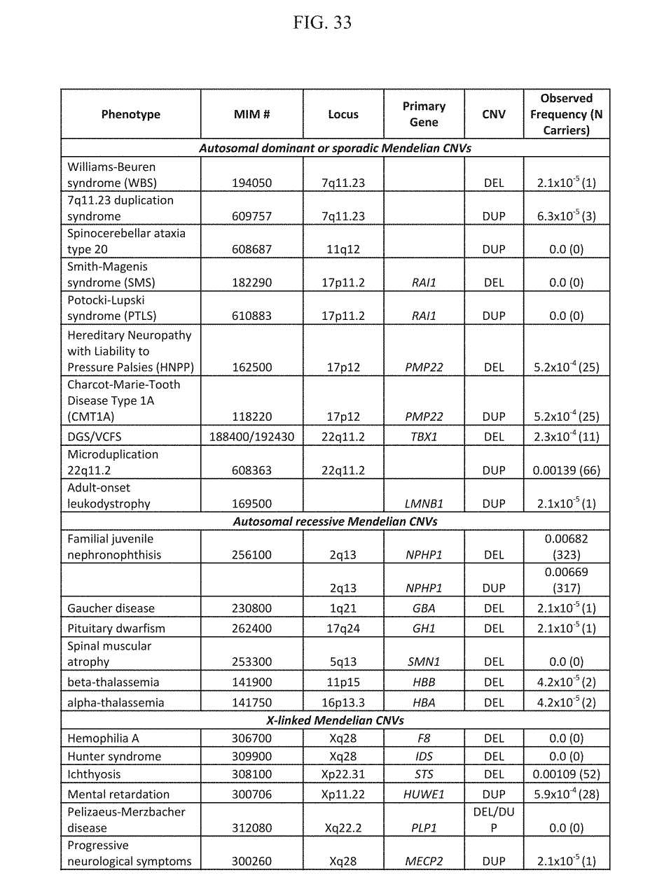

To demonstrate the relevance of the results herein to loci implicated in Mendelian traits, the observed frequencies of a set of known disease-associated CNVs in this population are set forth in FIG. 33.

While this population does not represent a true control set, the observed frequencies may represent the spectrum of coding copy-number variants expected in a broad, predominately European population outside of neuropsychiatric disease cohorts from which many catalogued CNVs have been ascertained. As this is the first large-scale exome CNV call set that represents a broad spectrum of sizes (from single exon CNVs up to ˜1 Mb), this resource provides the opportunity to refine estimates of penetrance for Mendelian CNVs.

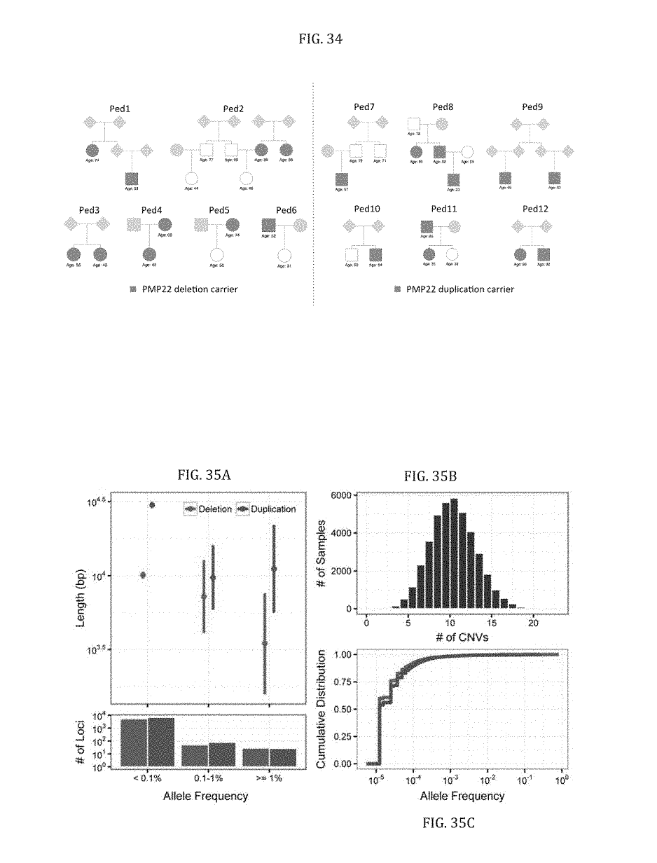

For example, 25 carriers of the 17p11.2 duplication that encompasses the dosage sensitive gene PMP22 and associates with the most common form of peripheral neuropathy, Charcot-Marie-Tooth disease type 1A (CMT1A; MIM #118220) (Lupski, J. R., et al., Cell 1991; 66: 219; Hoogendijk J E, et al. Lancet 1992, 339: 1081; DiVincenzo C, et al., Mol Genet Genomic Med 2014; 2: 522) were found. Similarly, 25 carriers of the reciprocal deletion associated with hereditary neuropathy with liability to pressure palsies (HNPP; MIM #162500) (Chance P F, et al., Cell 1993; 72: 143; Chance P F, et al., Hum Mol Genet 1994; 3:223) were identified. Relative to the population prevalence of the disease previously estimated at 1/2,500 (Skre, H., Clin. Genet. 1974; 6: 98), the observed frequency for the CMT-associated duplication alone is higher (5.2×10⁻⁴). Moreover, an equal number of deletion carriers (MAF=5.2×10⁻⁴) were identified, much higher than the reported frequency of 16/100,000 from epidemiological studies (Meretoja P, et al., Neuromuscul Disord 1997; 7:529). The observations herein confirm that HNPP as a clinical entity and its molecular cause, the 17p11.2 deletion including PMP22, have been historically under-diagnosed as it has been found herein that both deletions and duplications with equal frequency. To understand the structure of relationships in these carriers pedigree reconstruction and distant-relatedness analysis was performed, and it was found that there are a variety of pedigrees showing transmission of the PMP22 CNVs (FIG. 34), but no common ancestor is identified to link these carriers.

There is relationship estimation evidence that the PMP22 duplication carriers in Ped8 and Ped10 may have inherited the PMP22 duplication from a common ancestor ˜4 generations ago. Similarly, there is relationship estimation evidence that deletion carriers in Ped3 and Ped4 may have inherited the deletion from a common ancestor ˜4 generations ago. However, there is no relationship estimation evidence that any of the other duplication or deletion carriers inherited the PMP22 CNV from a common ancestor. This supports the hypothesis that there were multiple de novo CNV events with relatively equal frequency observed in this population.

This suggests that while transmission of PMP22 duplications and deletions was observed herein, the majority of these genomic rearrangements likely arose independently in these families as de novo events, consistent with the observation that 70-80% of sporadic cases of CMT1A due to the 17p11.2 duplication occur de novo (Szigeti K and Lupski J R, Eur J Hum Genet 2009; 17: 703). Using the number of independent pedigrees and individuals to estimate the relative frequency of de novo duplications and deletions, the frequency remains roughly equal between event types (19 duplications, 21 deletions; de novo MAF=4.01×10⁻⁴ and 4.44×10⁻⁴ respectively). The duplication CNV frequency is consequently the same as the population prevalence estimate for the disease (1/2,500), however higher than the de novo sperm-based estimated frequency ranging from 1/23,000 to 1/79,000 (Turner D J, et al., Nat Genet 2008; 40: 90). Importantly, because the majority of these CNV rearrangements occur sporadically in patients with a neuropathy phenotype, there are no SNVs that tag these variants. Consequently, genotype-phenotype associations cannot be identified via common variant association studies. This may hold true for other phenotypes beyond neuropathy, including common and complex traits, highlighting the importance of identifying CNVs as discrete markers and exploring phenotype associations independently of or in combination with SNVs.

Variation in the Vast Majority of Distinct Exonic CNV Loci is Extremely Rare

A set of distinct CNV loci was defined by recursively merging CNVs of the same type (deletion or duplication) with at least 50% reciprocal overlap. FIGS. 35A, B, and C shows the distributions of CNV loci relative to size, allele frequency (AF), and expected number per individual. Table 7 includes exome-wide statistics of the CNV call set. The vast majority (91%, FIG. 35C) of distinct CNV loci have AF<0.01% in this population (<10 carriers), with over half representing CNVs unique to a single sample in this cohort.

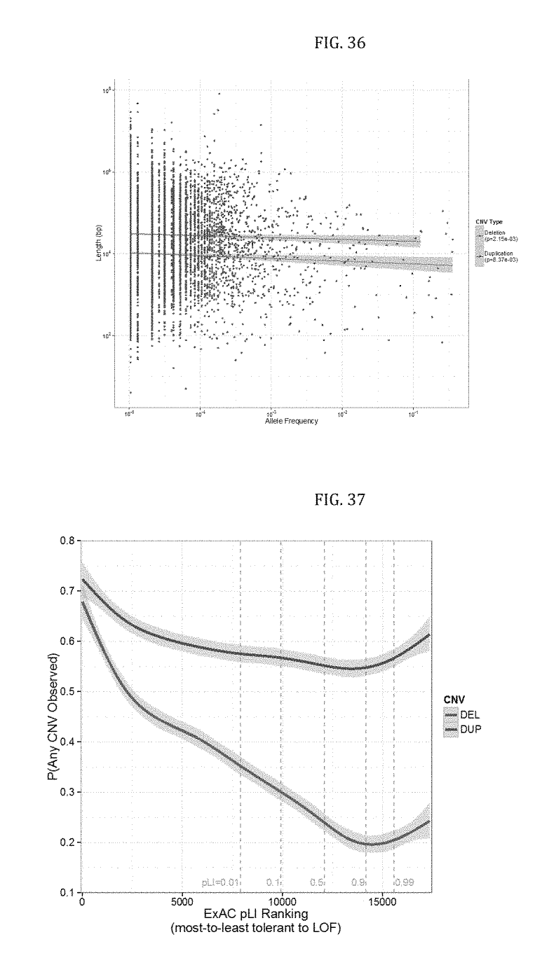

The median size of observed common CNV loci (AF>=1%) is 7.1 kb (deletions 4.4 kb, duplications 13.4 kb). The median size of observed rare CNV loci (AF<1%) is 17.8 kb (deletions 8.4 kb, duplications 32.7 kb). A negative log-linear correlation was observed between CNV length and allele frequency for both deletions and duplications (FIG. 35A; p=2.93×10⁻³ for deletions, p=2.07×10⁻² for duplications; see FIG. 36). 170/431 (39%) deletion loci with allele count >=10 have at least one overlapping duplication (50% reciprocal overlap criterion) observed in the cohort. Deletion loci with an observed overlapping duplication have a larger median size than those without (18.3 kb vs. 7.4 kb), while duplication loci with an observed overlapping deletion have a smaller median size than those without (20.2 kb vs. 34.7 kb). Paired low-copy repeats were identified in direct orientation flanking the estimated exonic breakpoints of 140 of 1902 (Table 7) unique, overlapping deletion and duplication loci (>=95% sequence homology; minimum 300 bp in length for sequences within a 100 Kb window of the 5′ and 3′ breakpoints), suggesting a fraction of these identified overlapping deletion/duplication loci are potentially repeat-mediated reciprocal CNVs arising from non-allelic homologous recombination (NAHR) events (Liu P, et al., Curr Opin Genet Dev 2012; 22: 211). The expected number of exonic CNVs in a single individual is 10, the vast majority of which are common (AF>1%; see FIG. 35B and Table 7).

On average, one very rare (AF<0.1%) CNV was observed in a single individual's exome, and roughly one out of seven individuals contain at least one CNV unique to their exome (relative to the cohort). The ratio of rare duplications to deletions (absolute number having AF<1%, not number of loci) is 1.6:1. While deletions are locus constrained and may have a clear loss-of-function genetic impact in the gene or genes they encompass through haploinsufficiency, duplications as a class are generally thought to be less deleterious due to the absence of genetic material loss. However, duplications can also be highly deleterious through multiple mechanisms such as gene dosage alteration, spatial disruption of regulatory elements and the genes they regulate, and gene fusion if occurring intragenically and in tandem. In addition, duplications can disrupt other genes when the event occurs as an insertional duplication in another region of the genome. It has been observed that only a small fraction (˜2-3%) of duplications occur as insertional events and the majority occur are in tandem (Newman, S., et al., Am J Human Genetics 2015; 96: 208), implying that their functional effects may be more localized and perhaps better tolerated, although the functional impact of duplications remains difficult to assess.

In total, 13,170 genes are affected by at least one CNV of less than 2 Mb in length, representing ˜73% of the total callable gene set (18,048 unfiltered genes in ENSEMBL75 with exome capture targets). Duplication loci are more likely to span a multiple gene locus than deletions (47.7% vs. 26.1%, p=3.11×10⁻¹⁴⁵: Table 7), suggesting that deletions of multiple genes are generally more deleterious than duplications and have been selected against. Nonetheless, 46.5% of duplication loci and 68.0% of deletion loci do not overlap the entirety of any gene, 23.8% (duplications) and 46.2% (deletions) respectively do not even overlap half of the exons of any gene. Thus, most exonic CNVs are relatively short in genic units, highlighting the importance of a CNV caller with high resolution across the full size range.

The general loss-of-function properties of exonic duplications and deletions were characterized by comparing the observed frequency of CNVs in genes (number of CNVs less than 2 Mb in length overlapping at least one exon of the gene) to corresponding probability of loss-of-function intolerance (pLI) metrics provided by the Exome Aggregation Consortium (ExAC release v0.3 (Lek et al. (2016). Analysis of protein-coding genetic variation in 60,706 humans. Nature 536, 285-291); N=17,367 genes comparable between data sets). While a negative correlation is observed between CNV frequency and pLI for both deletions and duplications (Spearman rank correlation: p=−0.082, p=2.36×10⁻²⁷ for duplications; p=−0.276, p=2.49×10⁻³⁰⁰ for deletions), the negative correlation is significantly stronger for deletions (Fisher's Z transformation of correlation coefficients, Z=−18.799, p=5.03×10⁻⁷⁸). Genes most tolerant to loss-of-function SNVs were very likely to have at least one observed CNV for both duplications and deletions alike (76 and 83 of the 100 most loss-of-function tolerant genes, respectively). However, genes least tolerant to loss-of-function SNVs frequently have observed duplications, but rarely have observed deletions (63 and 26 of the 100 least loss-of-function tolerant genes, respectively). Defining loss-of-function intolerance using the suggested threshold of pLI>=90% (rank=14,158), 57.6% of loss-of-function intolerant genes have observed duplications compared to only 21.2% with deletions.

FIG. 37 estimates the probability of observing at least one duplication or deletion in a gene relative to its rank by the pLI metric (generalized additive model with a cubic spline basis). Genes ranked by probability of SNV loss-of-function intolerance (pLI; ExAC v0.3) correlate with the observed probability of observing CNVs in the same gene. The most loss-of-function (LoF) tolerant genes are the most likely to have observed deletions and duplications. However, above a pLI ranking threshold of ˜2,500, observed duplication rates in genes remain consistently around 60-70% regardless of loss-of-function intolerance. Conversely, the frequency of genes with observed deletions continues to decrease in relation to loss-of-function intolerance, with only ˜20-25% of the most loss-of-function intolerant genes having any observed deletion in the cohort.

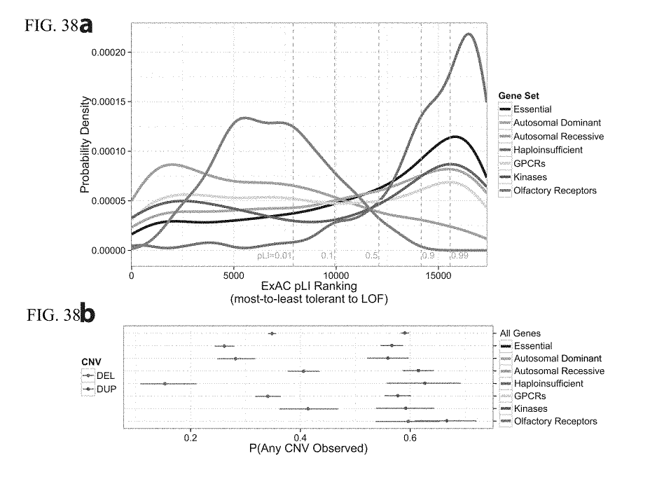

In FIG. 38A and FIG. 38B, it is shown that gene sets enriched or depleted for loss-of-function intolerant genes often also exhibit enriched or depleted CNV frequencies relative to expectation (particularly deletion frequencies).

As shown in FIG. 38A, the correlation between CNV frequency and loss-of-function intolerance is also affected by size. CNV loci were divided into small (<10 Kb), medium (10-50 Kb), and large (50 Kb-2 Mb) size bins and tested for correlation among each subset. As shown in FIG. 38B, a negative correlation was observed between CNV frequency and pLI for all CNV/size combinations, but size had the strongest effect on the correlation for deletions. For duplications, correlation coefficients were ρₛₘₐₗₗ=−0.065, ρ_{medium}=−0.057, and ρ_{large}=−0.049, while deletions demonstrated correlation coefficients of ρₛₘₐₗₗ=−0.247, ρ_{medium}=−0.176, and ρ_{large}=−0.115. Thus loss-of-function intolerance generally associates with intolerance to all CNVs, but as a whole, duplications are better tolerated than deletions and larger CNVs are better tolerated than smaller CNVs.

Linkage Disequilibrium Between CNVs and SNVs Identifies a Novel Tandem Duplication with a Nested Deletion Encompassing HMGCR

An analysis to identify pairs of CNVs in linkage disequilibrium that could represent independent CNVs within a haplotype or, alternatively, individual complex structural variants that manifest as independent events due to the limitations of read depth-based CNV calling, was performed. Recent surveys have identified complex classes of structural variants that appear with appreciable frequency, including inversions with flanking duplications, duplication/inverted triplication/duplication events (Carvalho et al, Nat Genet 2011; 43: 1074), duplications with nested deletions (Brand H, et al., Am J Hum Genet 2015; 97: 170), and complex deletions containing duplicated and/or inverted insertions (Sudmant P H, et al., Nature 2015; 526: 75). 33 paired events linked within a 5 Mb window having r²>=0.2 were identified.

Using a subset of the cohort with corresponding genotype SNP array data (34,246 individuals), this concept was extended to CNV-SNV linkage and performed an analysis to identify known SNVs that are tagging exonic CNVs. Such cases may contain GWAS hits and other SNVs of interest that associate with phenotypes whose functional impact is driven by an undetected CNV. The analysis included 892,083 SNVs (allele frequency between 0.0% and 0.5%) and 7,444 CNV loci (allele frequency between 0.00003% and 0.3593%). Within a 2 Mb window, 94 SNVs—ranging in minor allele frequency from 4.8×10⁻⁵ to 0.49—were identified that tag a total of 35 CNVs (r²>=0.2). While this linkage map has general utility as a resource for dissecting associations that are tagged by SNVs, it is clear from these results that a vast majority of CNVs are not tagged by SNVs, highlighting the value of CNV data.

After filtering samples having >=1% variant missingness (over all 918,320 variants), 31,211/34,246 individuals with chip data were considered for linkage disequilibrium (LD) analysis between SNVs and CNVs. For this set, the genotyping rate was 99.5%. A max genotype missingness filter of 1% reduced the count of variants to 892,083 variants ranging in minor allele frequency from 0-0.5, with a median of 0.136 and mean of 0.171. After merging of SNVs and 7,444 CNVs (MAF=0.0000313-0.3593, median 0.0000627, mean 0.00149, min MAC=3, max MAC=34,400, median=5, mean=142), LD was calculated with PLINK.

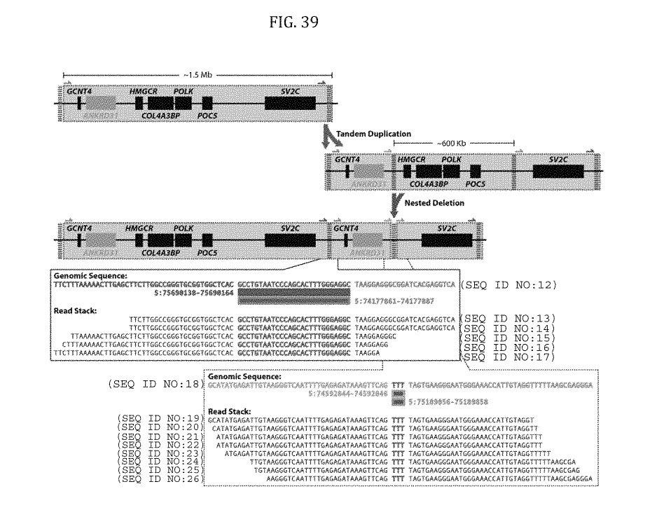

To investigate the possibility of linked CNV loci representing complex structural variants, two novel duplications in near-perfect linkage disequilibrium ((r²=0.958, D′=1) among 24 individuals were focused upon, encompassing SV2C (a single exon gene; 24 carriers) and GCNT4 (23 carriers). Given the orientation of these loci on either side of HMGCR, it was hypothesized that these loci are part of a single event that may include HMGCR. This hypothesis was confirmed via whole-genome sequencing of one carrier allowing us to precisely map the breakpoints of the rearrangement. A large ˜1.5 Mb tandem duplication of the region (hg19:g.chr5:74177861-75690164) was identified, with a ˜600 Kb nested deletion of the internal region (hg19:g.chr5:74592844-75189858). The resulting genotype includes three copies of SV2C, GCNT4, and the predicted gene ANKRD31, but HMGCR, COL4A3BP, POLK, ANKDDIB, and POC5 remain diploid due to the nested deletion (FIG. 39).

Whole-genome sequencing identified the breakpoints of two related structural variants, a tandem duplication with a nested deletion spanning HMGCR. Split-read alignments (shown) and discordant mapping mate-pair reads (not shown) identified microhomologies surrounding both events: a 27 nt Alu repeat subsequence (green; tandem duplication) and a simple 3 nt T-repeat (red; nested deletion). Notably, the most parsimonious explanation is that the nested duplication occurs within the duplicated copy (shown on the 3′ copy) representing a duplication-mediated deletion, but the opposite orientation (deletion within the 5′ copy) cannot be ruled out.

One additional carrier of the structural variant and one GCNT4 duplication that did not pass the QC filters were identified, bringing the total carrier count to 25.

Novel Associations of a Rare Duplication in LDLR to Lipid Traits

To demonstrate the use of this resource of common and rare copy number variants for phenotypic association mapping, an exome-wide (CNV-wide) association study of serum lipids, which are heritable risk factors for ischemic cardiovascular disease, was performed. The penetrance of these lipid-associated variants to coronary heart disease was also evaluated. Specifically, all CNV loci were compared to median fasting serum lipid levels (HDL-C, LDL-C, total cholesterol, and triglycerides) adjusted for lipid-lowering medication use in a subset of 49,675 individuals. Using a Bonferroni-corrected significance threshold of 1.2×10⁻⁵ revealed three CNV loci significantly associated with lipid levels (Table 8).

TABLE 8
Loci in which copy number variants are significantly associated with lipid levels.

| | | | | |
|---|---|---|---|---|
| CHR | 19 | 19 | 19 | 16 |
| BP1 | 11230767 | 11230767 | 54801926 | 15125591 |
| BP2 | 11241993 | 11241993 | 54804607 | 16292040 |
| Size | 11227 | 11227 | 2682 | 1166450 |
| Type | DUP | DUP | DEL | DUP |
| BETA* | 1.715 | 1.377 | 0.05285 | −0.4617 |
| SE* | 0.2357 | 0.2357 | 0.01037 | 0.09467 |
| P* | 3.55E−13 | 5.23E−09 | 3.52E−07 | 1.09E−06 |
| A1FREQ | 0.000256717 | 0.000254914 | 0.169554 | 0.00158309 |
| NMISS* | 35065 | 35313 | 35444 | 35065 |
| Beta-LMM | 1.73379 | 1.38355 | 0.0520635 | −0.439315 |
| SE-LMM | 0.234111 | 0.234806 | 0.0103203 | 0.094804 |
| P-Value, | 1.30E−13 | 3.80E−09 | 4.50E−07 | 3.60E−06 |
| BOLT-LMM | | | | |
| GENES | LDLR | LDLR | LILRA3 | NDE1, RRN3, etc |
| Trait | LDL | TCHOL | HDL | LDL |
| Beta-LMM | 76.1689 | 60.8742 | 0.652206 | −14.0667 |
| (mg/dL) | | | | |

The most significant CNV-lipid association identified was a novel duplication of exons 13-17 of the low-density lipoprotein receptor gene LDLR (an 18 exon gene) associated with high LDL cholesterol (β=1.73 [76 mg/dl], p=1.3×10⁻¹³) and high total cholesterol (β=1.38 [61 mg/dl], p=3.8×10⁻⁹; see Table 8). This duplication was identified in 24 carriers encompassing the exons corresponding to the transmembrane domain of the LDL receptor protein. Although further functional characterization of this event will provide a mechanistic explanation to this association, it is hypothesized that the tandem duplication can plausibly disrupt the stability of the transmembrane domain causing loss of function of LDLR in the carriers of this copy-number event.

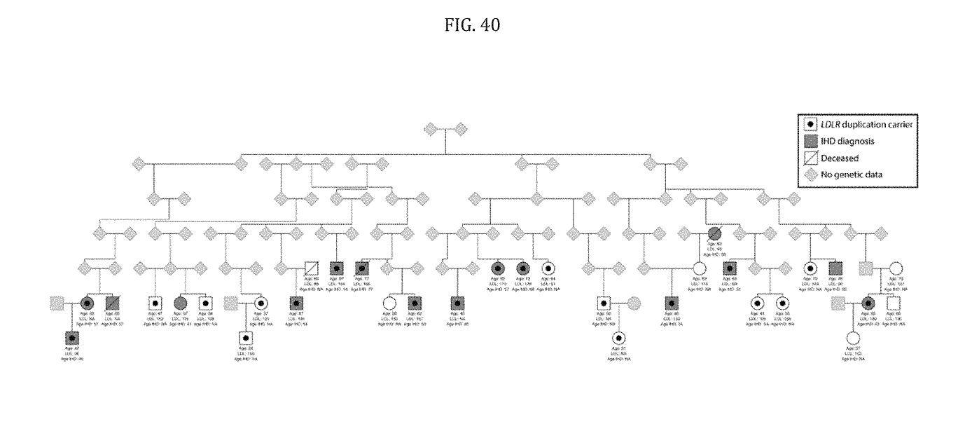

Whole-genome sequencing of one duplication carrier was performed to validate the structural variant and identify the precise breakpoints (see Methods). Discordantly-mapping mate pairs and split reads confirmed that the duplication occurred in tandem spanning 11.4 Kb of LDLR intragenic region (GRCh37/hg19 g.chr19:11229700-11241173). Breakpoint mapping and sequencing revealed the event to have occurred in the context of two Alu repeat sequences in introns 12 and 17 (FIG. 31 and FIG. 40; breakpoints support the CLAMMS call) with a 3 bp shared microhomology region at the break. The predicted translation of the resulting mRNA suggests the duplication occurs in-frame, however the effect of this duplication in the structure of the receptor is unknown. Several copy number variants have previously been reported in LDLR (Leigh et al., 2008); however, this particular duplication appears to be novel.

In a separate study, a start-loss SNV in SLC44A2 (˜500 kb away) was identified in perfect linkage disequilibrium with the LDLR duplication CNV (1:1 correspondence). This represents a case of a LoF SNV tagging a LoF structural variant in which the structural variant is most likely the driver, but analyses absent of CNV data would incorrectly identify SLC44A2 as the culprit gene. Using this tagging SNP as a guide, an additional four carriers were identified that had CNV calls that did not pass the high-confidence quality filters and a single additional carrier that was a false negative for the copy number variant. For the 20 carriers that had corresponding genotype array data, PennCNV (Wang K, et al., Genome Research 2007; 17:1665) was only able to detect the one carrier that was used for whole-genome sequence validation.

There is relationship estimation evidence that the PMP22 duplication carriers in Ped8 and Ped10 may have inherited the PMP22 duplication from a common ancestor ˜4 generations ago. Similarly, there is relationship estimation evidence that deletion carriers in Ped3 and Ped4 may have inherited the deletion from a common ancestor ˜4 generations ago. However, there is no relationship estimation evidence that any of the other duplication or deletion carriers inherited the PMP22 CNV from a common ancestor. This supports the hypothesis that there were multiple de novo CNV events with relatively equal frequency observed in the population.

Furthermore, the individual PennCNV call contained only eight markers and excluded exons 16 and 17. These data suggest that genotype arrays do not have the sensitivity necessary to identify this duplication and its lipid associations. Using the whole-genome validated breakpoint sequence as a guide, PCR primers were designed for a small region around the 5′ end of the inserted sequence and, using Sanger sequencing, validated the presence of the duplication in all 26 of the 29 carriers with sufficient DNA as well as its absence in six negative controls (related non-carriers and other LDLR events.

The penetrance of this copy number variant to coronary artery disease (CAD) was examined in 12,298 cases and 35,128 controls defined using a combination of angiographic and diagnosis code criteria (Dewey et al., 2016, In Press). In this analysis, the LDLR duplication was significantly associated with markedly increased CAD risk (OR=5.01, p=6×10⁻⁴). Using PRIMUS (Staples J, et al., Am J Hum Genet 2014; 95: 553) on the full carrier set, 10 pedigrees were reconstructed based on IBD estimates (up to third-degree relatedness) that included 21/29 of the LDLR duplication carriers. A distant-relatedness analysis was performed to connect 9/10 pedigrees—as well as all eight additional carriers—to a single large estimated pedigree containing 27/29 carriers and dating a common ancestor to at least 6 generations (FIG. 40).

Reconstructed pedigree containing 22/29 carriers of a novel duplication of LDLR exons 13-17 and ten unaffected related (first or second degree) individuals from the sequenced cohort. Five of the seven carriers excluded from this pedigree estimate are predicted to also be distantly related to this pedigree. The remaining two carriers are likely distantly related but the relationships could not be reliably estimated with available data. High LDL levels (p=1.3×10⁻¹³) and IHD-related diagnoses (p=6.1×10⁻⁴) segregate with duplication carriers, suggesting a novel cause of familial hypercholesterolemia (FH).

In this extended pedigree the mutation segregated with high LDL and 15/29 mutation carriers had ischemic heart disease (IHD) as defined by International Classification of Diseases, Ninth Edition (ICD-9) diagnosis codes 410*-414*. Furthermore, 11/15 mutation carriers with IHD presented with early onset IHD (defined as males <55 years old and females <65 years old at the time of first incidence of an IHD coding). In contrast, 3/10 related non-carriers had a history of IHD, only one of whom presented with early onset disease. Given that LDLR is frequently mutated in familial hypercholesterolemia (FH) cases (Leigh S E, et al., Ann Hum Genet 2008; 72: 485) and that a large extended kindred segregating this variant with markedly increased LDL, CAD risk, and high rates of early onset IHD was identified, it is concluded that this is likely a novel FH-causing CNV.

Novel Associations of a Common Deletion in LILRA3 to Lipid Traits

Next, a common deletion in the leukocyte immunoglobulin (Ig)-like receptor A3 gene (LILRA3) gene (allele frequency ˜17%) was associated with increased HDL levels (β=0.05 [0.65 mg/dl], p=4.5×10⁻⁷). No significant difference in incidence of coronary artery disease was observed. Microdeletions in LILRA3 are common and have high genetic diversity among populations. Its allele frequency was previously estimated at 17% in Europeans, consistent with the observations in (Hirayasu K, Arase H, Journal of Human Genetics 2015; 60). This microdeletion has previously been investigated for association with diseases including multiple sclerosis (Ordonez D, et al., Genes and Immunity 2009; 10: 579), rheumatoid arthritis, lupus, and prostate cancer (Hirayasu K, Arase H, Journal of Human Genetics 2015; 60). While GWAS hits adjacent to LILRA3 have been associated with HDL levels (Teslovich T M, et al., Nature 2010; 466; 707), no association has been identified between this LILRA3 CNV and any lipid phenotypes. The CNV-SNV linkage disequilibrium analysis herein excluded this SNV due to high-missingness, but direct computation of the linkage suggests that the deletion and SNV are in fact linked (r²=0.77, D′=0.959). Thus the microdeletion is likely driving the HDL effect while being tagged by the SNV, an observation that has not previously been made due to the limitations of existing technologies for detection of CNVs.

The LILRA3 microdeletion has historically been quantified via PCR, and more recently within the context of large-scale whole genome sequencing studies. However, the size and allele frequency of this deletion make it particularly difficult to identify from exome sequencing data. The results herein demonstrate the feasibility of identifying clinically relevant small, common CNVs from the exome using CLAMMS. The copy number calls made by CLAMMS at this locus on 69 carriers using TAQMAN® quantitative polymerase chain reaction (qPCR) has previously been validated, demonstrating 100% sensitivity and specificity while no other exome-based CNV caller could accurately identify copy number at the locus (Packer J S, et al., Bioinformatics 2015; 32: 133). This CNV also could not be detected by the arrays; PennCNV detected only two carriers from the entire cohort (50% reciprocal overlap criteria). In the high-confidence CLAMMS call set, this deletion has an observed transmission rate of 61.7% (>50% transmission is expected for common variants).

Finally, the lipid profiles of carriers of the complex structural variant surrounding HMGCR described previously (FIG. 39) were investigated, and a marginal association with high LDL was observed in carriers of this structural variant (p=3.1×10⁻⁴). While this association was not strong enough to pass exome-wide significance, it is hypothesized that the structural variant may affect HMGCR expression. No difference in the incidence of IHD among carriers was identified (p=0.66).

Identification of additional carriers and unaffected related individuals will provide a larger sample size to test for associations of lipid traits and cardiovascular phenotypes. PennCNV detected both duplication fragments (GCNT4 fragment: ˜400 Kb over ˜115 markers, SV2C fragment: ˜500 Kb over ˜175 markers) in 18/18 chipped samples—highlighting the improved sensitivity of array data for larger events (FIG. 39)—but did not uncover any additional carriers to increase the sample size.

Whole-genome sequencing identified the breakpoints of two related structural variants, a tandem duplication with a nested deletion spanning HMGCR. Split-read alignments (shown) and discordant mapping mate-pair reads (not shown) identified microhomologies surrounding both events: a 27 nt Alu repeat subsequence (green; tandem duplication) and a simple 3 nt T-repeat (red; nested deletion). Notably, the most parsimonious explanation is that the nested duplication occurs within the duplicated copy (shown on the 3′ copy) representing a duplication-mediated deletion, but the opposite orientation (deletion within the 5′ copy) cannot be ruled out.

If the hypothesis holds true, the most parsimonious explanation is that the variant disrupts HMGCR regulation. However, gene dosage effects from SV2C, GCNT4, and/or ANKRD31 cannot be ruled out.

This study delivers a survey of common and rare copy-number variation assessed using exome data in a broad clinical population, and demonstrates the utility of analyzing genetic variation in the context of health information contained within the EHR. Provided herein is a comprehensive catalogue of CNVs representing a substantial source of genomic variation in this study population, which has yet to be fully interrogated for associations with health and disease. In the rare end of the spectrum, the observation of significant differences in size and impact on mutation-intolerant genes of duplications in comparison to deletions suggests that duplications are much more tolerated. Through the generation of linkage disequilibrium maps for both CNVs and SNVs that tag CNVs, a resource to aid in the deeper understanding of association results is provided, and it is shown that little CNV variation can be assessed by imputation from SNP data. The value and provide a proof-of-concept for broader interrogation of CNVs and associations with disease via focused analyses in serum lipid traits is highlighted herein. Copy number variation in LDLR, while not unprecedented, represents an understudied cause of familial hypercholesterolemia. The described and thoroughly characterized exon 13-17 duplication, present in ˜1 in 1,749 samples, represents roughly 10% of the overall FH mutation rate observed in this cohort. The prevalence of FH-associated variants as approximately 1:215 (Dewey F, et al., in press). These data combined with other reports of LDLR rearrangements (Leigh et al., 2008) suggest that structural variants could represent a significant proportion of all FH cases. Additional sequencing and CNV analysis of LDLR in individuals presenting with high LDL levels in diverse populations may reveal additional causative copy number variants, improve diagnostic rates for familial hypercholesterolemia, and eventually inform patient treatments.

A novel association between common LILRA3 microdeletions and HDL cholesterol levels was also identified, as well as a complex structural variant surrounding HMGCR in which a ˜1.5 Mb tandem duplication with a nested ˜600 Kb deletion leaves HMGCR diploid, but plausibly disrupts its expression. This variant was marginally associated with high LDL cholesterol (p=3.1×10⁻⁴), however it failed to pass exome-wide significance. Given the low number of carriers in the sequenced cohort, identification of additional carriers and unaffected related individuals will provide a larger sample size to investigate potential phenotypic effects of this variant. A novel association between decreases in LDL and duplications at 16p13.11 (Table 8; β=−0.44 [−14 mg/dl], p=3.60×10⁻⁶) was identified, which is a locus where deletions associate with epileptic convulsions (Heinzen E L, et al., Am J Hum Genet 2010; 86: 707).

While this association does not have a clear biological or functional explanation, the ˜1.2 Mb duplication contains ABCC1, which has previously been linked via gene expression effects to cholesterol levels and statin treatment (Celestino et al., 2015; Rebecchi et al., 2009). It was also shown that CLAMMS detects a common ˜1.6 Kb CNV in HP well enough to recapitulate the directionality of previously observed associations with increased LDL and total cholesterol (Boettger L M, et al., Nat Genet, 2016; 1-9). While full characterization of this locus requires dissection of the full haplotype (including single nucleotide resolution), it was shown that through a single mappable exon, CLAMMS is able to identify this CNV directly from exome sequence read depths.

Recently, a qPCR-based approach was used to characterize the haplotypes surrounding a complex, common ˜1.7 Kb copy number variant internal to HP in 264 individuals followed by SNV imputation to over 20,000 individuals (Boettger L M, et al., Nat Genet, 2016; 1-9). These authors reported an association with decreased LDL and total cholesterol (β≈−0.1 for both). While the complexity of this two exon repeat locus (exons 3-4 & exons 5-6) is challenging to assess with exonic copy number estimates alone (only exons 2, 6, and 7 pass the >75% mappability threshold), frequent deletions and duplications of this variant were identified based on single exon calls of exon 6. Marginal (not exome-wide significant) associations with increased HDL (β=0.15 [1.5 mg/dl], p=1.9×10⁻³) and decreased triglycerides (β=−0.12 [−11.0 mg/dl], p=1.5×10⁻²) were observed in carriers of the duplication (N=571), but no significant associations were observed with the deletion. However, it was observed that the deletion was frequently filtered as low confidence, likely due to its size and mappability issues. Thus, the associations on the unfiltered call set in non-outlier samples were re-analyzed and the directionality of both associations was replicated with decreased LDL (β=−0.03 [−1.3 mg/dl], p=1.7×10⁻²) and total cholesterol (β=−0.02 [−1.1 mg/dl], p=5.0×10⁻²), with an estimated allele frequency of ˜12%. While it is not expected that CLAMMS can genotype these complex haplotypes to the resolution of the existing qPCR-based approach, which putatively explains why the associations were not exome-wide significant, this example highlights the sensitivity of CLAMMS for small, complex CNVs that have previously been unattainable with existing technologies.

The data provided herein on exome-wide CNV allele frequencies may be useful for assessing the sample size requirements for detection of associations with phenotypes of interest in future studies of rare and common disease. It was found that over 90% of distinct CNVs are present in less than 1 in 10,000 individuals. Extremely large control groups are therefore necessary to establish phenotypic associations.

Finally, the methods used in the CNV calling pipeline make several improvements to the state-of-the-art and may be useful in future studies of copy number variation. Evaluating transmission rates in reconstructed pedigrees allows one to evaluate the performance of a CNV-calling algorithm on one's own data, which may differ significantly from the performance of the algorithm for the data it was published with. It also makes it useful to tune quality control procedures, such as the use of SNP genotyping information to identify false positive calls.

As the data herein shows, the density of markers on genotype chips is insufficient or characterizing the full spectrum of copy number variation in humans (FIG. 32). With the growing ubiquity of whole exome and whole genome sequencing, and given the substantial body of literature implicating CNVs in both rare and common disease, the inclusion of CNV-calling into standard bioinformatics pipelines is long overdue.

### Example 3

SERPINA1 PI*Z Heterozygosity and Risk for Lung and Liver Disease

Homozygosity for the Z variant in SERPINA1 (PI*Z; rs28929474) causes alpha-1-antitrypsin (AAT) deficiency, with associated increased risk of chronic obstructive pulmonary disease (COPD) and liver disease. While heterozygosity for PI*Z is suspected to confer disease risk, its role has not been definitively established. The disclosed systems and methods were used to determine the association of PI*Z heterozygosity with lung and liver disease in a clinical care cohort.

In 49,176 sequenced adults of European ancestry, the association of PI*Z heterozygosity with EHR-extracted measures of AAT (n=1,360), alanine aminotransferase (ALT; n=43,458), aspartate aminotransferase (AST; n=42,806), alkaline phosphatase (ALP; n=42,401), γ-glutamyl transferase (GGT; n=3,389), and spirometry (n=9,825) was examined. PI*Z heterozygosity was also tested for association with alcoholic (n=197) and non-alcoholic (n=3,316) liver disease, asthma (n=7,652), COPD (n=6,314), and COPD-specific diagnoses of emphysema (n=1,546) and chronic bronchitis (n=2,450), as defined by ICD9 diagnosis codes.

There were 1669 heterozygous PI*Z carriers in the cohort. Heterozygosity for PI*Z was associated with a 46% reduction in AAT (p=9.57×10⁻⁵³), and with increased ALT (2%; p=7.22×10⁻¹⁵), AST (1.5%; 3.73×10⁻¹⁸), and ALP (5.9%, 1.56×10⁻²⁵) levels. There was no association with GGT or spirometry measures. In case/control analyses, heterozygosity for PI*Z was associated with alcoholic and non-alcoholic liver disease (odds ratio [OR] 2.41, p=0.001; OR 1.24, p=0.04, respectively), COPD (OR 1.27, p=0.008), and emphysema (OR 1.41, p=0.02). When restricting analyses to COPD (n=2,002) and emphysema (n=728) patients with spirometry-confirmed airway obstruction, PI*Z heterozygosity remained significantly associated (OR 1.44, p=0.006; OR=1.75, p=0.005, respectively). There was no association with asthma or chronic bronchitis.

In a large clinical care cohort, SERPINA1 PI*Z heterozygosity was significantly associated with increased liver enzyme levels, and increased risk of COPD, emphysema, and liver disease. This is the first study to clearly demonstrate the association of PI*Z heterozygosity with clinical disease risk, which has important implications given the high population frequency of the PI*Z allele.

### Example 4

Mutation Spectrum of NOD2 in Early Onset Inflammatory Bowel Disease

Inflammatory bowel disease (IBD), clinically defined as Crohn's Disease (CD) or ulcerative colitis (UC), results in chronic inflammation of the gastrointestinal tract in genetically susceptible hosts. IBD is typically diagnosed in the 3rd decade of life. However, pediatric-onset IBD is especially severe, with greater likelihood of intestinal stricturing, perianal disease, impaired developmental growth, and poor response to conventional treatments. GWAS have identified 163 loci associated with IBD susceptibility and progression in adults. Of these, the nucleotide binding and oligomerization domain containing 2 (NOD2) gene was the first and is the most replicated gene associated with adult CD, to date. However, its role in pediatric-onset IBD is not well understood.

Whole exome sequencing was performed on a cohort of 1,183 probands with pediatric-onset IBD (ages 0-18 y) and their affected or unaffected parents and siblings, where available. Trio-based analysis was conducted on 492 complete trios for gene identification and discovery and the remaining 691 probands were utilized for replication of candidate genes.

In the initial analyses, 12 families were identified with recessive compound heterozygous or homozygous variants in NOD2 (MAF<2%). The observation that some of these rare variants occur in trans from more common, previously-reported CD risk alleles (2%≦MAF≧5%) led to the survey of additional probands for recessive inheritance of NOD2 variants. In total, 105 probands were identified with recessive NOD2 variants, carrying a NOD2 CD-risk allele in addition to either another NOD2 CD-risk allele or a completely novel NOD2 variant. The contribution of recessive inheritance of these rare and low frequency NOD2 alleles in 1,146 IBD patients from the Regeneron Genetics Center-Geisinger Health System DiscovEHR study that links whole exome sequences to electronic health records was investigated next. Here, it was found that 7% of cases in this adult IBD cohort could be attributed to recessive inheritance of NOD2 variants, including 14% CD cases. Of these, 1% had a diagnosis before 18 y, consistent with early onset CD.

In sum, 9% of the probands in the pediatric-onset IBD cohort conform to a recessive, Mendelian mode of inheritance for rare and low frequency (MAF≦5%) deleterious variants in NOD2. This recessive inheritance was confirmed in an adult IBD cohort and identified several early onset CD cases. Collectively, the findings using the disclosed methods and systems implicate NOD2 as a Mendelian disease gene for early-onset IBD.

### Example 5

De-Novo Reconstruction of More than 6,000 Pedigrees in 51K De-Identified Exomes within the DiscovEHR Cohort

Pedigrees and family-based analyses have been moving back to the forefront of human genetics. However, many of the large-scale sequencing initiatives planned and underway are ascertaining and sequencing hundreds of thousands of de-identified individuals, without the ability to obtain accurate family history and pedigree records, precluding many powerful family-based analyses. The methods and systems disclosed demonstrate that tens of thousands of close familial relationships can be inferred within the DiscovEHR cohort, and the corresponding pedigrees can be reconstructed directly from the genetic data, identifying many familial relationships that can be used for downstream genotype-phenotype analyses enabling both population and family-based analytical approaches.

Using PLINK to estimate genome-wide IBD proportions between all individuals in the DiscovEHR cohort, it was determined that >48% of the individuals were involved in one or more of the ˜5,000 full-sibling relationship, ˜7,000 parent-child relationships, and -15,000 second-degree relationships. Subsequently, >6,000 pedigrees were constructed containing two or more sequenced individuals using PRIMUS. The largest extended family identified contained >3,000 individuals (˜6% of the dataset). 825 nuclear families were also identified, containing 948 trios, allowing performance of a rich set of trio-based analyses. These trios aided in improving CNV calling, phasing compound heterozygous mutations, and validating rare variant calls.

This resource of reconstructed pedigree data can be used to distinguish between novel/rare population variation and familial variants and can be leveraged to identify highly penetrant disease variants segregating in families that are underappreciated in population-wide association analyses. This approach has been validated by identifying related individuals segregating highly penetrant Mendelian disease causing variants causing, among other examples, familial aortic aneurysms, cardiac conduction defects, thyroid cancer, pigmentary glaucoma, and familial hypercholesterolemia, including a large pedigree containing 29 related individuals carrying a novel familial hypercholesterolemia-causing tandem duplication in LDLR.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

Various modifications and variations can be made without departing from the scope or spirit. Other embodiments will be apparent from consideration of the specification and practice disclosed herein. It is intended that the specification and examples be considered as exemplary only, with a true scope and spirit being indicated by the following claims.

What is claimed is:

1. A system comprising:
a genetic data component configured for functionally annotating one or more genetic variants obtained from sequence data;
a phenotypic data component configured for determining one or more phenotypes for one or more patients for whom the sequence data was obtained and analyzed by the genetic data component;
a genetic variant-phenotype association data component configured for determining one or more associations between the one or more genetic variants and the one or more phenotypes; and
a data analysis component configured for generating, storing, and indexing the one or more associations from the genetic variant-phenotype association data component.

2. The system of claim 1, wherein the functionally annotating of the one or more genetic variants generates genetic variant data.

3. The system of claim 2, wherein one or more variants in the genetic variant data are assessed for functional impact on transcripts/genes and potential loss-of-function (pLoF) candidates are identified.

4. The system of claim 1, wherein the genetic data component comprises a variant identification component comprised of a trimming component, an alignment component, and a variant calling component.

5. The system of claim 1, wherein the genetic data component comprises a variant annotation component comprised of a functional predictor component.

6. The system of claim 5, wherein the variant annotation component is configured to determine and assign functional information to the one or more genetic variants.

7. The system of claim 5, wherein the variant annotation component is configured to categorize each of the one or more genetic variants based on the variant's relationship to a coding sequence in a genome and how the one or more genetic variants may change the coding sequence and affect a gene product.

8. The system of claim 1, wherein the determining the one or more phenotypes for the one or more patients for whom the sequence data was obtained and analyzed by the genetic data component generates phenotypic data.

9. The system of claim 1, wherein the phenotypic data component comprises one or more of a binary phenotype component, a quantitative phenotype component, a categorical phenotype component, or a clinical narrative phenotype component.

10. The system of claim 9, wherein the binary phenotype component is configured for analyzing de-identified medical information to identify one or more codes assigned to a patient in the de-identified medical information.

11. The system of claim 11, wherein the quantitative phenotype component is configured for analyzing de-identified medical information to identify a continuous variable and assign a phenotype based on the identified continuous variable.

12. The system of claim 1, wherein the genetic variant-phenotype association data component comprises a computational component and a quality component.

13. The system of claim 12, wherein the computational component is configured for performing one or more statistical tests.

14. The system of claim 1, further comprising:
a phenotype data interface coupled to the phenotypic data component;
a genetic variant data interface coupled to the genetic data component;
a pedigree interface coupled to the genetic data component; and
a results interface coupled to the phenotypic data component and the data analysis component.

15. The system of claim 14, wherein the phenotype data interface comprises one or more of a phenotype data viewer, a query/visualization component, and a data exchange interface.

16. The system of claim 15, wherein the query/visualization component is configured to query phenotype data stored in an acyclic graph.

17. The system of claim 14, wherein the genetic variant data interface comprises one or more of a genetic variant data viewer, a query/visualization component, and/or a data exchange interface.

18. The system of claim 17, wherein the query/visualization component is configured to query genetic variant data stored in one or more VCF files in the genetic data component.

19. The system of claim 18, wherein the genetic data component is further configured to:
receive a plurality of VCF files;
determine one or more variant sites in common among the plurality of VCF files;
generate an index identifying presence or absence of the one or more variant sites for each of the plurality of VCF files;
encode a plurality of attributes as a single value for each of the plurality of VCF files; and
generate a final VCF file comprising the index and the encoded plurality of variables, wherein the query/visualization component is configured to query genetic variant data stored in the final VCF file.

20. The system of claim 17, wherein the data exchange is configured to receive an output from the phenotype data interface, the pedigree interface, and the results interface to be used as input into the genetic variant data interface and to provide output of the genetic variant data interface to be used as input into the phenotype data interface, the pedigree interface, and the results interface.

21. The system of claim 14, wherein the pedigree interface is configured to reconstruct a pedigree within a genetic dataset.

22. A method, comprising:
receiving a plurality of variants from exome sequencing data;
assessing a functional impact of the plurality of variants;
generating an effect prediction element for each of the plurality of variants; and
assembling the effect prediction element into a searchable database comprising the plurality of variants.

23. A method, comprising:
querying a genetic data component for a variant associated with a gene of interest;
passing the variant to a phenotypic data component as a query for a cohort possessing the variant;
passing the variant and the cohort to a genetic variant-phenotype association data component to determine an association result between the variant and a phenotype of the cohort;
passing the association result to a data analysis component to store and index the association result by at least one of the variant and the phenotype; and
querying the data analysis component by a target variant or a target phenotype, wherein the association result is provided in response.
